(19) United States
(12) Patent Application Publication
(10) Pub. No.: US 2025/0334873 A1
(43) Pub. Date: Oct. 30, 2025

(54) IMAGING OPTICAL SYSTEM, PROJECTION TYPE DISPLAY DEVICE, AND IMAGING APPARATUS

(71) Applicant: FUJIFILM Corporation, Tokyo (JP)

(72) Inventors: Taku FURUBAYASHI, Saitama (JP); Ukyo TOMIOKA, Saitama (JP); Akiko NAGAHARA, Saitama (JP); Masaru AMANO, Saitama (JP); Takashi KUNUGISE, Saitama (JP)

(73) Assignee: FUJIFILM Corporation, Tokyo (JP)

(21) Appl. No.: 19/182,547

(22) Filed: Apr. 17, 2025

(30) Foreign Application Priority Data
Apr. 25, 2024 (JP) 2024-071766

(51) Int. Cl. G03B 21/28; G02B 13/16

(52) U.S. Cl. CPC G03B 21/28; G02B 13/16

(57) ABSTRACT

The imaging optical system is capable of forming an enlarged image on an enlargement-side imaging plane by enlarging an image on a reduction-side imaging plane, the imaging optical system consisting of an optical window, a reflective optical system, and a refractive optical system including a plurality of lenses along an optical path in order from an enlargement side to a reduction side, in which at least two intermediate images are formed. The reflective optical system includes a first reflecting surface having a positive power, a second reflecting surface having a power, and a third reflecting surface having a positive power along the optical path in order from the enlargement side to the reduction side. A center of the enlarged image is at a position shifted from an optical axis of the refractive optical system in a direction perpendicular to the optical axis. The imaging optical system satisfies predetermined conditional expressions.

### CROSS-REFERENCE TO RELATED APPLICATIONS

This application claims priority from Japanese Patent Application No. 2024-071766, filed on Apr. 25, 2024, the entire disclosure of which is incorporated herein by reference.

### BACKGROUND

### Technical Field

The present disclosed technology relates to an imaging optical system, a projection type display device, and an imaging apparatus.

### Related Art

JP2020-024359A and JP2020-086174A describe an imaging optical system that can be used for a projection type display device, an imaging apparatus, or the like.

### SUMMARY

The present disclosure provides an imaging optical system that includes an optical window capable of preventing penetration of dust or the like and is small-sized, a projection type display device including the imaging optical system, and an imaging apparatus including the imaging optical system.

According to a first aspect of the present disclosure, there is provided an imaging optical system that is capable of forming an enlarged image on an enlargement-side imaging plane by enlarging an image on a reduction-side imaging plane, the imaging optical system consisting of an optical window, a reflective optical system, and a refractive optical system including a plurality of lenses along an optical path in order from an enlargement side to a reduction side, in which the reflective optical system includes a first reflecting surface having a positive power, a second reflecting surface having a power, and a third reflecting surface having a positive power along the optical path in order from the enlargement side to the reduction side, a first intermediate image is formed at a position conjugate to the image on the optical path closer to the reduction side than the third reflecting surface, a second intermediate image is formed at a position conjugate to the first intermediate image in the reflective optical system, the enlarged image is formed at a position conjugate to the second intermediate image on the optical path closer to the enlargement side than the optical window, a center of the enlarged image is at a position shifted from an optical axis of the refractive optical system in a direction perpendicular to the optical axis, and Conditional Expressions (1) and (2) represented by

$$40 ° < \vert α \vert < 85 ° and \qquad ( 1 )$$

$$0 ° < \vert θ c \vert < 35 ° \qquad ( 2 )$$

are satisfied.

Here, a principal ray that is incident into the center of the enlarged image in a state where an amount of the shift is maximum is a center principal ray, an incidence angle of the center principal ray into the enlargement-side imaging plane is represented by α, and an incidence angle of the center principal ray into the optical window is represented by θc.

According to a second aspect of the present disclosure, in the imaging optical system according to the first aspect, in a case where a maximum half angle of view of the enlargement side is represented by ω, Conditional Expression (3) represented by

$$65 ° < ω < 90 ° \qquad ( 3 )$$

is satisfied.

According to a third aspect of the present disclosure, in the imaging optical system according to the first aspect, an intersection between the center principal ray and a surface of the optical window on the enlargement side is positioned closer to the third reflecting surface side than the entire second reflecting surface in a direction of the optical axis.

According to a fourth aspect of the present disclosure, in the imaging optical system according to the first aspect, the entire optical window is positioned closer to the third reflecting surface side than a point positioned closest to the enlargement side in the refractive optical system in a direction of the optical axis.

According to a fifth aspect of the present disclosure, in the imaging optical system according to the first aspect, in a case where a distance between a point closest to the optical axis in the optical window and the optical axis is represented by hWmin, and a radius of a lens closest to the enlargement side in the refractive optical system is represented by ra, Conditional Expression (4) represented by

$$0.9 < hWmin / ra < 3 \qquad ( 4 )$$

is satisfied.

According to a sixth aspect of the present disclosure, in the imaging optical system according to the first aspect, the optical window is flat, and in a case where a distance between the optical axis and a point positioned closest to the optical axis among points positioned closest to the reflective optical system side in the optical window in a direction of the optical axis is represented by hWR, and a distance between the optical axis and a point farthest from the optical axis among points in an effective region of the third reflecting surface is represented by hM3, Conditional Expression (5) represented by

$$0.5 < hWR / hM 3 < 3 \qquad ( 5 )$$

is satisfied.

According to a seventh aspect of the present disclosure, in the imaging optical system according to the first aspect, the optical window is flat, and in a case where a tilt angle of the optical window with respect to a surface perpendicular to the optical axis is represented by θwin, Conditional Expression (6) represented by

$$30 ° < θ win < 85 ° \qquad ( 6 )$$

is satisfied.

According to an eighth aspect of the present disclosure, in the imaging optical system according to the first aspect, the optical window is flat, and in a case where a distance between a center of the image and the optical axis is represented by Δs, a length of a short side of the image is represented by ImS, a minimum value of V defined by V=Δs/ImS is represented by Vmin, a length of a long side of a rectangle circumscribing the optical window is represented by WL, a distance in a direction of the optical axis from the first reflecting surface to the enlarged image is represented by Dsc, a length of a long side of the enlarged image is represented by PrL, and a length of a long side of the image is represented by ImL, Conditional Expression (7) represented by

$$0 < ( V min - 0.5 ) \times WL \times ( Dsc / PrL ) / ImL < 1.2 , \qquad ( 7 )$$

is satisfied.

According to a ninth aspect of the present disclosure, in the imaging optical system according to the first aspect, the optical window is flat, and in a case where a length of a long side of a rectangle circumscribing the optical window is represented by WL, and a length of a short side of the rectangle is represented by WS, Conditional Expression (8) represented by

$$2 < WL / WS < 10 \qquad ( 8 )$$

is satisfied.

According to a tenth aspect of the present disclosure, in the imaging optical system according to the first aspect, the optical window is flat, and in a case where a distance between a center of the image and the optical axis is represented by Δs, a length of a short side of the image is represented by ImS, a minimum value of V defined by V=Δs/ImS is represented by Vmin, a length of a long side of a rectangle circumscribing the optical window is represented by WL, and a length of a short side of the rectangle is represented by WS, Conditional Expression (9) represented by

$$0.5 < ( V min - 0.5 ) \times WL / WS < 1.5 \qquad ( 9 )$$

is satisfied.

According to an eleventh aspect of the present disclosure, in the imaging optical system according to the first aspect, the optical window has a curvature in a long side direction of the image.

According to a twelfth aspect of the present disclosure, in the imaging optical system according to the eleventh aspect, in a case where a length of a long side of a projection of a rectangle circumscribing the optical window onto a surface perpendicular to a direction from a center of the curvature toward an origin used in an equation defining a curved surface of the optical window is represented by WpL, and a length of a short side of the projection is represented by WpS, Conditional Expression (10) represented by

$$1 < WpL / WpS < 3 \qquad ( 10 )$$

is satisfied.

According to a thirteenth aspect of the present disclosure, in the imaging optical system according to the eleventh aspect, the optical window is a cylindrical lens.

According to a fourteenth aspect of the present disclosure, in the imaging optical system according to the thirteenth aspect, a surface of the optical window on the reduction side is a cylindrical surface, and in a case where a length of a long side of a projection of a rectangle circumscribing the optical window onto a surface perpendicular to a direction from a center of the curvature toward an origin used in an equation defining a curved surface of the optical window is represented by WpL, and a curvature radius of the cylindrical surface in a direction perpendicular to a generatrix of the cylindrical surface is represented by Rcy, Conditional Expression (11) represented by

$$1 < WpL / Rcy < 2 \qquad ( 11 )$$

is satisfied.

According to a fifteenth aspect of the present disclosure, in the imaging optical system according to the thirteenth aspect, a surface of the optical window on the reduction side is a cylindrical surface, and in a case where a combined focal length of the reflective optical system and the refractive optical system is fRL, and a curvature radius of the cylindrical surface in a direction perpendicular to a generatrix of the cylindrical surface is represented by Rcy, Conditional Expression (12) represented by

$$0 < fRL / Rcy < 0.1 \qquad ( 12 )$$

is satisfied.

According to a sixteenth aspect of the present disclosure, in the imaging optical system according to the eleventh aspect, the optical window has a toric shape.

According to a seventeenth aspect of the present disclosure, in the imaging optical system according to the eleventh aspect, a surface of the optical window on the enlargement side and a surface of the optical window on the reduction side have a spherical shape.

According to an eighteenth aspect of the present disclosure, in the imaging optical system according to the eleventh aspect, the optical window has an aspherical shape.

According to a nineteenth aspect of the present disclosure, there is provided a projection type display device comprising: the imaging optical system according to any one of the first to eighteenth aspects.

According to a twentieth aspect of the present disclosure, there is provided an imaging apparatus comprising the imaging optical system according to any one of the first to eighteenth aspects.

In the present specification, it should be noted that the terms “consisting of” and “consists of” mean that the lens may include not only the above-described components but also lenses substantially having no power, optical elements, which are not lenses, such as a stop, a mask, a filter, a cover glass, a plane mirror, and a prism, and mechanism parts such as a lens flange, a lens barrel, an imaging element, and a camera shaking correction mechanism.

The sign of the power and the surface shape relating to an optical member including an aspheric surface are considered in a paraxial region unless otherwise specified.

The present disclosure can provide an imaging optical system that includes an optical window capable of preventing penetration of dust or the like and is small-sized, a projection type display device including the imaging optical system, and an imaging apparatus including the imaging optical system.

### BRIEF DESCRIPTION OF THE DRAWINGS

FIG. 1 is a cross-sectional view showing a configuration and luminous fluxes of an imaging optical system according to an embodiment corresponding to an imaging optical system according to Example 1.

FIG. 2 is a diagram schematically showing a usage state of a projection type display device according to an embodiment.

FIG. 3 is a cross-sectional view showing a positional relationship between the imaging optical system, a display surface, an enlarged image, and the like.

FIG. 4 is a diagram showing a positional relationship between an optical axis and a center of an image.

FIG. 5 is a diagram for describing symbols of conditional expressions.

FIG. 6 is a diagram for describing symbols of conditional expressions.

FIG. 7 is a schematic configuration diagram showing an imaging optical system including a rectangular and flat optical window.

FIG. 8A is a diagram showing an example of a luminous flux cross section and the optical window.

FIG. 8B is a diagram showing a rectangle circumscribing the optical window of FIG. 8A.

FIG. 9 is a schematic configuration diagram showing an imaging optical system including an optical window with a curvature.

FIG. 10 is a diagram showing a projection of a rectangle circumscribing the optical window.

FIG. 11 is a diagram showing an example of a luminous flux cross section and the optical window.

FIG. 12A is a diagram showing an example of a luminous flux cross section and the optical window.

FIG. 12B is a diagram showing a rectangle circumscribing the optical window of FIG. 12A.

FIG. 13A is a diagram showing an example of a luminous flux cross section and the optical window.

FIG. 13B is a diagram showing a rectangle circumscribing the optical window of FIG. 13A.

FIG. 14 is a cross-sectional view showing a configuration and luminous fluxes of an imaging optical system according to Example 2.

FIG. 15 is a cross-sectional view showing a configuration and luminous fluxes of an imaging optical system according to Example 3.

FIG. 16 is a cross-sectional view showing a configuration and luminous fluxes of an imaging optical system according to Example 4.

FIG. 17 is a cross-sectional view showing a configuration and luminous fluxes of an imaging optical system according to Example 5.

FIG. 18 is a cross-sectional view showing a configuration and luminous fluxes of an imaging optical system according to Example 6.

FIG. 19 is a cross-sectional view showing a configuration and luminous fluxes of an imaging optical system according to Example 7.

FIG. 20 is a cross-sectional view showing a configuration and luminous fluxes of an imaging optical system according to Example 8.

FIG. 21 is a cross-sectional view showing a configuration and luminous fluxes of an imaging optical system according to Example 9.

FIG. 22 is a cross-sectional view showing a configuration and luminous fluxes of an imaging optical system according to Example 10.

FIG. 23 is a cross-sectional view showing a configuration and luminous fluxes of an imaging optical system according to Example 11.

FIG. 24 is a cross-sectional view showing a configuration and luminous fluxes of an imaging optical system according to Example 12.

FIG. 25 is a cross-sectional view showing a configuration and luminous fluxes of an imaging optical system according to Example 13.

FIG. 26 is a cross-sectional view showing a configuration and luminous fluxes of an imaging optical system according to Example 14.

FIG. 27 is a cross-sectional view showing a configuration and luminous fluxes of an imaging optical system according to Example 15.

FIG. 28 is a cross-sectional view showing a configuration of a modification example where the imaging optical system according to Example 15 is accommodated in a housing.

FIG. 29 is a schematic configuration diagram showing a projection type display device according to an embodiment.

FIG. 30 is a schematic configuration diagram showing a projection type display device according to another embodiment.

FIG. 31 is a schematic configuration diagram showing a projection type display device according to still another embodiment.

FIG. 32 is a schematic configuration diagram showing a projection type display device according to still another embodiment.

FIG. 33 is a perspective view of the front side of an imaging apparatus according to an embodiment.

FIG. 34 is a perspective view showing a rear side of the imaging apparatus shown in FIG. 33.

### DETAILED DESCRIPTION

Hereinafter, an embodiment of the present disclosed technology will be described with reference to the drawings.

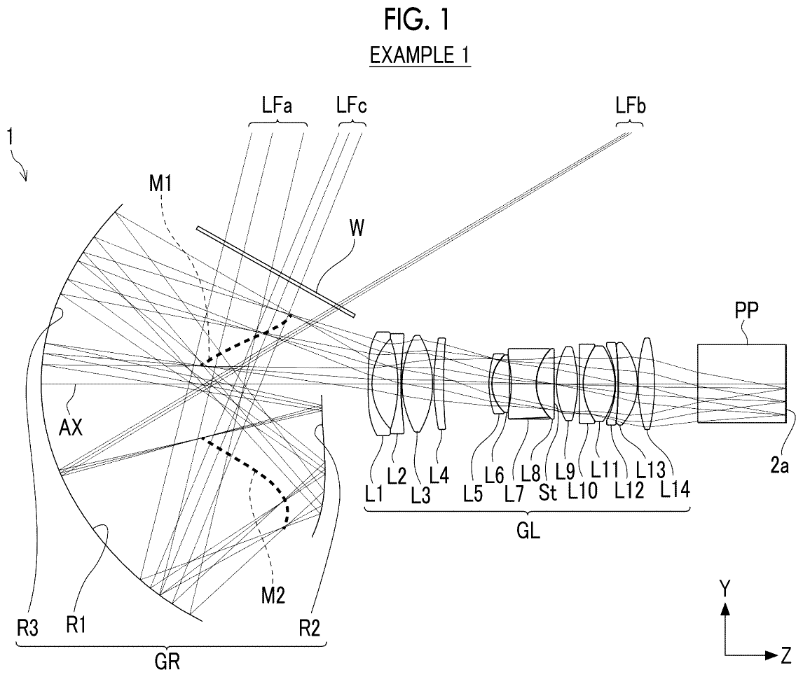

FIG. 1 is a cross-sectional view showing a configuration and luminous fluxes in a cross section including an optical axis AX of an imaging optical system 1 according to an embodiment of the present disclosure. The configuration example shown in FIG. 1 corresponds to Example 1 described below.

In the following description, a direction of the optical axis AX of the imaging optical system 1 will be referred to as a Z-axis direction. A direction that is perpendicular to the Z-axis direction and that is the vertical direction in FIG. 1 will be referred to as a Y-axis direction. A direction perpendicular to both of the Z-axis direction and the Y-axis direction will be referred to as an X-axis direction. The X-axis direction is a direction perpendicular to the paper plane of FIG. 1. Regarding the Y-axis direction, an upward direction of FIG. 1 will be referred to as an +Y-axis direction, and a downward direction will be referred to as −Y-axis direction.

The imaging optical system 1 can also be mounted on a projection type display device to configure a projection optical system where a display element is disposed on a reduction-side imaging plane. In addition, the imaging optical system can also be mounted on a digital camera or the like to configure an imaging optical system where an imaging element is disposed on the reduction-side imaging plane. Hereinafter, the description will be made assuming a case where the imaging optical system 1 is used for the projection optical system.

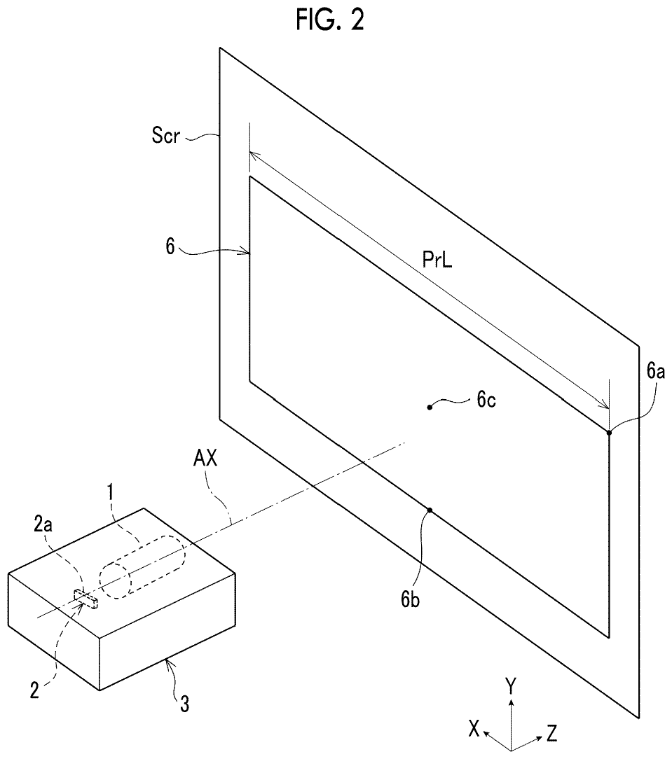

FIG. 2 is a diagram schematically showing a usage state of a projection type display device 3 according to an embodiment of the present disclosed technology. The projection type display device 3 includes the imaging optical system 1 and a display element 2 as a light valve. FIG. 2 schematically shows the imaging optical system 1 and the display element 2.

The display element 2 is an element that outputs an optical image, and this optical image is displayed as an image on a display surface 2a of the display element 2. As the display element 2, for example, a liquid crystal display element or an image display element such as digital micromirror device (DMD: registered trademark) can be used.

The imaging optical system 1 forms an enlarged image 6 on a screen Scr as a projected image by enlarging an image on the display surface 2a. The image displayed by the display element 2 has an optically conjugate relationship with the enlarged image 6. Optically, the image displayed by the display element 2 can be considered a reduction-side conjugate image, and the enlarged image 6 can be considered an enlargement-side conjugate image. The display surface 2a and the screen Scr are positioned at optically conjugate positions. The display surface 2a is an example of “reduction-side imaging plane” of the present disclosure, and the screen Scr is an example of “enlargement-side imaging plane” of the present disclosure.

It should be noted that, in the present specification, “screen” means an object on which a projected image formed by the imaging optical system 1 is projected. The screen may be, for example, not only a dedicated screen but also a wall surface of a room, a floor surface, a ceiling, an outer wall surface of a building, or the like.

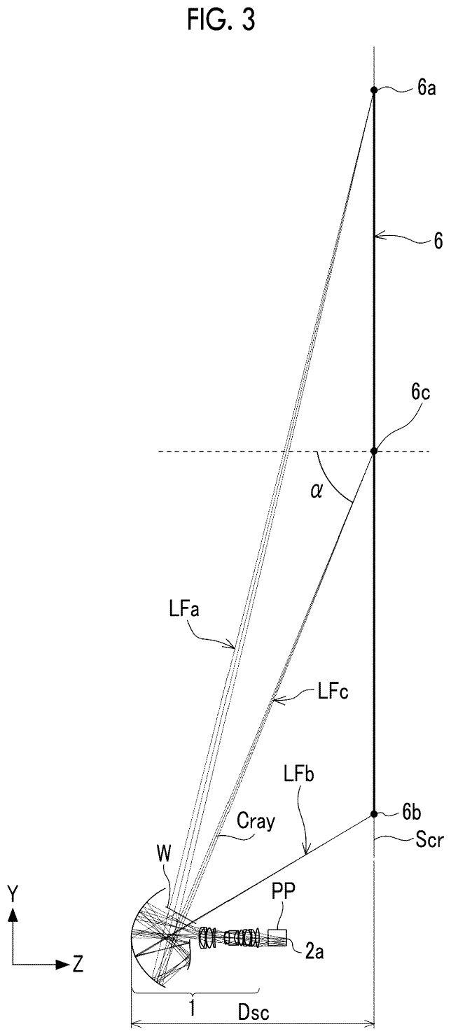

In FIG. 2, a reference numeral is added to a point 6b positioned immediately below a center 6c among a point 6a of an upper end corner, the center 6c, and a lower end point in the enlarged image 6. In FIG. 1, as the luminous fluxes, a ray LFa with a maximum angle of view, a ray LFc with an intermediate angle of view, and a ray LFb with a minimum angle of view are shown. As shown in FIG. 3, in the enlarged image 6, the ray LFa is focused on the point 6a, the ray LFc is focused on the center 6c, and the ray LFb is focused on the point 6b. FIG. 3 shows a configuration of the imaging optical system 1, the display surface 2a, the enlarged image 6, and the screen Scr in the cross section including the optical axis AX.

The imaging optical system 1 of FIG. 1 consists of an optical window W, a reflective optical system GR, and a refractive optical system GL including a plurality of lenses along an optical path in order from the enlargement side to the reduction side.

In addition, in the description of the present specification, “the enlargement side” refers to the screen Scr side on the optical path, and “the reduction side” refers to the display surface 2a side on the optical path. In the present specification, “the enlargement side” and “the reduction side” are determined along the optical path. For example, in the imaging optical system that forms a bent optical path, “a reflecting surface A is closer to the enlargement side than a reflecting surface B” has the same meaning as “the reflecting surface A is on the optical path to be closer to the enlargement side than the reflecting surface B”. In the imaging optical system that forms a bent optical path, “closest to the enlargement side” represents that a position is closest to the enlargement side in the arrangement order on the optical path, and does not represent that the position is closest to the screen Scr in terms of distance. Hereinafter, in order to avoid redundant description, “along the optical path in order from the enlargement side to the reduction side” will also be referred to as “in order from the enlargement side to the reduction side”.

The reflective optical system GR includes a first reflecting surface R1 having a positive power, a second reflecting surface R2 having a power, and a third reflecting surface R3 having a positive power along the optical path in order from the enlargement side to the reduction side.

Chromatic aberration does not occur on the reflecting surface itself. Therefore, by disposing three reflecting surfaces on the enlargement side in the imaging optical system 1, the occurrence of chromatic aberration in the entire optical system can be reduced. In addition, an optical path length can be easily ensured by the optical path where a ray is reflected three times. Therefore, the size can be reduced while achieving a wide angle, and further the power of each of optical elements can be reduced. As a result, a load on aberration correction and the like of the refractive optical system GL can be reduced, and thus the number of lenses of the refractive optical system GL can be reduced, which contributes to a reduction in size.

The first reflecting surface R1 and the third reflecting surface R3 may be formed of the same member and have the same surface shape. In this case, the time and the number of processes required for, for example, a relative alignment process of the reflecting surfaces during manufacturing can be reduced, which can contribute to cost reduction. In addition, performance deterioration caused by relative misalignment of the reflecting surfaces during manufacturing can be suppressed, which is advantageous in ensuring the performance.

“Being formed of the same member and having the same surface shape” represent a continuous surface having a shape that is formed based on the same design data. “The same design data” represents that curvature radii are the same in the case of a spherical shape, represents that aspheric equations and aspherical coefficients are the same in the case of an aspherical shape, and represents that free-form surface equations and free-form surface coefficients are the same in the case of a free-form surface shape.

For example, the first reflecting surface R1, the second reflecting surface R2, and the third reflecting surface R3 of FIG. 1 consist of mirror surfaces. For example, the refractive optical system GL of FIG. 1 consists of lenses L1 to L8, an aperture stop St, and lenses L9 to L14 in order from the enlargement side to the reduction side. The aperture stop St shown in FIG. 1 does not show the size or the shape thereof, but shows a position thereof in the optical axis direction. For example, the refractive optical system GL and the reflective optical system GR of FIG. 1 have the common optical axis AX. The configuration of the coaxial system can be set up more easily than a configuration other than the coaxial system. In a case where an optical surface of an optical component has a rotational symmetrical axis, the rotational symmetrical axis corresponds to the optical axis AX.

FIG. 1 shows an example where the optical member PP closer to the reduction side than the imaging optical system 1, and the display surface 2a of the display element 2 are disposed. The optical member PP is a member which is regarded as a filter, a cover glass, a color synthesis prism, or the like. The optical member PP has no power, and a configuration where the optical member PP is not provided can also be adopted. FIG. 2 does not show the optical member PP.

In the imaging optical system 1 of FIG. 1, a luminous flux from the display surface 2a to the enlargement side transmits through the optical member PP, transmits through the refractive optical system GL, and forms a first intermediate image M1. Next, the luminous flux is incident into the third reflecting surface R3 to be reflected from the third reflecting surface R3, is incident into the second reflecting surface R2 to be reflected from the second reflecting surface R2, and forms a second intermediate image M2. Next, the luminous flux is incident into the first reflecting surface R1 to be reflected from the first reflecting surface R1, transmits through the optical window W, and forms a projected image on the screen Scr (not shown in FIG. 1).

The imaging optical system 1 includes a bent optical path where a luminous flux is reflected three times, and is in a state where a luminous flux is focused as shown in FIG. 1. For example, assuming a surface perpendicular to the optical axis AX passing through the first intermediate image M1, a luminous flux transmits through this surface four times. In a case where dust or the like penetrates the optical path, light having a strong intensity runs into the dust or the like, which may cause a problem. Accordingly, in the imaging optical system 1, the optical window W closest to the enlargement side is disposed.

The optical window W consists of a refractive material having a light-transmitting property. The light-transmitting property represents that, for example, a transmittance with respect to a wavelength of a luminous flux is 80% or more. The optical window W is different from a simple opening portion opened to an external environment. By disposing the refractive material having a function as a window closest to the enlargement side in the imaging optical system 1, penetration of dust or the like from an external environment can be prevented. The region of the intended “optical window” of the present disclosure is a region where light can transmit, and does not include a mechanical component such as a window frame.

For example, the optical window W in the example of FIG. 1 is flat, and the external shape thereof is rectangular. However, the optical window according to the present disclosure is not limited to the example of FIG. 1 and can adopt various aspects. The detailed configuration of the optical window according to the present disclosure will be described.

In the imaging optical system 1, as images conjugate to the image displayed on the display surface 2a, at least two intermediate images including the first intermediate image M1 and the second intermediate image M2 are formed. By forming the intermediate images, the focal length of the imaging optical system 1 can be reduced to achieve a configuration suitable for increasing the angle of view. In addition, at least two intermediate images are formed which is advantageous in realizing an ultra-wide-angle optical system. In FIG. 1, the first intermediate image M1 and the second intermediate image M2 are indicated by conceptually thick broken lines. The shape of the first intermediate image M1 and the second intermediate image M2 shown in FIG. 1 is not necessarily accurate.

The first intermediate image M1 is formed at a position conjugate to the reduction-side imaging plane on the optical path closer to the reduction side than the third reflecting surface R3. It is preferable that the first intermediate image M1 is formed on the optical path between the third reflecting surface R3 and the refractive optical system GL. This way, in a case where the first intermediate image M1 is not formed in the refractive optical system GL, projection of scratches and/or dust of a lens can be suppressed, which is advantageous in forming a favorable projected image.

The second intermediate image M2 is formed at a position conjugate to the first intermediate image M1 in the reflective optical system GR. The enlarged image 6 is formed at a position conjugate to the second intermediate image M2. “In the reflective optical system GR” refers to the inside of the optical path from a surface closest to the enlargement side in the reflective optical system GR to a surface closest to the reduction side in the reflective optical system GR. By forming the second intermediate image M2 in the reflective optical system GR, projection of scratches and/or dust of a lens can be suppressed, which is advantageous in forming a favorable projected image.

It is preferable that the second intermediate image M2 is formed on the optical path between the first reflecting surface R1 and second reflecting surface R2. In this case, projection of scratches and/or dust of a reflecting surface can be suppressed, which is advantageous in forming a favorable projected image.

It is preferable that intermediate images formed closer to the enlargement side than the refractive optical system GL are only two intermediate images including the first intermediate image M1 and the second intermediate image M2. In this case, this configuration is advantageous in reducing the size while realizing a wide-angle optical system. In addition, in order to reduce the size, the intermediate images formed by the imaging optical system 1 may be configured to be only the two intermediate images including the first intermediate image M1 and the second intermediate image M2.

A refraction member may be configured not to be disposed on the optical path between the first reflecting surface R1 and the second reflecting surface R2. In a case where the refraction member is disposed on the optical path between the first reflecting surface R1 and the second reflecting surface R2, there is a defect that projection of scratches and/or dust of the refraction member may occur. By not disposing the refraction member, this defect can be avoided. In addition, this configuration can contribute to simplifying the device configuration. Due to the same reason, the refraction member may be configured not to be disposed on the optical path between the second reflecting surface R2 and the third reflecting surface R3.

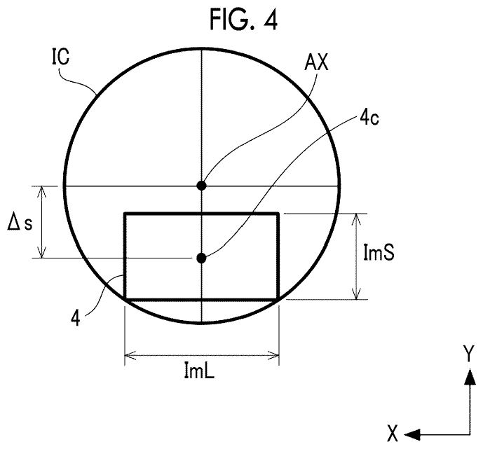

In the present example, the center of the image displayed on the display surface 2a is not positioned on the optical axis AX and is at a position shifted from the optical axis AX in the −Y-axis direction that is a direction perpendicular to the optical axis AX. FIG. 4 shows a schematic positional relationship between the optical axis AX on an image circle IC on the reduction side of the imaging optical system 1 and an image 4 displayed on the display surface 2a. In the present example, a long side direction of the image 4 is the X-axis direction, and a short side direction is the Y-axis direction. Hereinafter, the amount of the shift, that is, the distance between a center 4c of the image 4 and the optical axis AX will be referred to as a shift amount Δs. For example, in a case where the imaging optical system 1 and the display element 2 are movable relative to each other in the direction perpendicular to the optical axis AX, the shift amount Δs is variable.

In a state where the center 4c of the image 4 is at the position shifted from the optical axis AX in the −Y-axis direction, as shown in FIG. 3, the center 6c of the enlarged image 6 projected onto the screen Scr is also not positioned on the optical axis AX of the imaging optical system 1 and is also at a position shifted from the optical axis AX in the +Y-axis direction that is a direction perpendicular to the optical axis AX. With this configuration, the enlarged image 6 can be positioned above the imaging optical system 1. For example, this configuration is effective for a case where the projection type display device 3 is placed on a floor to project a projected image onto a screen or the like above the floor.

The center of the image displayed on the display surface 2a is an intersection between diagonals of a rectangle in a case where the image is rectangular, is the center of a circle in a case where the image is circular, and is an intersection between diagonals of a trapezoid in a case where the image is trapezoidal. Likewise, the center of the enlarged image that is a projected image is an intersection between diagonals of a rectangle in a case where the enlarged image is rectangular, is the center of a circle in a case where the enlarged image is circular, and is an intersection between diagonals of a trapezoid in a case where the enlarged image is trapezoidal.

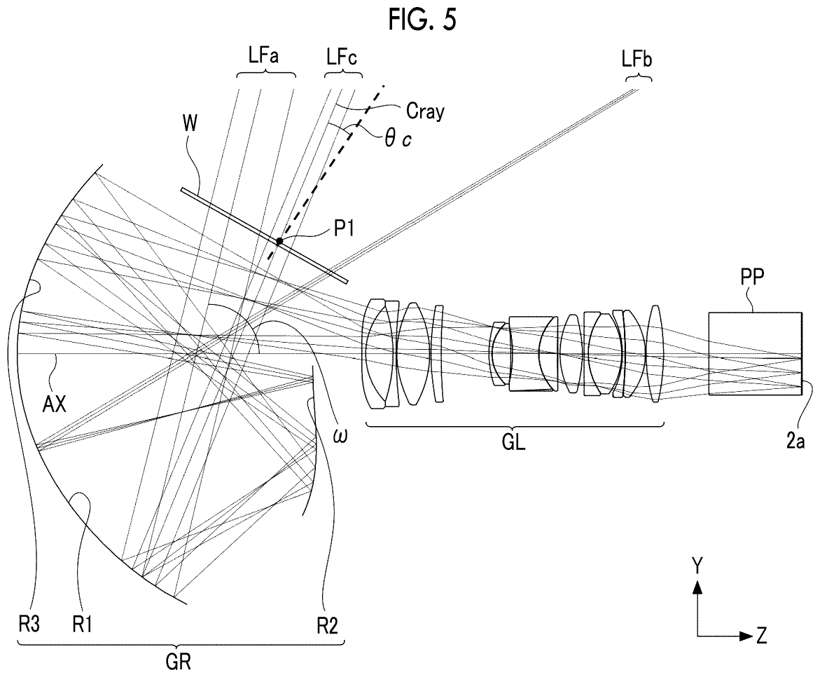

Hereinafter, a principal ray that is incident into the center 6c of the enlarged image 6 in a state where the shift amount Δs is maximum will be referred to as a center principal ray Cray. The center principal ray Cray is a ray in the luminous flux LFc. For example, FIGS. 3 and 5 show the center principal ray Cray. FIG. 5 shows a configuration in a cross section including the optical axis AX of the imaging optical system 1 of FIG. 1. FIG. 5 does not show some reference numerals as compared to FIG. 1.

It is preferable that, as shown in FIG. 5, an intersection P1 between the center principal ray Cray and a surface of the optical window W on the enlargement side is positioned closer to the third reflecting surface R3 side than the entire second reflecting surface R2 in the direction of the optical axis AX. In this case, this configuration is advantageous in reducing the size of the optical window W.

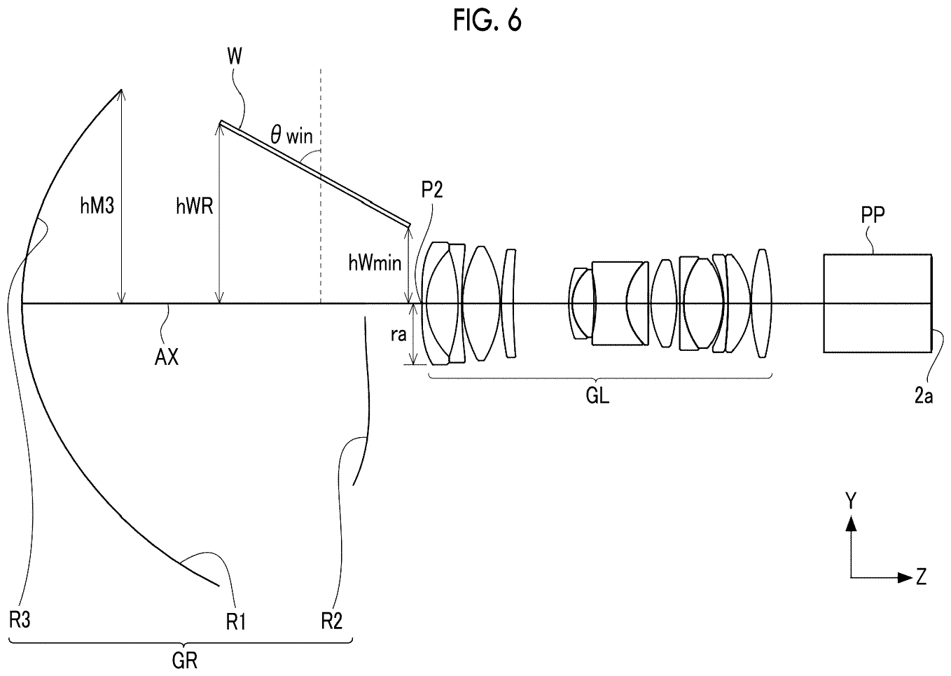

Further, in order to reduce the size of the optical window W, as shown in FIG. 6, it is preferable that the entire optical window W is positioned closer to the third reflecting surface R3 side than a point P2 positioned closest to the enlargement side in the refractive optical system GL in the direction of the optical axis AX. FIG. 6 shows a configuration in a cross section including the optical axis AX of the imaging optical system 1 of FIG. 1. For easy understanding, FIG. 6 does not show some reference numerals and luminous fluxes as compared to FIG. 1. In the example of FIG. 6, a surface closest to the enlargement side in the refractive optical system GL is a convex surface. Therefore, a surface apex (a point of the convex surface on the optical axis AX) is the point P2. However, in a case where a surface closest to the enlargement side in the refractive optical system GL is a concave surface, a point in a peripheral portion of the concave surface may be the point P2 positioned closest to the enlargement side in the refractive optical system GL instead of the point on the optical axis AX.

Next, preferable and possible configurations about conditional expressions of the imaging optical system according to the present disclosure will be described. In the following description, in order to avoid redundant description, “the imaging optical system of the present disclosure” will also be simply referred to as an “the imaging optical system”. In addition, in the following description relating to the conditional expressions, in order to avoid redundant description, factors having the same definition will be represented by the same symbols, and the description thereof will not be repeated.

In a case where an incidence angle of the center principal ray Cray into the enlargement-side imaging plane is represented by α, it is preferable that the imaging optical system satisfies Conditional Expression (1). In the present example, the screen Scr corresponds to the enlargement-side imaging plane. For example, FIG. 3 shows the above-described incidence angle α. In FIG. 3, a surface perpendicular to the screen Scr is indicated by a broken line. In the present example, the incidence angle α is an angle formed between the center principal ray Cray and a surface perpendicular to the enlargement-side imaging plane. By setting the corresponding value of Conditional Expression (1) not to be the lower limit value or less, this configuration is advantageous in increasing the angle of view of the imaging optical system. By setting the corresponding value of Conditional Expression (1) not to be the upper limit value or more, this configuration is advantageous in projecting an image on the plane without distortion.

$$40 ° < \vert α \vert < 85 ° and \qquad ( 1 )$$

In order to obtain more favorable characteristics, the lower limit value of Conditional Expression (1) is more preferably 50° and still more preferably 60°. In order to obtain more favorable characteristics, it is more preferable that the upper limit value of Conditional Expression (1) is 80°.

In a case where an incidence angle of the center principal ray Cray into the optical window W is represented by θc, it is preferable that the imaging optical system satisfies Conditional Expression (2). For example, FIG. 5 shows the above-described incidence angle θc. In FIG. 5, a surface perpendicular to the optical window W is indicated by a broken line. The lower limit of Conditional Expression (2) satisfies 0°<|θc| because |θc| is an absolute value. By setting the corresponding value of Conditional Expression (2) not to be the upper limit value or more, an increase in the size of the optical window W can be suppressed, and an increase in the length of the optical window W in the short side direction can be suppressed.

$$0 ° < \vert θ c \vert < 35 ° \qquad ( 2 )$$

In order to obtain more favorable characteristics, the upper limit value of Conditional Expression (2) is more preferably 30° and still more preferably 25°.

In a case where a maximum half angle of view of the enlargement side is represented by ω, it is preferable that the imaging optical system satisfies Conditional Expression (3). ω represents the maximum angle among angles between the optical axis AX and a principal ray from a surface closest to the enlargement side in the imaging optical system to the enlargement-side imaging plane. In the present example, ω corresponds to an angle between the principal ray of the ray LFa and the optical axis AX. For example, FIG. 5 shows the maximum half angle of view ω. By setting the corresponding value of Conditional Expression (3) not to be the lower limit value or less, a wide-angle optical system can be realized. By setting the corresponding value of Conditional Expression (3) not to be the upper limit value or more, shielding of a ray caused by relatively fine unevenness of a wall surface of the screen Scr can be suppressed.

$$65 ° < ω < 90 ° \qquad ( 3 )$$

In order to obtain more favorable characteristics, the lower limit value of Conditional Expression (3) is more preferably 70° and still more preferably 75°.

It is preferable that the imaging optical system satisfies Conditional Expression (4). Here, a distance between a point closest to the optical axis AX in the optical window W and the optical axis AX is represented by hWmin. A radius of a lens closest to the enlargement side in the refractive optical system GL is represented by ra. For example, FIG. 6 shows the distance hWmin and the radius ra. In a case where the external shape of the lens is non-circular, the maximum value among the radii of the lens is represented by ra. By setting the corresponding value of Conditional Expression (4) not to be the lower limit value or less, interference between the optical window W and the refractive optical system GL is easily prevented. By setting the corresponding value of Conditional Expression (4) not to be the upper limit value or more, this configuration is advantageous in reducing the size of the optical window W.

$$0.9 < hWmin / ra < 3 \qquad ( 4 )$$

In order to obtain more favorable characteristics, it is more preferable that the lower limit value of Conditional Expression (4) is 1. In order to obtain more favorable characteristics, the upper limit value of Conditional Expression (4) is more preferably 2.7 and still more preferably 2.5.

The optical window according to the present disclosure may be flat. In this case, the manufacturing is easy, which is advantageous in reducing the cost.

In a case where the optical window is flat, it is preferable that the imaging optical system satisfies Conditional Expression (5). Here, a distance between the optical axis AX and a point positioned closest to the optical axis AX among points positioned closest to the reflective optical system GR side in the optical window in the direction of the optical axis AX is represented by hWR. A distance between the optical axis AX and a point farthest from the optical axis AX among points in an effective region of the third reflecting surface R3 is represented by hM3. “The effective region” described herein refers to a region that is a mirror surface and has a reflectivity of 80% or more with respect to a wavelength of a luminous flux. For example, FIG. 6 shows the distance hWR and the distance hM3. By setting the corresponding value of Conditional Expression (5) not to be the lower limit value or less, interference between a luminous flux toward the third reflecting surface R3 and the optical window W is easily prevented. By setting the corresponding value of Conditional Expression (5) not to be the upper limit value or more, this configuration is advantageous in reducing the size of the optical window W.

$$0.5 < hWR / hM 3 < 3 \qquad ( 5 )$$

In order to obtain more favorable characteristics, it is more preferable that the lower limit value of Conditional Expression (5) is 0.7. In order to obtain more favorable characteristics, the upper limit value of Conditional Expression (5) is more preferably 2 and still more preferably 1.5.

In a case where the optical window is flat, it is preferable that the imaging optical system satisfies Conditional Expression (6). Here, a tilt angle of the optical window with respect to a surface perpendicular to the optical axis AX is represented by θwin. For example, FIG. 6 shows the above-described tilt angle θwin. In FIG. 6, a surface perpendicular to the optical axis AX is indicated by a broken line. By setting the corresponding value of Conditional Expression (6) not to be the lower limit value or less, the size of the optical window W is easily reduced while achieving a configuration capable of supporting a luminous flux having a high angle of view. By setting the corresponding value of Conditional Expression (6) not to be the upper limit value or more, the size of the optical window W is easily reduced while achieving a configuration capable of supporting a luminous flux having a low angle of view.

$$30 ° < θ win < 85 ° \qquad ( 6 )$$

In order to obtain more favorable characteristics, the lower limit value of Conditional Expression (6) is more preferably 40° and still more preferably 50°. In order to obtain more favorable characteristics, the upper limit value of Conditional Expression (6) is more preferably 82° and still more preferably 80°.

In a case where the optical window is flat, it is preferable that the imaging optical system satisfies Conditional Expression (7). Here, a shift amount that is a distance between the center 4c of the image 4 and the optical axis AX is represented by Δs. A length of a short side of the image 4 is represented by ImS. A minimum value of V defined by V=Δs/ImS is represented by Vmin. A length of a long side of a rectangle circumscribing the optical window is represented by WL. A distance in the direction of the optical axis AX from the first reflecting surface R1 to the enlarged image 6 is represented by Dsc. A length of a long side of the enlarged image 6 is represented by PrL. A length of a long side of the image 4 is represented by ImL. As described above, in a case where the imaging optical system 1 and the display element 2 are movable relative to each other in the direction perpendicular to the optical axis AX, the shift amount Δs is variable. Therefore, V is also variable. Vmin is the minimum value among values that can be adopted for V. By satisfying Conditional Expression (7), this configuration is advantageous in reducing the size of the optical window.

$$0 < ( V min - 0.5 ) \times W L \times ( Dsc / PrL ) / ImL < 1.2 \qquad ( 7 )$$

In order to obtain more favorable characteristics, the upper limit value of Conditional Expression (7) is more preferably 1 and still more preferably 0.8.

In a case where the optical window is rectangular, a length of a long side of the rectangle is represented by WL. In a case where the image displayed on the display surface 2a is not rectangular, a length of a short side of a rectangle circumscribing the image is represented by ImS, and a length of a long side of the rectangle is represented by ImL. In a case where the enlarged image projected onto the screen is not rectangular, a length of a long side of a rectangle circumscribing the enlarged image is represented by PrL.

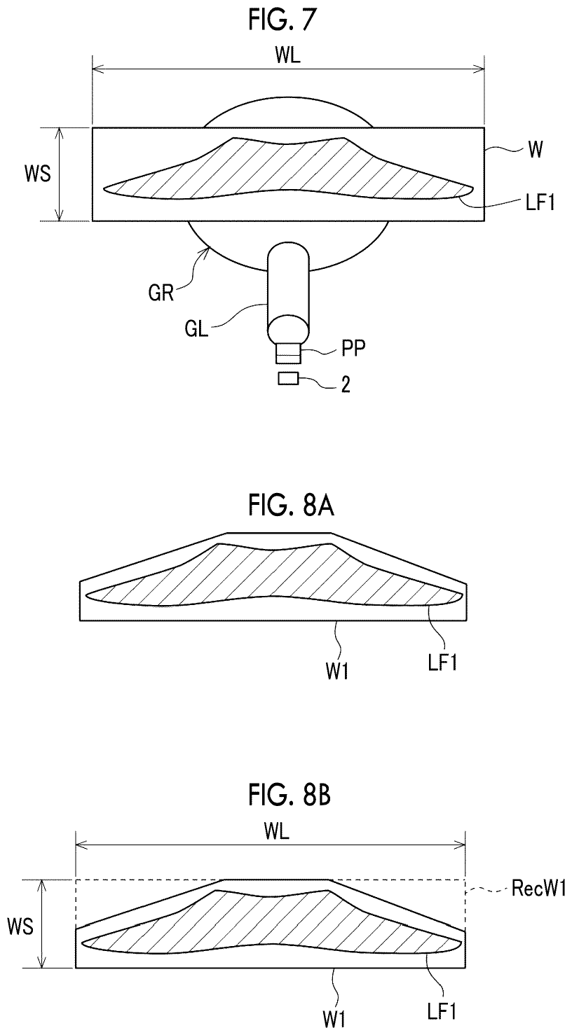

For example, FIG. 4 shows the shift amount Δs, the length ImS, and the length ImL. For example, FIG. 3 shows the distance Dsc, FIG. 2 shows the length PrL, and FIG. 7 shows the length WL.

FIG. 7 shows a schematic configuration diagram in a case where the imaging optical system, the optical member PP, and the display element 2 of FIG. 1 are seen from the top to the bottom of FIG. 1 in a normal direction of the optical window W. FIG. 7 schematically shows the reflective optical system GR, the refractive optical system GL, the optical member PP, and the display element 2. A long side direction of the optical window W of FIG. 7 is the X-axis direction that is the same as the long side direction of the image displayed by the display element 2. FIG. 7 shows the length WL of the long side of the optical window W and a length WS of the short side of the optical window W.

In FIG. 7, a diagonal line is added to a luminous flux cross section LF1 that is a cross section of a luminous flux for imaging on the surface of the optical window W. Hereinafter, for convenience of description, the cross section of the luminous flux for imaging on the surface of the optical window will be referred to as “luminous flux cross section”. The optical window W of FIG. 7 is a rectangle having a size including the luminous flux cross section LF1.

Note that, in the present disclosed technology, the external shape of the optical window is not limited to a rectangle and can be freely set. For example, a trapezoidal optical window W1 shown in FIG. 8A may be used as compared to the luminous flux cross section LF1 of FIG. 7. The luminous flux cross section LF1 of FIG. 8A has the same shape as that of the luminous flux cross section LF1 of FIG. 7. In FIG. 8B, a rectangle RecW1 circumscribing the optical window W1 is indicated by a broken line, and a length WL of a long side of the rectangle RecW1 and a length WS of a short side of the rectangle RecW1 are also shown. As compared to the optical window W of FIG. 7, the optical window W1 of FIG. 8A is more advantageous in reducing the size and the weight of the optical window, and is advantageous in shielding stray light that penetrates from an external environment.

In a case where the optical window is flat, it is preferable that the imaging optical system satisfies Conditional Expression (8). Here, a length of a short side of a rectangle circumscribing the optical window is represented by WS. By setting the corresponding value of Conditional Expression (8) not to be the lower limit value or less, this configuration is advantageous in increasing the angle of view of the imaging optical system. By setting the corresponding value of Conditional Expression (8) not to be the upper limit value or more, this configuration is advantageous in reducing the size of the optical window in the long side direction.

$$2 < WL / WS < 10 \qquad ( 8 )$$

In order to obtain more favorable characteristics, the lower limit value of Conditional Expression (8) is more preferably 3 and still more preferably 4. In order to obtain more favorable characteristics, the upper limit value of Conditional Expression (8) is more preferably 9 and still more preferably 8.

In a case where the optical window is flat, it is preferable that the imaging optical system satisfies Conditional Expression (9). By setting the corresponding value of Conditional Expression (9) not to be the lower limit value or less, this configuration is advantageous in increasing the angle of view of the imaging optical system. By setting the corresponding value of Conditional Expression (9) not to be the upper limit value or more, this configuration is advantageous in reducing the size of the optical window in the long side direction.

$$0.5 < ( V min - 0.5 ) \times WL / WS < 1.5 \qquad ( 9 )$$

In order to obtain more favorable characteristics, the lower limit value of Conditional Expression (9) is more preferably 0.6 and still more preferably 0.7. In order to obtain more favorable characteristics, the upper limit value of Conditional Expression (9) is more preferably 1.3 and still more preferably 1.1.

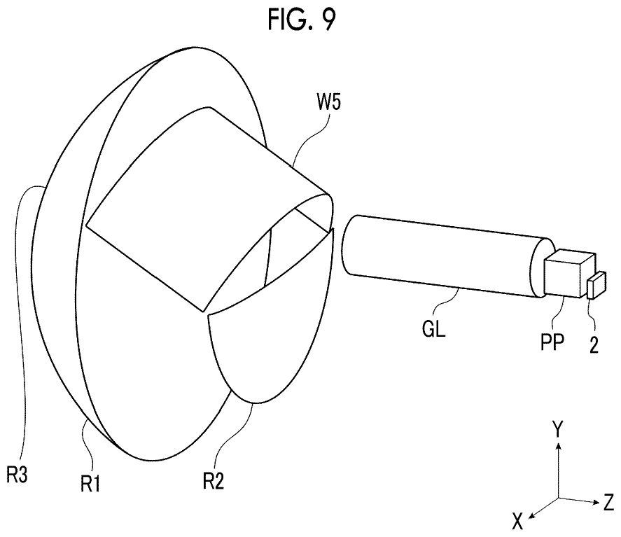

The optical window according to the present disclosure may have a curvature. The optical window has a curvature, which can contribute to a reduction in the size of the optical window. For example, by configuring the optical window to have a curvature in the long side direction of the image displayed by the display element 2, the size of the optical window in the long side direction can be reduced. For example, FIG. 9 is a perspective view showing a configuration of an imaging optical system including an optical window W5 having a curvature in the long side direction of the image displayed by the display element 2. In FIG. 9, the long side direction of the image is the X direction. FIG. 9 schematically shows each of the components.

In a case where the optical window has a curvature in the long side direction of the image displayed by the display element 2, it is preferable that the imaging optical system satisfies Conditional Expression (10). Here, a length of a long side of a projection of a rectangle circumscribing the optical window onto a surface perpendicular to a direction from a center of the curvature of the optical window toward an origin used in an equation defining a curved surface of the optical window is represented by WpL, and a length of a short side of the projection is represented by WpS. In a case where a surface of the optical window on the enlargement side and a surface of the optical window on the reduction side have a curvature, WpL and WpS are values regarding the surface of the optical window on the enlargement side. By setting the corresponding value of Conditional Expression (10) not to be the lower limit value or less, this configuration is advantageous in increasing the angle of view of the imaging optical system. By setting the corresponding value of Conditional Expression (10) not to be the upper limit value or more, this configuration is advantageous in reducing the size of the optical window in the long side direction.

$$1 < WpL / WpS < 3 \qquad ( 10 )$$

In order to obtain more favorable characteristics, the lower limit value of Conditional Expression (10) is more preferably 1.2 and still more preferably 1.5. In order to obtain more favorable characteristics, the upper limit value of Conditional Expression (10) is more preferably 2.8 and still more preferably 2.5.

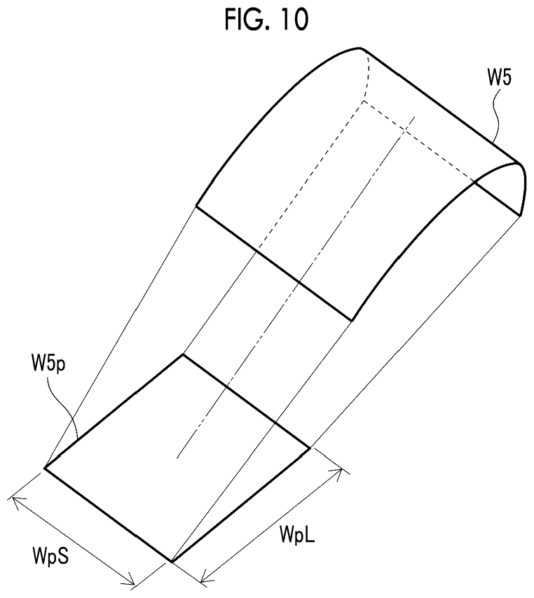

For example, FIG. 10 shows the optical window W5 having the curvature, the projection W5p, the length WpL, and the length WpS. In FIG. 10, the direction from the center of the curvature of the optical window W5 toward the origin used in the equation defining the curved surface of the optical window W5 is indicated by a two-dot chain line.

In a case where the optical window has a curvature, the optical window may consist of a cylindrical lens. Even in a case where the optical window has a curvature in the short side direction of the image, the effect of reducing the size is low. Even in a case where the optical window has a curvature in the long side direction of the image, the size can be effectively reduced. In addition, in a case where the optical window has a curvature only in either of the short side direction or the long side direction of the image, the manufacturing is easier as compared to a case where the optical window has a curvature in both of the short side direction and the long side direction of the image. From the above, by making the optical window to have a cylindrical shape, the size can be effectively reduced while ensuring the mass productivity.

In a case where the optical window is a cylindrical lens and a surface of the optical window on the reduction side is a cylindrical surface, it is preferable that the imaging optical system satisfies Conditional Expression (11). Here, a curvature radius of the cylindrical surface in a direction perpendicular to a generatrix of the cylindrical surface is represented by Rcy. That is, the direction perpendicular to the generatrix of the cylindrical surface is a direction having a curvature. The sign of Rcy is positive in a case where the cylindrical surface has a shape that is convex on the enlargement side, and is negative in a case where the cylindrical surface has a shape that is convex on the reduction side. By setting the corresponding value of Conditional Expression (11) not to be the lower limit value or less, this configuration is advantageous in reducing the size of the optical window in the direction having the curvature. By setting the corresponding value of Conditional Expression (11) not to be the upper limit value or more, the optical window can be suitably configured as the cylindrical lens.

$$1 < WpL / Rcy < 2 \qquad ( 11 )$$

In order to obtain more favorable characteristics, the lower limit value of Conditional Expression (11) is more preferably 1.2 and still more preferably 1.5.

In a case where the optical window is a cylindrical lens and a surface of the optical window on the reduction side is a cylindrical surface, it is preferable that the imaging optical system satisfies Conditional Expression (12). Here, a combined focal length of the reflective optical system GR and the refractive optical system GL in the imaging optical system is represented by fRL. By setting the corresponding value of Conditional Expression (12) not to be the lower limit value or less, this configuration is advantageous in reducing the size of the optical window in the direction having the curvature. The corresponding value of Conditional Expression (12) is set not to be the upper limit value or more, this configuration is advantageous in reducing the size of the imaging optical system.

$$0 < fRL / Rcy < 0.1 \qquad ( 12 )$$

In order to obtain more favorable characteristics, the upper limit value of Conditional Expression (12) is more preferably 0.08 and still more preferably 0.06.

In a case where the optical window has a curvature, the optical window may have a toric shape. In this case, the size is easily reduced according to the aspect ratio of the image.

In a case where the optical window has a curvature, the surface of the optical window on the enlargement side and the surface of the optical window on the reduction side may have a spherical shape. In this case, not only the effect of reducing the size but also the effect of imparting an aberration correction function to the optical window can be achieved. In addition, the optical window can be manufactured using the same method as that of a spherical lens, and thus an increase in cost can be suppressed.

In a case where the optical window has a curvature, the optical window may have an aspherical shape. In this case, not only the effect of reducing the size but also the effect of imparting a more favorable aberration correction function to the optical window can be achieved.

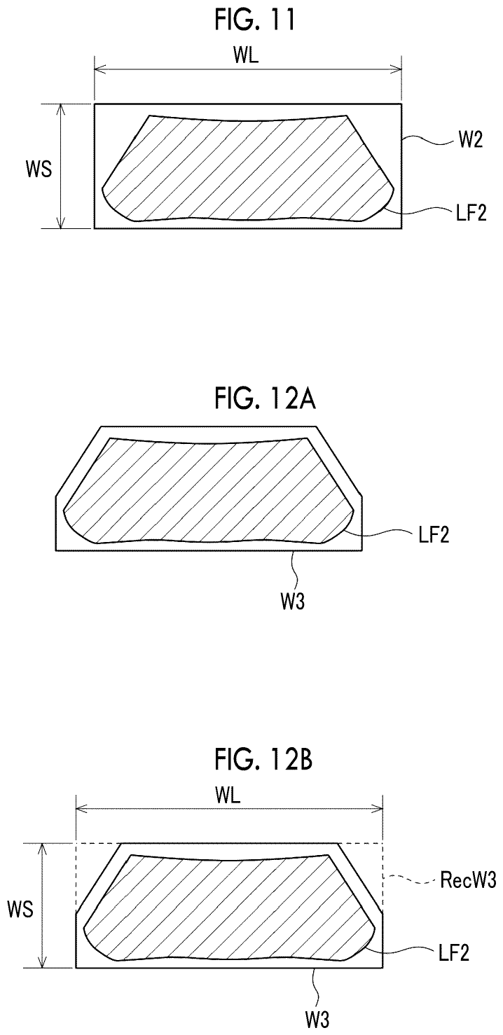

In a case where the optical window has a curvature, the luminous flux cross section varies depending on the curvature. In a case where the optical window has a curvature, “luminous flux cross section” refers to a cross section of a luminous flux for imaging on a tangent plane of the optical window at a center position of the surface of the optical window on the enlargement side. FIGS. 11, 12A, 12B, 13A, and 13B schematically show examples of the luminous flux cross section and the optical window.

FIG. 11 shows a luminous flux cross section LF2 and a rectangular optical window W2. In FIG. 11, a diagonal line is added to the luminous flux cross section LF2. The horizontal direction of FIG. 11 is the X-axis direction, that is, the long side direction of the image displayed by the display element. The luminous flux cross section LF2 is an example, for example, in a case where the optical window having a cylindrical shape is used.

A trapezoidal optical window W3 shown in FIG. 12A may be used in the luminous flux cross section LF2 of FIG. 11. The luminous flux cross section LF2 of FIG. 12A has the same shape as that of the luminous flux cross section LF2 of FIG. 11. In FIG. 12B, a rectangle RecW3 circumscribing the optical window W3 is indicated by a broken line, and a length WL of a long side of the rectangle RecW3 and a length WS of a short side of the rectangle RecW3 are also shown. As compared to the optical window W2 of FIG. 11, the optical window W3 of FIG. 12A is more advantageous in reducing the size and the weight of the optical window, and is advantageous in shielding stray light that penetrates from an external environment.

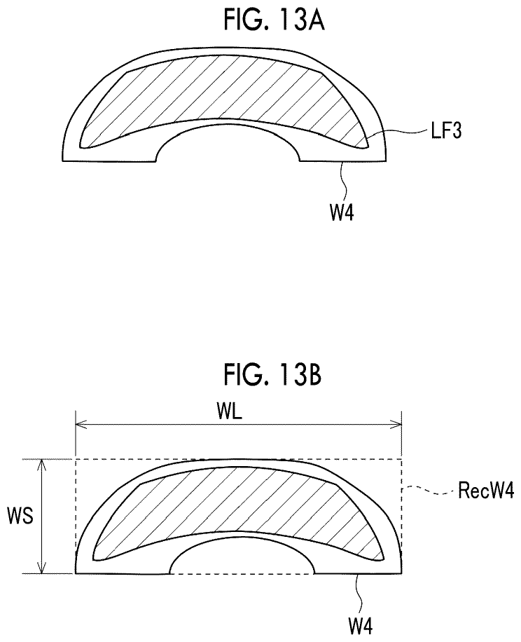

FIG. 13A shows a luminous flux cross section LF3 and an optical window W4 having a shape that is a part of a substantially toric shape. In FIG. 13A, a diagonal line is added to the luminous flux cross section LF3. The horizontal direction of FIG. 13A is the X-axis direction, that is, the long side direction of the image displayed by the display element. The luminous flux cross section LF3 is an example, for example, in a case where the optical window where the surface on the enlargement side and the surface on the reduction side are aspherical surfaces is used. In FIG. 13B, a rectangle RecW4 circumscribing the optical window W4 is indicated by a broken line, and a length WL of a long side of the rectangle RecW4 and a length WS of a short side of the rectangle RecW4 are also shown.

The reference numerals WL in FIGS. 7, 8B, 11, 12B, and 13B are intended to be used for the same concept, and do not need to have the same value. Likewise, the reference numerals WS in FIGS. 7, 8B, 11, 12B, and 13B are intended to be used for the same concept, and do not need to have the same value.

The preferable configurations and available configurations including the configurations regarding the conditional expressions can be freely combined within a range where they do not contradict each other, and it is preferable to appropriately selectively adopt the combination according to required specifications. Various modifications can be made without departing from the scope of the present disclosed technology.

For example, in the present disclosed technology, the number of lenses and the number of reflecting surfaces in the imaging optical system may be different from those in the example of FIG. 1. The reflective optical system GR may be configured to consist of the three reflecting surfaces, or may include an optical member other than the three reflecting surfaces. The reflecting surface is not limited to a mirror surface and may be, for example, a surface formed on a surface of a lens or a surface formed on a surface of a prism. The refractive optical system GL may include an optical member other than a lens. For example, the refractive optical system GL may include a plane mirror. The imaging optical system may include an optical path bending member not having a power to bend the optical path. As the optical path bending member, for example, a plane mirror or a reflecting surface of a prism can be used.

For example, one preferable aspect of the imaging optical system according to the present disclosure is an imaging optical system 1 that is capable of forming an enlarged image 6 on an enlargement-side imaging plane by enlarging an image 4 on a reduction-side imaging plane, the imaging optical system consisting of an optical window W, a reflective optical system GR, and a refractive optical system GL including a plurality of lenses along an optical path in order from an enlargement side to a reduction side, the reflective optical system GR includes a first reflecting surface R1 having a positive power, a second reflecting surface R2 having a power, and a third reflecting surface R3 having a positive power along the optical path in order from the enlargement side to the reduction side, a first intermediate image M1 is formed at a position conjugate to the image on the optical path closer to the reduction side than the third reflecting surface R3, a second intermediate image M2 is formed at a position conjugate to the first intermediate image M1 in the reflective optical system GR, the enlarged image is formed at a position conjugate to the second intermediate image M2 on the optical path closer to the enlargement side than the optical window W, a center of the enlarged image is at a position shifted from an optical axis AX of the refractive optical system GL in a direction perpendicular to the optical axis AX, and in a case where a principal ray that is incident into the center of the enlarged image in a state where an amount of the shift is maximum is a center principal ray Cray, Conditional Expressions (1) and (2) are satisfied.

Next, examples of the imaging optical system of the present disclosure will be described, with reference to the drawings. The reference numerals added to the components of the imaging optical system in a cross-sectional view of each of examples are used independently for each example in order to avoid complication of description and drawings due to an increase in the number of digits of the reference numerals. Therefore, even in a case where common reference numerals are added in the drawings of different examples, components do not necessarily have a common configuration.

### Example 1

FIG. 1 is a cross-sectional view of a configuration and luminous flux of an imaging optical system of Example 1, and an illustration method and a configuration thereof are as described above. Therefore, some description is not repeated herein.

The imaging optical system according to Example 1 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L8, an aperture stop St, and lenses L9 to L14 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 1 to 4 show data of the imaging optical system according to Example 1. Table 1 shows each of the configurations of the optical window W. Table 2 shows construction data of the reflective optical system GR, the refractive optical system GL, and the optical member PP. Table 3 shows specifications of a combined optical system where the reflective optical system GR and the refractive optical system GL are combined. Table 4 shows an aspherical coefficient of each of the aspherical surfaces.

In Table 1, “Center Position” shows the center position of the optical window W with respect to an intersection between the first reflecting surface R1 and the optical axis AX. “Normal Direction” shows the normal direction at the center position of the optical window W. “Size” shows the dimensions in a view from the normal direction of the optical window W. The X-axis direction is the long side direction. “Center Thickness” shows the center thickness in the normal direction. “Refractive Index” shows the refractive index with respect to the d line. “Abbe Number” shows the Abbe number with respect to the d line. The wavelength of the d line is 587.56 nanometers (nm).

In Table 2, the construction data is shown as follows. The “Sn” column shows surface numbers in a case where the surface closest to the enlargement side is the first surface and the number is increased one by one toward the reduction side. The R column shows a curvature radius of each surface. The D column shows a surface spacing between each surface and the surface adjacent to the reduction side on the optical axis AX. The Nd column shows a refractive index of each component with respect to the d line. The vd column shows an Abbe number of each component with respect to the d line. “Reflecting Surface” is filled in the Nd field of the row corresponding to each of the reflecting surfaces.

In the table of the construction data, the sign of the curvature radius of a surface that is convex to the enlargement side is positive, and the sign of the curvature radius of a surface that is convex to the reduction side is negative. In the fields of the surface number of the surface corresponding to the aperture stop St, the surface number and the expression (St) are shown. The value in the bottom field of the column D in the table indicates a spacing between the display surface 2a and the surface closest to the reduction side in the table.

Table 3 shows a focal length f, a back focus Bf in terms of an air conversion distance, a F-number FNo., a maximum total angle of view 2ω with respect to the d line in the combined optical system. [°] in the fields of 2ω indicates that the unit thereof is degree.

In the construction data, a reference sign * is added to surface numbers of aspherical surfaces, and values of paraxial curvature radius are shown in the fields of the curvature radius of the aspherical surface. In Table 4, the Sn row shows surface numbers of the aspherical surfaces, and the KA and Am rows show numerical values of the aspherical coefficients for each aspherical surface. Here, m of Am represents an integer of 3 or more and varies depending on the surface. For example, in the first surface of Example 1, m=3, 4, 5, . . . , and 20. The “E±n” (n: an integer) in the numerical values of the aspherical coefficients of Table 4 indicates “×10^{±n}”. KA and Am are the aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ A m \times {h}^{m}$$

where,
Zd is an aspherical surface depth (a length of a perpendicular from a point on an aspherical surface at a height h to a plane that is perpendicular to the optical axis AX and in contact with the aspherical surface apex),
h is a height (a distance from the optical axis AX to the lens surface),
C is a reciprocal of the paraxial curvature radius,
KA and Am are aspherical coefficients, and
Σ in the aspheric equation represents the total sum regarding m.

In the data of each of the tables, degrees are used as the unit of an angle, and millimeters (mm) are used as the unit of a length. However, appropriate different units may be used because the optical system can be used even in a case where the system is enlarged or reduced in proportion. Further, each of the following tables shows numerical values rounded off to predetermined decimal places.

TABLE 1
Example 1

| Center Position | 31 mm in Y-Axis Direction and 67 mm in Z-Axis |
|---|---|
| | Direction |
| Normal Direction | Direction in which Optical Axis AX is Rotated |
| | by 60° Around X-Axis as Rotation Axis |
| Shape | Flat Rectangle |
| Size | Long Side 235 mm, Short Side 56 mm |
| Center Thickness | 1 mm |
| Refractive Index | 1.51680 |
| Abbe Number | 64.20 |

TABLE 2
Example 1

| Sn | R | D | Nd | νd |
|---|---|---|---|---|
| *1 | 62.5759 | 78.1800 | Reflecting | |
| | | | Surface | |
| *2 | 227.4726 | −78.1800 | Reflecting | |
| | | | Surface | |
| *3 | 62.5759 | 91.1864 | Reflecting | |
| | | | Surface | |
| *4 | ∞ | 1.0400 | 1.72916 | 54.68 |
| 5 | 18.6285 | 7.2166 | | |
| 6 | −41.7154 | 0.8100 | 1.92286 | 20.88 |
| 7 | 111.2286 | 0.2000 | | |
| *8 | 25.5205 | 8.5400 | 1.51742 | 52.43 |
| 9 | −27.9500 | 0.3400 | | |
| *10 | 56.7987 | 2.7100 | 1.80518 | 25.46 |
| 11 | 158.5181 | 12.6619 | | |
| 12 | 27.4224 | 0.8000 | 1.90043 | 37.37 |
| 13 | 11.1730 | 4.9500 | 1.67270 | 32.10 |
| 14 | −75.7140 | 0.4682 | | |
| 15 | −34.0677 | 6.9600 | 1.90043 | 37.37 |
| 16 | 14.0954 | 4.9100 | 1.80809 | 22.76 |
| 17 | 406.7297 | 0.1200 | | |
| 18(St) | ∞ | 0.5800 | | |
| 19 | 22.6285 | 5.8800 | 1.51742 | 52.43 |
| *20 | −30.5443 | 0.6900 | | |
| 21 | ∞ | 0.9000 | 1.95375 | 32.32 |
| 22 | 18.8698 | 8.8300 | 1.48749 | 70.44 |
| 23 | −18.8698 | 0.2000 | | |
| 24 | −23.0909 | 0.9300 | 2.00069 | 25.46 |
| 25 | −101.7220 | 5.1400 | 1.48749 | 70.44 |
| 26 | −18.1195 | 0.2000 | | |
| 27 | 47.2808 | 4.6000 | 1.60311 | 60.64 |
| 28 | −59.5384 | 12.0000 | | |
| 29 | ∞ | 24.5000 | 1.51680 | 64.20 |
| 30 | ∞ | 0.2009 | | |

TABLE 3
Example 1

| | |
|---|---|
| f | 2.12 |
| Bf | 28.34 |
| FNo. | 1.80 |
| 2ω[°] | 158.0 |

TABLE 4
Example 1

| Sn | 1 | 2 | 3 |
|---|---|---|---|
| KA | 4.9484650E−01 | 2.1016143E+01 | 4.9484650E−01 |
| A3 | 2.0670685E−05 | 1.7408582E−04 | 2.0670685E−05 |
| A4 | −3.3224988E−06 | −7.1080471E−05 | −3.3224988E−06 |
| A5 | 1.7181164E−07 | 8.1664560E−06 | 1.7181164E−07 |
| A6 | 1.3803767E−09 | −2.3589031E−07 | 1.3803767E−09 |
| A7 | −4.0534139E−10 | −1.4905223E−08 | −4.0534139E−10 |
| A8 | 9.2215574E−12 | 9.2981646E−10 | 9.2215574E−12 |
| A9 | 2.0375333E−13 | 6.2385263E−12 | 2.0375333E−13 |
| A10 | −1.0060937E−14 | −1.3352700E−12 | −1.0060937E−14 |
| A11 | 1.6697234E−17 | 8.6845273E−15 | 1.6697234E−17 |
| A12 | 4.3017226E−18 | 1.1360941E−15 | 4.3017226E−18 |
| A13 | −4.5208445E−20 | −1.5481642E−17 | −4.5208445E−20 |
| A14 | −8.4810951E−22 | −6.3250099E−19 | −8.4810951E−22 |
| A15 | 1.5641416E−23 | 1.2890556E−20 | 1.5641416E−23 |
| A16 | 5.2893627E−26 | 1.8957439E−22 | 5.2893627E−26 |
| A17 | −2.3072995E−27 | −5.9555061E−24 | −2.3072995E−27 |
| A18 | 5.6058850E−30 | −4.4733331E−27 | 5.6058850E−30 |
| A19 | 1.2937950E−31 | 1.1394564E−27 | 1.2937950E−31 |
| A20 | −7.1642091E−34 | −8.2026634E−30 | −7.1642091E−34 |

| Sn | 4 | 8 | 10 | 20 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.1890529E−04 | −5.3626389E−05 | −1.4081630E−05 | 3.9779385E−05 |
| A5 | −8.8687390E−06 | 9.3189604E−06 | 4.2814060E−06 | −8.5327356E−07 |
| A6 | 1.6137207E−07 | −6.3984935E−07 | −1.0094215E−06 | 7.6658191E−08 |
| A7 | 3.6831937E−08 | −1.4050469E−08 | 9.0958580E−08 | −4.8679958E−09 |
| A8 | −2.1602541E−09 | 3.3884215E−09 | −1.0583872E−09 | −2.9616178E−10 |
| A9 | −2.7392546E−11 | −1.0920277E−10 | −3.0223454E−10 | 8.5785377E−12 |
| A10 | 3.0791861E−12 | −1.0565732E−13 | 1.3070503E−11 | 4.0225722E−13 |

Symbols, meanings, description methods, and illustration methods of the respective data pieces according to Example 1 are basically similar to those in the following examples unless otherwise specified. Therefore, hereinafter, repeated description will not be given. In the following examples, the X-axis direction, the Y-axis direction, and the Z-axis direction are the same as those of Example 1. In all of the following examples, the shape of the optical window W in a view from the normal direction of the optical window W is rectangular, and the long side direction of the rectangle is the X-axis direction. In an example including the optical window W having a curvature among the following examples, the tables showing each of the configurations of the optical window W show the values regarding the surface of the optical window W on the enlargement side.

### Example 2

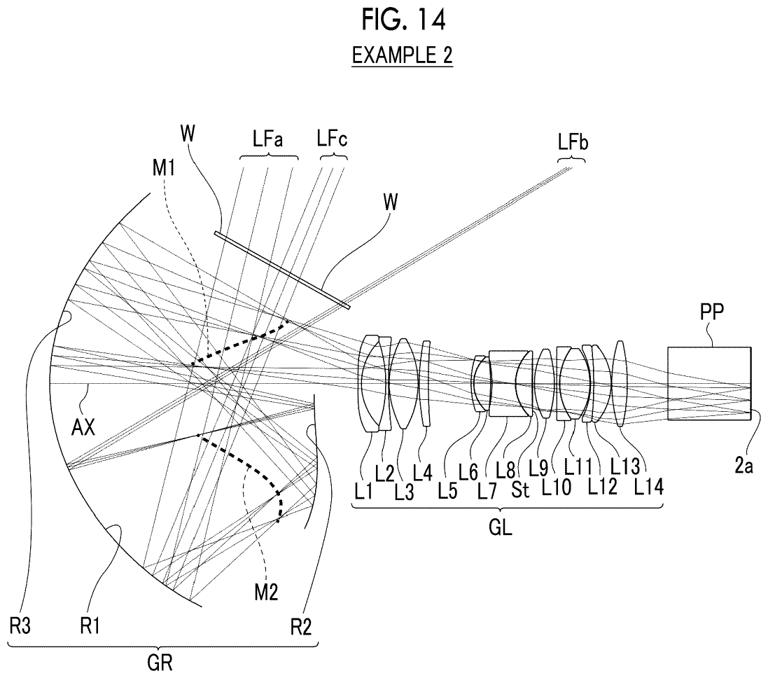

FIG. 14 is a cross-sectional view showing a configuration and luminous fluxes of an imaging optical system according to Example 2. The imaging optical system according to Example 2 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L8, an aperture stop St, and lenses L9 to L14 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 5 to 8 show data of the imaging optical system according to Example 2. Table 5 shows each of the configurations of the optical window W. Table 6 shows construction data of the reflective optical system GR, the refractive optical system GL, and the optical member PP. Table 7 shows specifications of a combined optical system where the reflective optical system GR and the refractive optical system GL are combined. Table 8 shows an aspherical coefficient of each of the aspherical surfaces.

TABLE 5
Example 2

| Center Position | 35 mm in Y-Axis Direction and 68 mm in Z-Axis |
|---|---|
| | Direction |
| Normal Direction | Direction in which Optical Axis AX is Rotated |
| | by 60° Around X-Axis as Rotation Axis |
| Shape | Cylindrical Shape, Curvature Radius of 50 mm |
| | in X-Axis Direction |
| Size | Long Side 90 mm, Short Side 46 mm |
| Center Thickness | 1 mm |
| Refractive Index | 1.51680 |
| Abbe Number | 64.20 |

TABLE 6
Example 2

| Sn | R | D | Nd | νd |
|---|---|---|---|---|
| *1 | 62.5759 | 78.1800 | Reflecting | |
| | | | Surface | |
| *2 | 227.4726 | −78.1800 | Reflecting | |
| | | | Surface | |
| *3 | 62.5759 | 91.1864 | Reflecting | |
| | | | Surface | |
| *4 | ∞ | 1.0400 | 1.72916 | 54.68 |
| 5 | 18.6285 | 7.2166 | | |
| 6 | −41.7154 | 0.8100 | 1.92286 | 20.88 |
| 7 | 111.2286 | 0.2000 | | |
| *8 | 25.5205 | 8.5400 | 1.51742 | 52.43 |
| 9 | −27.9500 | 0.3400 | | |
| *10 | 56.7987 | 2.7100 | 1.80518 | 25.46 |
| 11 | 158.5181 | 12.6619 | | |
| 12 | 27.4224 | 0.8000 | 1.90043 | 37.37 |
| 13 | 11.1730 | 4.9500 | 1.67270 | 32.10 |
| 14 | −75.7140 | 0.4682 | | |
| 15 | −34.0677 | 6.9600 | 1.90043 | 37.37 |
| 16 | 14.0954 | 4.9100 | 1.80809 | 22.76 |
| 17 | 406.7297 | 0.1200 | | |
| 18(St) | ∞ | 0.5800 | | |
| 19 | 22.6285 | 5.8800 | 1.51742 | 52.43 |
| *20 | −30.5443 | 0.6900 | | |
| 21 | ∞ | 0.9000 | 1.95375 | 32.32 |
| 22 | 18.8698 | 8.8300 | 1.48749 | 70.44 |
| 23 | −18.8698 | 0.2000 | | |
| 24 | −23.0909 | 0.9300 | 2.00069 | 25.46 |
| 25 | −101.7220 | 5.1400 | 1.48749 | 70.44 |
| 26 | −18.1195 | 0.2000 | | |
| 27 | 47.2808 | 4.6000 | 1.60311 | 60.64 |
| 28 | −59.5384 | 12.0000 | | |
| 29 | ∞ | 24.5000 | 1.51680 | 64.20 |
| 30 | ∞ | 0.2009 | | |

TABLE 7
Example 2

| | |
|---|---|
| f | 2.12 |
| Bf | 28.34 |
| FNo. | 1.80 |
| 2ω[°] | 158.0 |

TABLE 8
Example 2

| Sn | 1 | 2 | 3 |
|---|---|---|---|
| KA | 4.9484650E−01 | 2.1016143E+01 | 4.9484650E−01 |
| A3 | 2.0670685E−05 | 1.7408582E−04 | 2.0670685E−05 |
| A4 | −3.3224988E−06 | −7.1080471E−05 | −3.3224988E−06 |
| A5 | 1.7181164E−07 | 8.1664560E−06 | 1.7181164E−07 |
| A6 | 1.3803767E−09 | −2.3589031E−07 | 1.3803767E−09 |
| A7 | −4.0534139E−10 | −1.4905223E−08 | −4.0534139E−10 |
| A8 | 9.2215574E−12 | 9.2981646E−10 | 9.2215574E−12 |
| A9 | 2.0375333E−13 | 6.2385263E−12 | 2.0375333E−13 |
| A10 | −1.0060937E−14 | −1.3352700E−12 | −1.0060937E−14 |
| A11 | 1.6697234E−17 | 8.6845273E−15 | 1.6697234E−17 |
| A12 | 4.3017226E−18 | 1.1360941E−15 | 4.3017226E−18 |
| A13 | −4.5208445E−20 | −1.5481642E−17 | −4.5208445E−20 |
| A14 | −8.4810951E−22 | −6.3250099E−19 | −8.4810951E−22 |
| A15 | 1.5641416E−23 | 1.2890556E−20 | 1.5641416E−23 |
| A16 | 5.2893627E−26 | 1.8957439E−22 | 5.2893627E−26 |
| A17 | −2.3072995E−27 | −5.9555061E−24 | −2.3072995E−27 |
| A18 | 5.6058850E−30 | −4.4733331E−27 | 5.6058850E−30 |
| A19 | 1.2937950E−31 | 1.1394564E−27 | 1.2937950E−31 |
| A20 | −7.1642091E−34 | −8.2026634E−30 | −7.1642091E−34 |

| Sn | 4 | 8 | 10 | 20 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.1890529E−04 | −5.3626389E−05 | −1.4081630E−05 | 3.9779385E−05 |
| A5 | −8.8687390E−06 | 9.3189604E−06 | 4.2814060E−06 | −8.5327356E−07 |
| A6 | 1.6137207E−07 | −6.3984935E−07 | −1.0094215E−06 | 7.6658191E−08 |
| A7 | 3.6831937E−08 | −1.4050469E−08 | 9.0958580E−08 | −4.8679958E−09 |
| A8 | −2.1602541E−09 | 3.3884215E−09 | −1.0583872E−09 | −2.9616178E−10 |
| A9 | −2.7392546E−11 | −1.0920277E−10 | −3.0223454E−10 | 8.5785377E−12 |
| A10 | 3.0791861E−12 | −1.0565732E−13 | 1.3070503E−11 | 4.0225722E−13 |

### Example 3

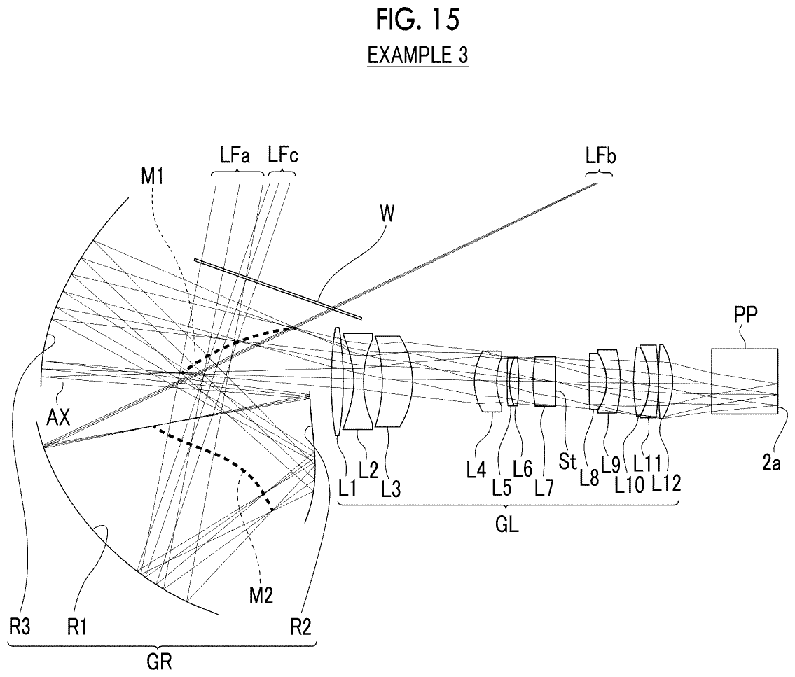

FIG. 15 is a cross-sectional view showing a configuration and luminous fluxes of an imaging optical system according to Example 3. The imaging optical system according to Example 3 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L7, an aperture stop St, and lenses L8 to L12 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 9 to 12 show data of the imaging optical system according to Example 3. Table 9 shows each of the configurations of the optical window W. Table 10 shows construction data of the reflective optical system GR, the refractive optical system GL, and the optical member PP. Table 11 shows specifications of a combined optical system where the reflective optical system GR and the refractive optical system GL are combined. Table 12 shows an aspherical coefficient of each of the aspherical surfaces.

TABLE 9
Example 3

| Center Position | 42 mm in Y-Axis Direction and 107 mm in Z-Axis |
|---|---|
| | Direction |
| Normal Direction | Direction in which Optical Axis AX is Rotated |
| | by 70° Around X-Axis as Rotation Axis |
| Shape | Flat Rectangle |
| Size | Long Side 580 mm, Short Side 78 mm |
| Center Thickness | 1 mm |
| Refractive Index | 1.51680 |
| Abbe Number | 64.20 |

TABLE 10
Example 3

| Sn | R | D | Nd | νd |
|---|---|---|---|---|
| *1 | 90.3999 | 121.6454 | Reflecting | |
| | | | Surface | |
| *2 | 147.9247 | −117.7919 | Reflecting | |
| | | | Surface | |
| *3 | 83.6336 | 127.3182 | Reflecting | |
| | | | Surface | |
| 4 | 161.5284 | 5.2820 | 1.75500 | 52.32 |
| 5 | −158.2707 | 4.6188 | | |
| *6 | −37.0785 | 4.2572 | 1.58913 | 61.15 |
| 7 | 47.2005 | 8.2408 | | |
| 8 | −67.8403 | 13.0733 | 1.49700 | 81.61 |
| 9 | −39.3828 | 27.1171 | | |
| 10 | 27.3006 | 9.7896 | 1.51742 | 52.43 |
| 11 | 30.1540 | 4.5544 | | |
| 12 | 194.0087 | 0.9991 | 1.80420 | 46.50 |
| 13 | 29.5222 | 0.1006 | | |
| 14 | 30.7206 | 4.0792 | 1.48749 | 70.44 |
| 15 | −81.7275 | 6.1880 | | |
| 16 | 59.5507 | 10.0009 | 1.59270 | 35.31 |
| 17(St) | −559.2067 | 14.6255 | | |
| 18 | 317.6939 | 7.6158 | 1.49700 | 81.61 |
| 19 | −22.7918 | 0.1000 | | |
| 20 | −22.3867 | 6.0009 | 1.87070 | 40.73 |
| 21 | −61.9365 | 5.8124 | | |
| 22 | 88.5399 | 6.8078 | 1.59282 | 68.62 |
| 23 | −32.2014 | 0.0995 | | |
| 24 | −31.6224 | 3.9317 | 1.87070 | 40.73 |
| 25 | −126.1715 | 0.0291 | | |
| 26 | 200.3045 | 6.2791 | 1.51633 | 64.06 |
| *27 | −32.1675 | 17.0500 | | |
| 28 | ∞ | 29.1000 | 1.51680 | 64.20 |
| 29 | ∞ | 0.0523 | | |

TABLE 11
Example 3

| | |
|---|---|
| f | 2.01 |
| Bf | 36.28 |
| FNo. | 2.00 |
| 2ω[°] | 143.6 |

TABLE 12
Example 3

| Sn | 1 | 2 | 3 |
|---|---|---|---|
| KA | 6.6097081E−01 | 3.4475110E+00 | −2.5498209E−01 |
| A3 | 1.4123225E−06 | −2.4574371E−05 | 5.4566756E−07 |
| A4 | −1.4271660E−07 | 9.3390310E−08 | −3.8473499E−07 |
| A5 | 7.5994413E−09 | 4.7407434E−08 | 1.9700320E−08 |
| A6 | −1.5905247E−10 | −4.1397122E−09 | −3.6362011E−10 |
| A7 | −1.4947711E−12 | 4.2113414E−11 | −5.4581013E−12 |
| A8 | 6.6594229E−14 | 1.6688648E−12 | 2.8765080E−13 |
| A9 | −1.3019224E−16 | −2.9297527E−14 | −1.8871006E−15 |
| A10 | −9.1849160E−18 | −2.4212041E−16 | −5.3233532E−17 |
| A11 | 4.4173419E−20 | 6.5208664E−18 | 7.6224954E−19 |
| A12 | 5.5661837E−22 | 8.2453988E−21 | 2.3293230E−21 |
| A13 | −3.1808508E−24 | −6.3278346E−22 | −8.5305630E−23 |
| A14 | −1.4369072E−26 | 9.7658860E−25 | 1.9762226E−25 |
| A15 | 7.3121202E−29 | 2.2788453E−26 | 3.1406445E−27 |
| A16 | 1.0706006E−31 | −6.4523411E−29 | −1.4462391E−29 |

| Sn | 6 | 27 |
|---|---|---|
| KA | 1.0000000E+00 | 1.0000000E+00 |
| A4 | 1.5143441E−05 | 2.6377709E−06 |
| A6 | −4.0488986E−08 | 1.9386282E−09 |
| A8 | 1.9269008E−10 | 8.1795177E−12 |
| A10 | −6.0807124E−13 | −1.1263682E−14 |
| A12 | 1.1272801E−15 | |
| A14 | −1.1218917E−18 | |
| A16 | 4.6597701E−22 | |

### Example 4

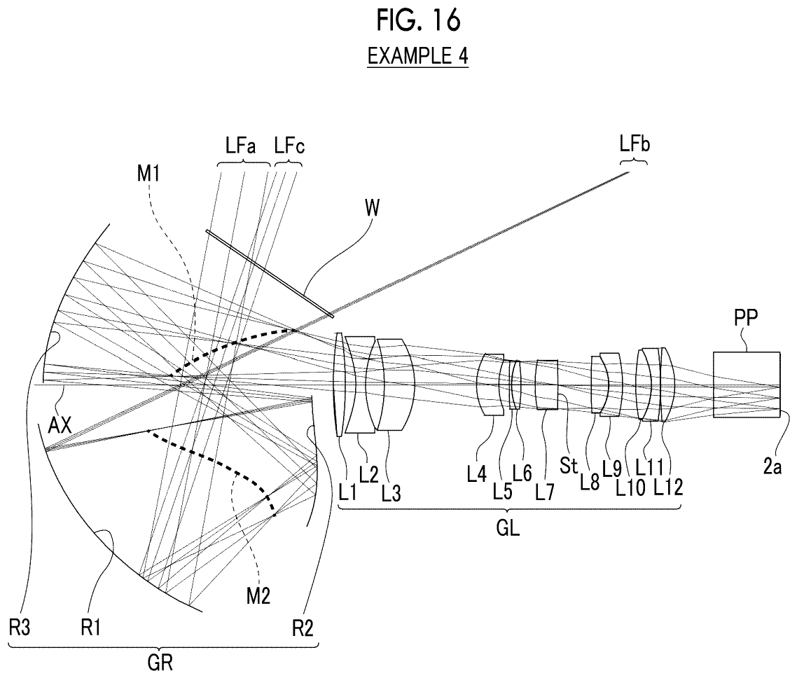

FIG. 16 is a cross-sectional view showing a configuration and luminous fluxes of an imaging optical system according to Example 4. The imaging optical system according to Example 4 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L7, an aperture stop St, and lenses L8 to L12 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 13 to 16 show data of the imaging optical system according to Example 4. Table 13 shows each of the configurations of the optical window W. Table 14 shows construction data of the reflective optical system GR, the refractive optical system GL, and the optical member PP. Table 15 shows specifications of a combined optical system where the reflective optical system GR and the refractive optical system GL are combined. Table 16 shows an aspherical coefficient of each of the aspherical surfaces.

TABLE 13
Example 4

| Center Position | 50.2 mm in Y-Axis Direction and 102.6 mm in Z-Axis |
|---|---|
| | Direction |
| Normal Direction | Direction in which Optical Axis AX is Rotated |
| | by 55° Around X-Axis as Rotation Axis |
| Shape | Cylindrical Shape, Curvature Radius of 62 mm in |
| | X-Axis Direction |
| Size | Long Side 122 mm, Short Side 68 mm |
| Center Thickness | 1 mm |
| Refractive Index | 1.51680 |
| Abbe Number | 64.20 |

TABLE 14
Example 4

| Sn | R | D | Nd | νd |
|---|---|---|---|---|
| *1 | 90.3999 | 121.6454 | Reflecting | |
| | | | Surface | |
| *2 | 147.9247 | −117.7919 | Reflecting | |
| | | | Surface | |
| *3 | 83.6336 | 127.3182 | Reflecting | |
| | | | Surface | |
| 4 | 161.5284 | 5.2820 | 1.75500 | 52.32 |
| 5 | −158.2707 | 4.6188 | | |
| *6 | −37.0785 | 4.2572 | 1.58913 | 61.15 |
| 7 | 47.2005 | 8.2408 | | |
| 8 | −67.8403 | 13.0733 | 1.49700 | 81.61 |
| 9 | −39.3828 | 27.1171 | | |
| 10 | 27.3006 | 9.7896 | 1.51742 | 52.43 |
| 11 | 30.1540 | 4.5544 | | |
| 12 | 194.0087 | 0.9991 | 1.80420 | 46.50 |
| 13 | 29.5222 | 0.1006 | | |
| 14 | 30.7206 | 4.0792 | 1.48749 | 70.44 |
| 15 | −81.7275 | 6.1880 | | |
| 16 | 59.5507 | 10.0009 | 1.59270 | 35.31 |
| 17(St) | −559.2067 | 14.6255 | | |
| 18 | 317.6939 | 7.6158 | 1.49700 | 81.61 |
| 19 | −22.7918 | 0.1000 | | |
| 20 | −22.3867 | 6.0009 | 1.87070 | 40.73 |
| 21 | −61.9365 | 5.8124 | | |
| 22 | 88.5399 | 6.8078 | 1.59282 | 68.62 |
| 23 | −32.2014 | 0.0995 | | |
| 24 | −31.6224 | 3.9317 | 1.87070 | 40.73 |
| 25 | −126.1715 | 0.0291 | | |
| 26 | 200.3045 | 6.2791 | 1.51633 | 64.06 |
| *27 | −32.1675 | 17.0500 | | |
| 28 | ∞ | 29.1000 | 1.51680 | 64.20 |
| 29 | ∞ | 0.0523 | | |

TABLE 15
Example 4

| | |
|---|---|
| f | 2.01 |
| Bf | 36.28 |
| FNo. | 2.00 |
| 2ω[°] | 143.6 |

TABLE 16
Example 4

| Sn | 1 | 2 | 3 |
|---|---|---|---|
| KA | 6.6097081E−01 | 3.4475110E+00 | −2.5498209E−01 |
| A3 | 1.4123225E−06 | −2.4574371E−05 | 5.4566756E−07 |
| A4 | −1.4271660E−07 | 9.3390310E−08 | −3.8473499E−07 |
| A5 | 7.5994413E−09 | 4.7407434E−08 | 1.9700320E−08 |
| A6 | −1.5905247E−10 | −4.1397122E−09 | −3.6362011E−10 |
| A7 | −1.4947711E−12 | 4.2113414E−11 | −5.4581013E−12 |
| A8 | 6.6594229E−14 | 1.6688648E−12 | 2.8765080E−13 |
| A9 | −1.3019224E−16 | −2.9297527E−14 | −1.8871006E−15 |
| A10 | −9.1849160E−18 | −2.4212041E−16 | −5.3233532E−17 |
| A11 | 4.4173419E−20 | 6.5208664E−18 | 7.6224954E−19 |
| A12 | 5.5661837E−22 | 8.2453988E−21 | 2.3293230E−21 |
| A13 | −3.1808508E−24 | −6.3278346E−22 | −8.5305630E−23 |
| A14 | −1.4369072E−26 | 9.7658860E−25 | 1.9762226E−25 |
| A15 | 7.3121202E−29 | 2.2788453E−26 | 3.1406445E−27 |
| A16 | 1.0706006E−31 | −6.4523411E−29 | −1.4462391E−29 |

| Sn | 6 | 27 |
|---|---|---|
| KA | 1.0000000E+00 | 1.0000000E+00 |
| A4 | 1.5143441E−05 | 2.6377709E−06 |
| A6 | −4.0488986E−08 | 1.9386282E−09 |
| A8 | 1.9269008E−10 | 8.1795177E−12 |
| A10 | −6.0807124E−13 | −1.1263682E−14 |
| A12 | 1.1272801E−15 | |
| A14 | −1.1218917E−18 | |
| A16 | 4.6597701E−22 | |

### Example 5

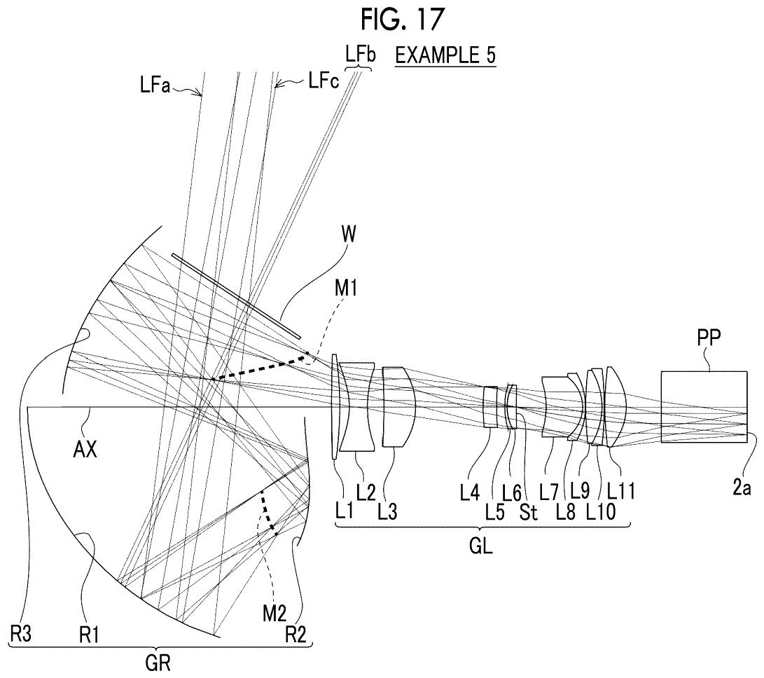

FIG. 17 shows a cross-sectional view of a configuration and luminous flux of the imaging optical system according to Example 5. The imaging optical system according to Example 5 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L6, an aperture stop intermediate image M1 is formed on the optical path between the refractive optical system GL and the third reflecting surface R3. A second intermediate image M2 is formed on the optical path between the second reflecting surface R2 and the first reflecting surface R1.

Tables 17 to 20 show data of the imaging optical system according to Example 5. Table 17 shows each of the configurations of the optical window W. Table 18 shows construction data of the reflective optical system GR, the refractive optical system GL, and the optical member PP. Table 19 shows specifications of a combined optical system where the reflective optical system GR and the refractive optical system GL are combined. Table 20 shows an aspherical coefficient of each of the aspherical surfaces.

TABLE 17
Example 5

| Center Position | 40 mm in Y-Axis Direction and 72.5 mm in Z-Axis |
|---|---|
| | Direction |
| Normal Direction | Direction in which Optical Axis AX is Rotated |
| | by 56° Around X-Axis as Rotation Axis |
| Shape | Flat Rectangle |
| Size | Long Side 404 mm, Short Side 54 mm |
| Center Thickness | 1 mm |
| Refractive Index | 1.51633 |
| Abbe Number | 64.14 |

TABLE 18
Example 5

| Sn | R | D | Nd | νd |
|---|---|---|---|---|
| *1 | 69.0780 | 97.1646 | Reflecting | |
| | | | Surface | |
| *2 | 115.9484 | −84.9678 | Reflecting | |
| | | | Surface | |
| *3 | 58.6129 | 94.4289 | Reflecting | |
| | | | Surface | |
| 4 | 500.0000 | 2.8950 | 1.84666 | 23.78 |
| 5 | −139.4545 | 3.3854 | | |
| *6 | −24.3818 | 6.3211 | 1.76450 | 49.10 |
| 7 | 42.2369 | 5.6093 | | |
| 8 | −266.2675 | 11.1087 | 1.43700 | 95.10 |
| 9 | −24.7687 | 23.6794 | | |
| 10 | 67.8589 | 4.7408 | 1.86966 | 20.02 |
| 11 | 113.6408 | 2.8196 | | |
| 12 | 27.2473 | 0.8010 | 1.80420 | 46.50 |
| 13 | 16.9347 | 0.0502 | | |
| 14 | 17.1536 | 3.2380 | 1.48749 | 70.44 |
| 15(St) | 1808.4665 | 10.4373 | | |
| 16 | −30.0619 | 12.7814 | 1.48749 | 70.44 |
| 17 | −13.7698 | 0.9997 | 1.87070 | 40.73 |
| 18 | −25.2899 | 0.0991 | | |
| 19 | 118.0186 | 5.6815 | 1.59282 | 68.62 |
| 20 | −26.2489 | 0.7999 | 1.80420 | 46.50 |
| 21 | −129.1262 | 0.2000 | | |
| *22 | 83.0722 | 7.5283 | 1.49700 | 81.61 |
| *23 | −20.3892 | 12.2900 | | |
| 24 | ∞ | 30.0900 | 1.51680 | 64.20 |
| 25 | ∞ | 0.0508 | | |

TABLE 19
Example 5

| | |
|---|---|
| f | 1.15 |
| Bf | 32.17 |
| FNo. | 2.19 |
| 2ω[°] | 169.6 |

TABLE 20
Example 5

| Sn | 1 | 2 | 3 |
|---|---|---|---|
| KA | 6.2310280E−01 | 3.9038253E+00 | 3.8038492E−02 |
| A3 | −2.2274506E−05 | −6.2177818E−05 | 2.7490561E−06 |
| A4 | 8.2698572E−07 | 5.9669729E−07 | −9.4493186E−07 |
| A5 | 3.2754170E−08 | 2.4483807E−07 | 3.5676281E−08 |
| A6 | −1.4811608E−09 | −2.1588202E−08 | −6.7746513E−10 |
| A7 | −9.5882579E−12 | 2.2095803E−10 | −1.5529893E−11 |
| A8 | 7.4398296E−13 | 1.6600439E−11 | 1.0087852E−12 |
| A9 | −8.3754329E−16 | −3.4884722E−13 | −9.5309283E−15 |
| A10 | −1.6238548E−16 | −4.5955809E−15 | −2.7924079E−16 |
| A11 | 5.9982361E−19 | 1.5182851E−16 | 5.5956379E−18 |
| A12 | 1.7300642E−20 | 3.0055912E−19 | 1.4137729E−20 |
| A13 | −7.3584090E−23 | −2.8170896E−20 | −9.3274233E−22 |
| A14 | −8.7601003E−25 | 6.5904201E−23 | 3.2991391E−24 |
| A15 | 2.8415104E−27 | 1.9240193E−24 | 5.1232084E−26 |
| A16 | 1.6503742E−29 | −8.2710970E−27 | −3.1686037E−28 |
| Sn | 6 | 22 | 23 |
| KA | 1.0000000E+00 | 1.0000000E+00 | 1.0000000E+00 |
| A4 | 5.6747070E−05 | −8.4522106E−06 | 1.2120375E−05 |
| A6 | −1.9498955E−07 | 1.5370673E−09 | 9.3616711E−09 |
| A8 | 1.0867483E−09 | 6.2982196E−11 | 8.9858877E−11 |
| A10 | −5.2121464E−12 | −1.9569357E−13 | −8.9198020E−14 |
| A12 | 1.6564685E−14 | | |
| A14 | −2.8938668E−17 | | |
| A16 | 2.1153248E−20 | | |

### Example 6

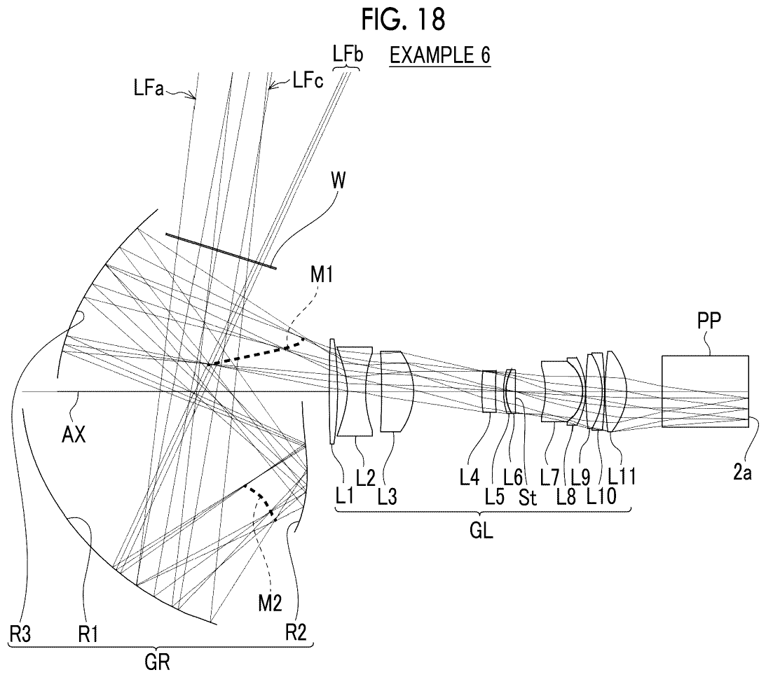

FIG. 18 is a cross-sectional view showing a configuration and luminous fluxes of an imaging optical system according to Example 6. The imaging optical system according to Example 6 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L6, an aperture stop intermediate image M1 is formed on the optical path between the refractive optical system GL and the third reflecting surface R3. A second intermediate image M2 is formed on the optical path between the second reflecting surface R2 and the first reflecting surface R1.

Tables 21 to 24 show data of the imaging optical system according to Example 6. Table 21 shows each of the configurations of the optical window W. Table 22 shows construction data of the reflective optical system GR, the refractive optical system GL, and the optical member PP. Table 23 shows specifications of a combined optical system where the reflective optical system GR and the refractive optical system GL are combined. Table 24 shows an aspherical coefficient of each of the aspherical surfaces.

TABLE 21
Example 6

| Center Position | 47.8 mm in Y-Axis Direction and 75.8 mm in Z-Axis |
|---|---|
| | Direction |
| Normal Direction | Direction in which Optical Axis AX is Rotated |
| | by 72° Around X-Axis as Rotation Axis |
| Shape | Cylindrical Shape, Curvature Radius of 55 mm in |
| | X-Axis Direction |
| Size | Long Side 108 mm, Short Side 50 mm |
| Center Thickness | 0.5 mm |
| Refractive Index | 1.53638 |
| Abbe Number | 56.09 |

TABLE 22
Example 6

| Sn | R | D | Nd | νd |
|---|---|---|---|---|
| *1 | 69.0780 | 97.1646 | Reflecting | |
| | | | Surface | |
| *2 | 115.9484 | −84.9678 | Reflecting | |
| | | | Surface | |
| *3 | 58.6129 | 94.4289 | Reflecting | |
| | | | Surface | |
| 4 | 500.0000 | 2.8950 | 1.84666 | 23.78 |
| 5 | −139.4545 | 3.3854 | | |
| *6 | −24.3818 | 6.3211 | 1.76450 | 49.10 |
| 7 | 42.2369 | 5.6093 | | |
| 8 | −266.2675 | 11.1087 | 1.43700 | 95.10 |
| 9 | −24.7687 | 23.6794 | | |
| 10 | 67.8589 | 4.7408 | 1.86966 | 20.02 |
| 11 | 113.6408 | 2.8196 | | |
| 12 | 27.2473 | 0.8010 | 1.80420 | 46.50 |
| 13 | 16.9347 | 0.0502 | | |
| 14 | 17.1536 | 3.2380 | 1.48749 | 70.44 |
| 15(St) | 1808.4665 | 10.4373 | | |
| 16 | −30.0619 | 12.7814 | 1.48749 | 70.44 |
| 17 | −13.7698 | 0.9997 | 1.87070 | 40.73 |
| 18 | −25.2899 | 0.0991 | | |
| 19 | 118.0186 | 5.6815 | 1.59282 | 68.62 |
| 20 | −26.2489 | 0.7999 | 1.80420 | 46.50 |
| 21 | −129.1262 | 0.2000 | | |
| *22 | 83.0722 | 7.5283 | 1.49700 | 81.61 |
| *23 | −20.3892 | 12.2900 | | |
| 24 | ∞ | 30.0900 | 1.51680 | 64.20 |
| 25 | ∞ | 0.0508 | | |

TABLE 23
Example 6

| | |
|---|---|
| f | 1.15 |
| Bf | 32.17 |
| FNo. | 2.19 |
| 2ω[°] | 169.6 |

TABLE 24
Example 6

| Sn | 1 | 2 | 3 |
|---|---|---|---|
| KA | 6.2310280E−01 | 3.9038253E+00 | 3.8038492E−02 |
| A3 | −2.2274506E−05 | −6.2177818E−05 | 2.7490561E−06 |
| A4 | 8.2698572E−07 | 5.9669729E−07 | −9.4493186E−07 |
| A5 | 3.2754170E−08 | 2.4483807E−07 | 3.5676281E−08 |
| A6 | −1.4811608E−09 | −2.1588202E−08 | −6.7746513E−10 |
| A7 | −9.5882579E−12 | 2.2095803E−10 | −1.5529893E−11 |
| A8 | 7.4398296E−13 | 1.6600439E−11 | 1.0087852E−12 |
| A9 | −8.3754329E−16 | −3.4884722E−13 | −9.5309283E−15 |
| A10 | −1.6238548E−16 | −4.5955809E−15 | −2.7924079E−16 |
| A11 | 5.9982361E−19 | 1.5182851E−16 | 5.5956379E−18 |
| A12 | 1.7300642E−20 | 3.0055912E−19 | 1.4137729E−20 |
| A13 | −7.3584090E−23 | −2.8170896E−20 | −9.3274233E−22 |
| A14 | −8.7601003E−25 | 6.5904201E−23 | 3.2991391E−24 |
| A15 | 2.8415104E−27 | 1.9240193E−24 | 5.1232084E−26 |
| A16 | 1.6503742E−29 | −8.2710970E−27 | −3.1686037E−28 |
| Sn | 6 | 22 | 23 |
| KA | 1.0000000E+00 | 1.0000000E+00 | 1.0000000E+00 |
| A4 | 5.6747070E−05 | −8.4522106E−06 | 1.2120375E−05 |
| A6 | −1.9498955E−07 | 1.5370673E−09 | 9.3616711E−09 |
| A8 | 1.0867483E−09 | 6.2982196E−11 | 8.9858877E−11 |
| A10 | −5.2121464E−12 | −1.9569357E−13 | −8.9198020E−14 |
| A12 | 1.6564685E−14 | | |
| A14 | −2.8938668E−17 | | |
| A16 | 2.1153248E−20 | | |

### Example 7

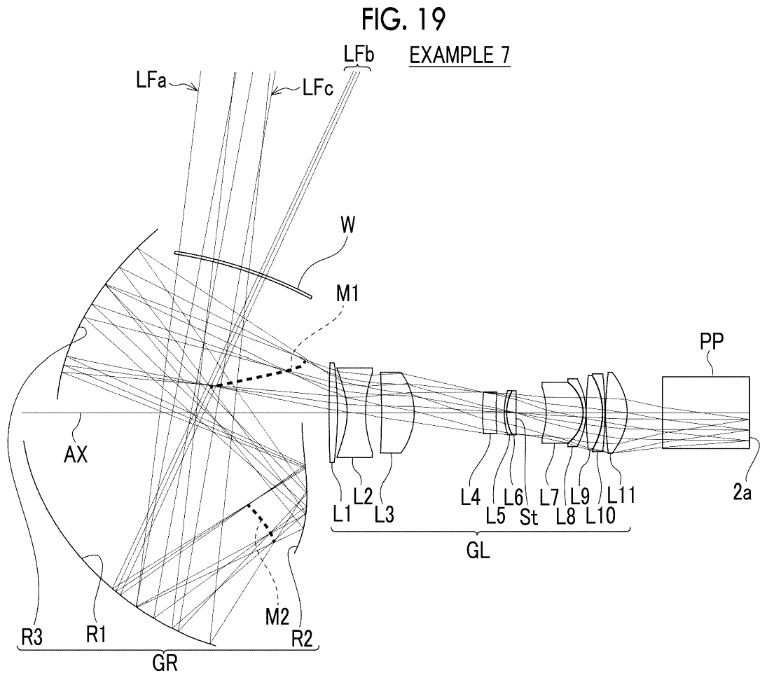

FIG. 19 is a cross-sectional view showing a configuration and luminous fluxes of an imaging optical system according to Example 7. The imaging optical system according to Example 7 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L6, an aperture stop intermediate image M1 is formed on the optical path between the refractive optical system GL and the third reflecting surface R3. A second intermediate image M2 is formed on the optical path between the second reflecting surface R2 and the first reflecting surface R1.

Tables 25 to 28 show data of the imaging optical system according to Example 7. Table 25 shows each of the configurations of the optical window W. In Table 25, “Origin of Equation of Curved Surface” shows the origin used in the equation defining the curved surface of the optical window W, and Table 25 shows the position of the origin with respect to the intersection between the first reflecting surface R1 and the optical axis AX. In Table 25, “Long side direction” and “Short side direction” of the “Shape” field show the directions in a case where the optical window W is seen from the normal direction of the optical window W. Table 26 shows construction data of the reflective optical system GR, the refractive optical system GL, and the optical member PP. Table 27 shows specifications of a combined optical system where the reflective optical system GR and the refractive optical system GL are combined. Table 28 shows an aspherical coefficient of each of the aspherical surfaces.

TABLE 25
Example 7

| Center Position | 51.2 mm in Y-Axis Direction and 76.7 mm in |
|---|---|
| | Z-Axis Direction |
| Origin of Equation | 50 mm in Y-Axis Direction and 80 mm in Z-Axis |
| of Curved Surface | Direction |
| Normal Direction | Direction in which Optical Axis AX is Rotated by |
| | 70° Around X-Axis as Rotation Axis |
| Shape | Toric Shape, Curvature Radius of 55 mm in Long |
| | Side Direction, Curvature Radius of 150 mm in |
| | Short Side Direction |
| Size | Long Side 109 mm, Short Side 50 mm |
| Center Thickness | 1 mm |
| Refractive Index | 1.51633 |
| Abbe Number | 64.14 |

TABLE 26
Example 7

| Sn | R | D | Nd | νd |
|---|---|---|---|---|
| *1 | 69.0780 | 97.1646 | Reflecting | |
| | | | Surface | |
| *2 | 115.9484 | −84.9678 | Reflecting | |
| | | | Surface | |
| *3 | 58.6129 | 94.4289 | Reflecting | |
| | | | Surface | |
| 4 | 500.0000 | 2.8950 | 1.84666 | 23.78 |
| 5 | −139.4545 | 3.3854 | | |
| *6 | −24.3818 | 6.3211 | 1.76450 | 49.10 |
| 7 | 42.2369 | 5.6093 | | |
| 8 | −266.2675 | 11.1087 | 1.43700 | 95.10 |
| 9 | −24.7687 | 23.6794 | | |
| 10 | 67.8589 | 4.7408 | 1.86966 | 20.02 |
| 11 | 113.6408 | 2.8196 | | |
| 12 | 27.2473 | 0.8010 | 1.80420 | 46.50 |
| 13 | 16.9347 | 0.0502 | | |
| 14 | 17.1536 | 3.2380 | 1.48749 | 70.44 |
| 15(St) | 1808.4665 | 10.4373 | | |
| 16 | −30.0619 | 12.7814 | 1.48749 | 70.44 |
| 17 | −13.7698 | 0.9997 | 1.87070 | 40.73 |
| 18 | −25.2899 | 0.0991 | | |
| 19 | 118.0186 | 5.6815 | 1.59282 | 68.62 |
| 20 | −26.2489 | 0.7999 | 1.80420 | 46.50 |
| 21 | −129.1262 | 0.2000 | | |
| *22 | 83.0722 | 7.5283 | 1.49700 | 81.61 |
| *23 | −20.3892 | 12.2900 | | |
| 24 | ∞ | 30.0900 | 1.51680 | 64.20 |
| 25 | ∞ | 0.0508 | | |

TABLE 27
Example 7

| | |
|---|---|
| f | 1.16 |
| Bf | 32.17 |
| FNo. | 2.19 |
| 2ω[°] | 169.6 |

TABLE 28
Example 7

| Sn | 1 | 2 | 3 |
|---|---|---|---|
| KA | 6.2310280E−01 | 3.9038253E+00 | 3.8038492E−02 |
| A3 | −2.2274506E−05 | −6.2177818E−05 | 2.7490561E−06 |
| A4 | 8.2698572E−07 | 5.9669729E−07 | −9.4493186E−07 |
| A5 | 3.2754170E−08 | 2.4483807E−07 | 3.5676281E−08 |
| A6 | −1.4811608E−09 | −2.1588202E−08 | −6.7746513E−10 |
| A7 | −9.5882579E−12 | 2.2095803E−10 | −1.5529893E−11 |
| A8 | 7.4398296E−13 | 1.6600439E−11 | 1.0087852E−12 |
| A9 | −8.3754329E−16 | −3.4884722E−13 | −9.5309283E−15 |
| A10 | −1.6238548E−16 | −4.5955809E−15 | −2.7924079E−16 |
| A11 | 5.9982361E−19 | 1.5182851E−16 | 5.5956379E−18 |
| A12 | 1.7300642E−20 | 3.0055912E−19 | 1.4137729E−20 |
| A13 | −7.3584090E−23 | −2.8170896E−20 | −9.3274233E−22 |
| A14 | −8.7601003E−25 | 6.5904201E−23 | 3.2991391E−24 |
| A15 | 2.8415104E−27 | 1.9240193E−24 | 5.1232084E−26 |
| A16 | 1.6503742E−29 | −8.2710970E−27 | −3.1686037E−28 |
| Sn | 6 | 22 | 23 |
| KA | 1.0000000E+00 | 1.0000000E+00 | 1.0000000E+00 |
| A4 | 5.6747070E−05 | −8.4522106E−06 | 1.2120375E−05 |
| A6 | −1.9498955E−07 | 1.5370673E−09 | 9.3616711E−09 |
| A8 | 1.0867483E−09 | 6.2982196E−11 | 8.9858877E−11 |
| A10 | −5.2121464E−12 | −1.9569357E−13 | −8.9198020E−14 |
| A12 | 1.6564685E−14 | | |
| A14 | −2.8938668E−17 | | |
| A16 | 2.1153248E−20 | | |

### Example 8

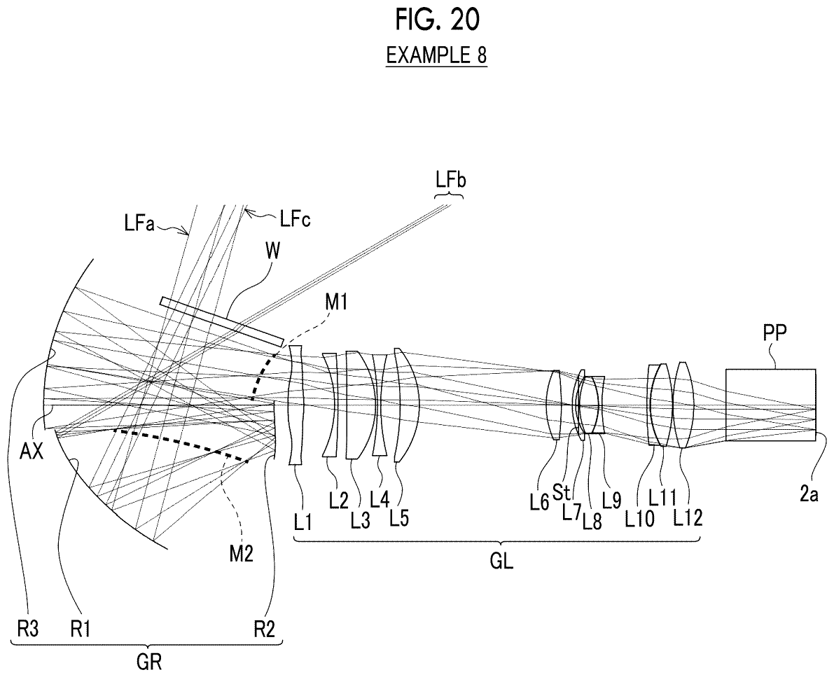

FIG. 20 is a cross-sectional view showing a configuration and luminous fluxes of an imaging optical system according to Example 8. The imaging optical system according to Example 8 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L6, an aperture stop St, and lenses L7 to L12. A first intermediate image M1 is formed on the optical path between the refractive optical system GL and the third reflecting surface R3. A second intermediate image M2 is formed on the optical path between the second reflecting surface R2 and the first reflecting surface R1.

Tables 29 to 32 show data of the imaging optical system according to Example 8. Table 29 shows each of the configurations of the optical window W. Table 30 shows construction data of the reflective optical system GR, the refractive optical system GL, and the optical member PP. Table 31 shows specifications of a combined optical system where the reflective optical system GR and the refractive optical system GL are combined. Table 32 shows an aspherical coefficient of each of the aspherical surfaces.

TABLE 29
Example 8

| Center Position | 32.1 mm in Y-Axis Direction and 61.6 mm in Z-Axis |
|---|---|
| | Direction |
| Normal Direction | Direction in which Optical Axis AX is Rotated |
| | by 70° Around X-Axis as Rotation Axis |
| Shape | Flat Rectangle |
| Size | Long Side 240 mm, Short Side 46 mm |
| Center Thickness | 3 mm |
| Refractive Index | 1.51680 |
| Abbe Number | 64.20 |

TABLE 30
Example 8

| Sn | R | D | Nd | νd |
|---|---|---|---|---|
| *1 | 32.0680 | 79.7500 | Reflecting | |
| | | | Surface | |
| *2 | 80.6818 | −82.4741 | Reflecting | |
| | | | Surface | |
| *3 | 88.6891 | 87.4742 | Reflecting | |
| | | | Surface | |
| *4 | −403.0262 | 5.7045 | 1.51007 | 56.24 |
| *5 | −25.5927 | 10.9735 | | |
| 6 | 42.1526 | 1.2000 | 1.60738 | 56.82 |
| 7 | −289.1760 | 3.2086 | | |
| 8 | −925.8158 | 10.2775 | 1.51742 | 52.43 |
| 9 | −33.9505 | 0.6883 | | |
| 10 | −98.2644 | 1.2004 | 1.80400 | 46.53 |
| 11 | 80.3752 | 6.9581 | | |
| 12 | −91.8902 | 6.8783 | 1.65844 | 50.88 |
| 13 | −34.0606 | 45.4956 | | |
| 14 | 32.2189 | 5.4094 | 1.48749 | 70.44 |
| 15 | −105.2785 | 5.9301 | | |
| 16(St) | ∞ | −2.0098 | | |
| 17 | 27.8787 | 1.2006 | 1.80400 | 46.53 |
| 18 | 18.8050 | 1.4514 | | |
| 19 | 27.2323 | 6.6969 | 1.51742 | 52.43 |
| 20 | −24.1411 | 0.1207 | | |
| 21 | −23.4680 | 1.2007 | 1.80440 | 39.58 |
| 22 | 57.7071 | 15.9036 | | |
| 23 | 153.4166 | 1.2009 | 1.79952 | 42.24 |
| 24 | 32.2895 | 7.9675 | 1.58913 | 61.13 |
| 25 | −51.7150 | 0.2000 | | |
| 26 | 52.3743 | 7.4921 | 1.53775 | 74.70 |
| 27 | −43.0537 | 11.5000 | | |
| 28 | ∞ | 32.1500 | 1.51680 | 64.20 |
| 29 | ∞ | 0.1597 | | |

TABLE 31
Example 8

| | |
|---|---|
| f | 2.53 |
| Bf | 32.84 |
| FNo. | 1.68 |
| 2ω[°] | 156.0 |

TABLE 32
Example 8

| Sn | 1 | 2 | 3 |
|---|---|---|---|
| KA | 2.7440972E−01 | 8.0209624E+00 | −1.0828293E+00 |
| A3 | 0.0000000E+00 | 0.0000000E+00 | 0.0000000E+00 |
| A4 | −1.5727758E−06 | −6.7444778E−05 | 2.8107038E−07 |
| A5 | −1.5475182E−07 | 6.1020501E−06 | 1.1521027E−08 |
| A6 | 7.0219118E−09 | 2.5265943E−08 | −1.0007724E−09 |
| A7 | −1.2329329E−11 | −3.9549098E−08 | 3.8248985E−11 |
| A8 | −5.7046655E−12 | 1.5376586E−09 | −4.8599481E−13 |
| A9 | 1.0247085E−13 | 8.6071456E−11 | −1.0659642E−14 |
| A10 | 1.3991962E−15 | −7.5624153E−12 | 3.9922946E−16 |
| A11 | −5.3804736E−17 | 8.3059010E−14 | −2.0046954E−18 |
| A12 | 1.4802709E−19 | 9.8785387E−15 | −7.9573484E−20 |
| A13 | 8.3939391E−21 | −4.3651349E−16 | 1.3430506E−21 |
| A14 | −7.3107825E−23 | 5.8950622E−18 | −6.4363051E−24 |

| Sn | 4 | 5 |
|---|---|---|
| KA | −1.0000000E+01 | −1.0000000E+01 |
| A3 | 0.0000000E+00 | 0.0000000E+00 |
| A4 | 3.9829966E−04 | 3.1878299E−04 |
| A5 | −4.1819476E−05 | −2.0498026E−05 |
| A6 | 2.1584398E−07 | −1.4788913E−06 |
| A7 | 1.9612557E−07 | 1.5862761E−07 |
| A8 | −1.0765950E−08 | 1.7232633E−09 |
| A9 | −1.9338022E−10 | −6.0910377E−10 |
| A10 | 2.9293499E−11 | 9.2284534E−12 |
| A11 | −1.5586060E−13 | 1.1122429E−12 |
| A12 | −3.4968563E−14 | −3.0281862E−14 |
| A13 | 6.2335940E−16 | −7.7271077E−16 |
| A14 | 3.2155229E−18 | 2.5797054E−17 |

### Example 9

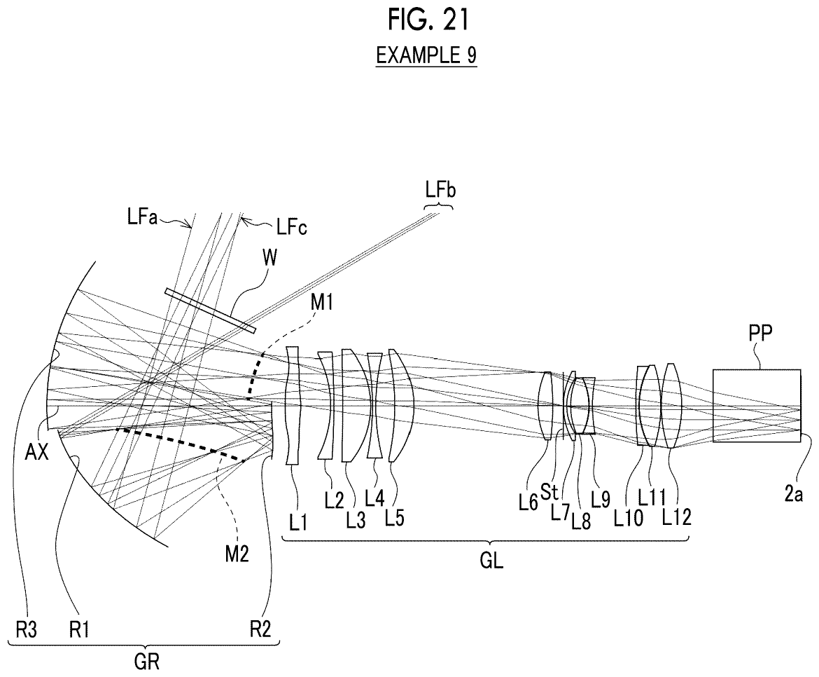

FIG. 21 is a cross-sectional view showing a configuration and luminous fluxes of an imaging optical system according to Example 9. The imaging optical system according to Example 9 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 to L6, an aperture stop St, and lenses L7 to L12 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 33 to 36 show data of the imaging optical system according to Example 9. Table 33 shows each of the configurations of the optical window W. Table 34 shows construction data of the reflective optical system GR, the refractive optical system GL, and the optical member PP. Table 35 shows specifications of a combined optical system where the reflective optical system GR and the refractive optical system GL are combined. Table 36 shows an aspherical coefficient of each of the aspherical surfaces.

TABLE 33
Example 9

| Center Position | 36.6 mm in Y-Axis Direction and 42.3 mm in Z-Axis |
|---|---|
| | Direction |
| Normal Direction | Direction in which Optical Axis AX is Rotated |
| | by 65° Around X-Axis as Rotation Axis |
| Shape | Cylindrical Shape, Curvature Radius of 50 mm in |
| | X-Axis Direction |
| Size | Long Side 95 mm, Short Side 36 mm |
| Center Thickness | 2 mm |
| Refractive Index | 1.51680 |
| Abbe Number | 64.20 |

TABLE 34
Example 9

| Sn | R | D | Nd | νd |
|---|---|---|---|---|
| *1 | 32.0680 | 79.7500 | Reflecting | |
| | | | Surface | |
| *2 | 80.6818 | −82.4741 | Reflecting | |
| | | | Surface | |
| *3 | 88.6891 | 87.4742 | Reflecting | |
| | | | Surface | |
| *4 | −403.0262 | 5.7045 | 1.51007 | 56.24 |
| *5 | −25.5927 | 10.9735 | | |
| 6 | −42.1526 | 1.2000 | 1.60738 | 56.82 |
| 7 | −289.1760 | 3.2086 | | |
| 8 | −925.8158 | 10.2775 | 1.51742 | 52.43 |
| 9 | −33.9505 | 0.6883 | | |
| 10 | −98.2644 | 1.2004 | 1.80400 | 46.53 |
| 11 | 80.3752 | 6.9581 | | |
| 12 | −91.8902 | 6.8783 | 1.65844 | 50.88 |
| 13 | −34.0606 | 45.4956 | | |
| 14 | 32.2189 | 5.4094 | 1.48749 | 70.44 |
| 15 | −105.2785 | 5.9301 | | |
| 16(St) | ∞ | −2.0098 | | |
| 17 | 27.8787 | 1.2006 | 1.80400 | 46.53 |
| 18 | 18.8050 | 1.4514 | | |
| 19 | 27.2323 | 6.6969 | 1.51742 | 52.43 |
| 20 | −24.1411 | 0.1207 | | |
| 21 | −23.4680 | 1.2007 | 1.80440 | 39.58 |
| 22 | 57.7071 | 15.9036 | | |
| 23 | 153.4166 | 1.2009 | 1.79952 | 42.24 |
| 24 | 32.2895 | 7.9675 | 1.58913 | 61.13 |
| 25 | −51.7150 | 0.2000 | | |
| 26 | 52.3743 | 7.4921 | 1.53775 | 74.70 |
| 27 | −43.0537 | 11.5000 | | |
| 28 | ∞ | 32.1500 | 1.51680 | 64.20 |
| 29 | ∞ | 0.1597 | | |

TABLE 35
Example 9

| | |
|---|---|
| f | 2.53 |
| Bf | 32.84 |
| FNo. | 1.68 |
| 2ω[°] | 156.0 |

TABLE 36
Example 9

| Sn | 1 | 2 | 3 |
|---|---|---|---|
| KA | 2.7440972E−01 | 8.0209624E+00 | −1.0828293E+00 |
| A3 | 0.0000000E+00 | 0.0000000E+00 | 0.0000000E+00 |
| A4 | −1.5727758E−06 | −6.7444778E−05 | 2.8107038E−07 |
| A5 | −1.5475182E−07 | 6.1020501E−06 | 1.1521027E−08 |
| A6 | 7.0219118E−09 | 2.5265943E−08 | −1.0007724E−09 |
| A7 | −1.2329329E−11 | −3.9549098E−08 | 3.8248985E−11 |
| A8 | −5.7046655E−12 | 1.5376586E−09 | −4.8599481E−13 |
| A9 | 1.0247085E−13 | 8.6071456E−11 | −1.0659642E−14 |
| A10 | 1.3991962E−15 | −7.5624153E−12 | 3.9922946E−16 |
| A11 | −5.3804736E−17 | 8.3059010E−14 | −2.0046954E−18 |
| A12 | 1.4802709E−19 | 9.8785387E−15 | −7.9573484E−20 |
| A13 | 8.3939391E−21 | −4.3651349E−16 | 1.3430506E−21 |
| A14 | −7.3107825E−23 | 5.8950622E−18 | −6.4363051E−24 |

| Sn | 4 | 5 |
|---|---|---|
| KA | −1.0000000E+01 | −1.0000000E+01 |
| A3 | 0.0000000E+00 | 0.0000000E+00 |
| A4 | 3.9829966E−04 | 3.1878299E−04 |
| A5 | −4.1819476E−05 | −2.0498026E−05 |
| A6 | 2.1584398E−07 | −1.4788913E−06 |
| A7 | 1.9612557E−07 | 1.5862761E−07 |
| A8 | −1.0765950E−08 | 1.7232633E−09 |
| A9 | −1.9338022E−10 | −6.0910377E−10 |
| A10 | 2.9293499E−11 | 9.2284534E−12 |
| A11 | −1.5586060E−13 | 1.1122429E−12 |
| A12 | −3.4968563E−14 | −3.0281862E−14 |
| A13 | 6.2335940E−16 | −7.7271077E−16 |
| A14 | 3.2155229E−18 | 2.5797054E−17 |

### Example 10

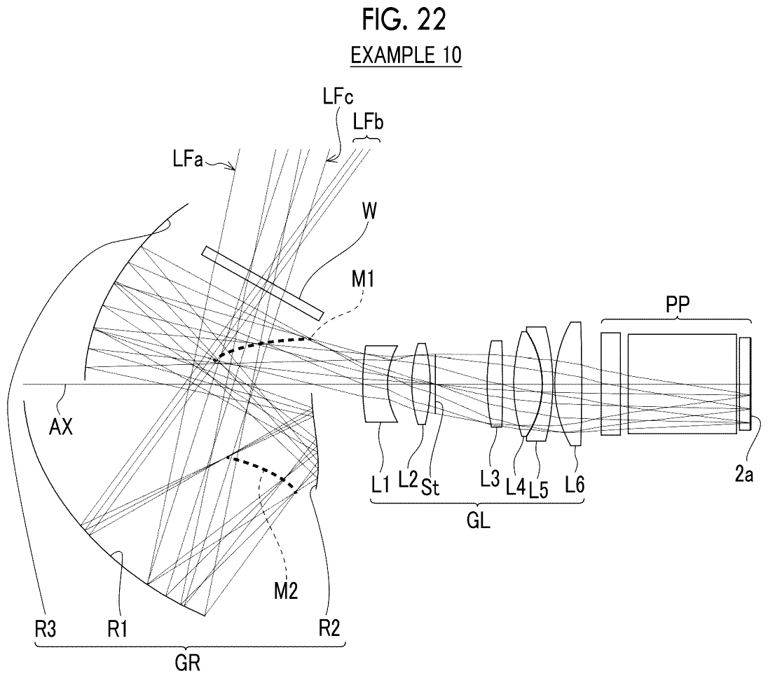

FIG. 22 is a cross-sectional view showing a configuration and luminous fluxes of an imaging optical system according to Example 10. The imaging optical system according to Example 10 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 and L2, an aperture stop St, and lenses L3 to L6 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 37 to 40 show data of the imaging optical system according to Example 10. Table 37 shows each of the configurations of the optical window W. Table 38 shows construction data of the reflective optical system GR, the refractive optical system GL, and the optical member PP. Table 39 shows specifications of a combined optical system where the reflective optical system GR and the refractive optical system GL are combined. Table 40 shows an aspherical coefficient of each of the aspherical surfaces.

TABLE 37
Example 10

| Center Position | 11 mm in Y-Axis Direction and 25 mm in Z-Axis |
|---|---|
| | Direction |
| Normal Direction | Direction in which Optical Axis AX is Rotated |
| | by 60° Around X-Axis as Rotation Axis |
| Shape | Flat Rectangle |
| Size | Long Side 46 mm, Short Side 14 mm |
| Center Thickness | 1 mm |
| Refractive Index | 1.51680 |
| Abbe Number | 64.20 |

TABLE 38
Example 10

| Sn | R | D | Nd | νd |
|---|---|---|---|---|
| *1 | 19.7221 | 29.7898 | Reflecting | |
| | | | Surface | |
| *2 | 26.6528 | −23.4282 | Reflecting | |
| | | | Surface | |
| *3 | 18.5347 | 28.7425 | Reflecting | |
| | | | Surface | |
| *4 | 33.9837 | 2.5143 | 1.80610 | 40.73 |
| *5 | 8.4813 | 2.4972 | | |
| 6 | 14.1369 | 1.9148 | 1.51742 | 52.15 |
| 7 | −17.8042 | 0.5189 | | |
| 8(St) | ∞ | 5.3607 | | |
| 9 | 23.8650 | 1.5900 | 1.56883 | 56.04 |
| 10 | −138.3622 | 1.1545 | | |
| 11 | 18.4597 | 2.9560 | 1.49700 | 81.61 |
| 12 | −10.1051 | 1.0782 | 1.84666 | 23.78 |
| 13 | −24.5577 | 0.2009 | | |
| 14 | 13.5944 | 2.8007 | 1.55397 | 71.76 |
| 15 | −181.6933 | 2.0008 | | |
| 16 | ∞ | 2.0000 | 1.51680 | 64.20 |
| 17 | ∞ | 0.8000 | | |
| 18 | ∞ | 11.2000 | 1.72342 | 37.95 |
| 19 | ∞ | 0.2000 | | |
| 20 | ∞ | 1.1000 | 1.48749 | 70.44 |
| 21 | ∞ | 0.0475 | | |

TABLE 39
Example 10

| | |
|---|---|
| f | 0.85 |
| Bf | 11.60 |
| FNo. | 2.00 |
| 2ω[°] | 160.6 |

TABLE 40
Example 10

| Sn | 1 | 2 | 3 |
|---|---|---|---|
| KA | 3.0254917E−01 | 5.1850683E+00 | −1.8105802E−01 |
| A3 | −9.5031709E−04 | 2.0105494E−03 | −4.9273974E−04 |
| A4 | 1.4950563E−04 | −1.7074575E−03 | 2.4339883E−04 |
| A5 | −1.8907199E−06 | 5.4263026E−04 | −5.5543976E−05 |
| A6 | −4.9759823E−07 | −7.9836465E−05 | 5.8496337E−06 |
| A7 | −1.0287458E−08 | −1.6804738E−06 | −7.9297237E−09 |
| A8 | 2.1940240E−09 | 1.9289363E−06 | −5.4324034E−08 |
| A9 | 6.7227745E−11 | −1.6244194E−07 | 3.5686820E−09 |
| A10 | −7.4972837E−12 | −1.1674184E−08 | 1.1525899E−10 |
| A11 | −8.9394184E−14 | 2.3030681E−09 | −1.8924245E−11 |
| A12 | 1.2624994E−14 | −2.7508297E−11 | 2.2396707E−13 |
| A13 | 2.4630130E−18 | −1.1822177E−11 | 3.6962211E−14 |
| A14 | −9.3301580E−18 | 4.8485752E−13 | −1.0545036E−15 |
| A15 | 3.9711889E−20 | 2.1098666E−14 | −2.3934104E−17 |
| A16 | 2.2377226E−21 | −1.2257663E−15 | 9.2618167E−19 |

| Sn | 4 | 5 |
|---|---|---|
| KA | 1.0000000E+00 | 1.0000000E+00 |
| A3 | 0.0000000E+00 | 1.1297561E−18 |
| A4 | 1.1400003E−04 | 6.4470365E−04 |
| A5 | 3.9438050E−04 | −2.4327474E−04 |
| A6 | −6.8380971E−05 | 2.8039901E−05 |
| A7 | −5.0676829E−05 | −1.8367005E−08 |
| A8 | 1.4369124E−05 | −1.5961557E−07 |
| A9 | 1.1109095E−06 | −4.2072390E−09 |
| A10 | −4.6856118E−07 | 1.3036972E−10 |

### Example 11

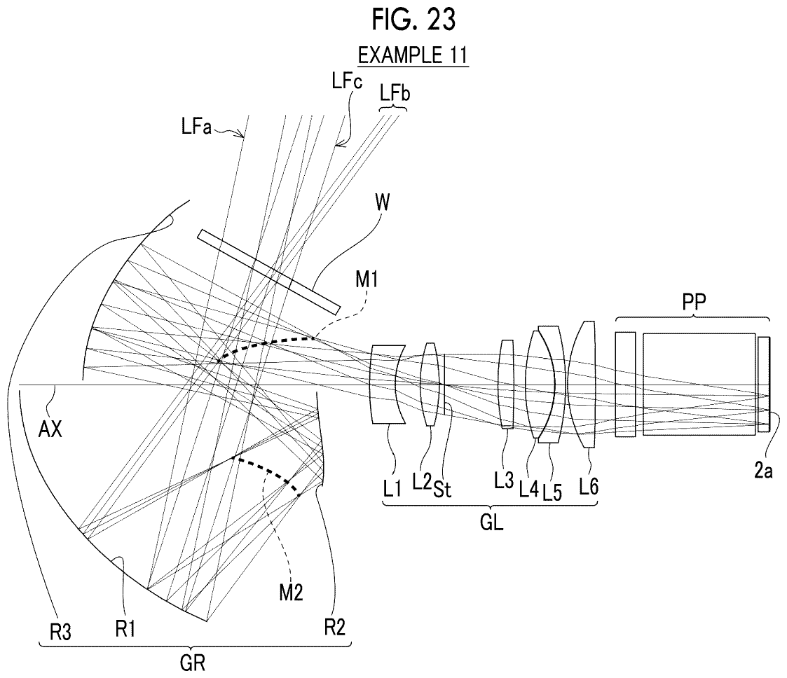

FIG. 23 is a cross-sectional view showing a configuration and luminous fluxes of an imaging optical system according to Example 11. The imaging optical system according to Example 11 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The refractive optical system GL consists of lenses L1 and L2, an aperture stop St, and lenses L3 to L6 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 41 to 44 show data of the imaging optical system according to Example 11. Table 41 shows each of the configurations of the optical window W. Table 42 shows construction data of the reflective optical system GR, the refractive optical system GL, and the optical member PP. Table 43 shows specifications of a combined optical system where the reflective optical system GR and the refractive optical system GL are combined. Table 44 shows an aspherical coefficient of each of the aspherical surfaces.

TABLE 41
Example 11

| Center Position | 24 mm in Y-Axis Direction and 50.5 mm in Z-Axis |
|---|---|
| | Direction |
| Normal Direction | Direction in which Optical Axis AX is Rotated |
| | by 60° Around X-Axis as Rotation Axis |
| Shape | Cylindrical Shape, Curvature Radius of 20 mm in |
| | X-Axis Direction |
| Size | Long Side 31 mm, Short Side 15 mm |
| Center Thickness | 2 mm |
| Refractive Index | 1.51680 |
| Abbe Number | 64.20 |

TABLE 42
Example 11

| Sn | R | D | Nd | νd |
|---|---|---|---|---|
| *1 | 19.7221 | 29.7898 | Reflecting | |
| | | | Surface | |
| *2 | 26.6528 | −23.4282 | Reflecting | |
| | | | Surface | |
| *3 | 18.5347 | 28.7425 | Reflecting | |
| | | | Surface | |
| *4 | 33.9837 | 2.5143 | 1.80610 | 40.73 |
| *5 | 8.4813 | 2.4972 | | |
| 6 | 14.1369 | 1.9148 | 1.51742 | 52.15 |
| 7 | −17.8042 | 0.5189 | | |
| 8(St) | ∞ | 5.3607 | | |
| 9 | 23.8650 | 1.5900 | 1.56883 | 56.04 |
| 10 | −138.3622 | 1.1545 | | |
| 11 | 18.4597 | 2.9560 | 1.49700 | 81.61 |
| 12 | −10.1051 | 1.0782 | 1.84666 | 23.78 |
| 13 | −24.5577 | 0.2009 | | |
| 14 | 13.5944 | 2.8007 | 1.55397 | 71.76 |
| 15 | −181.6933 | 2.0008 | | |
| 16 | ∞ | 2.0000 | 1.51680 | 64.20 |
| 17 | ∞ | 0.8000 | | |
| 18 | ∞ | 11.2000 | 1.72342 | 37.95 |
| 19 | ∞ | 0.3000 | | |
| 20 | ∞ | 1.1000 | 1.48749 | 70.44 |
| 21 | ∞ | 0.0475 | | |

TABLE 43
Example 11

| | |
|---|---|
| f | 0.85 |
| Bf | 11.60 |
| FNo. | 2.00 |
| 2ω[°] | 160.6 |

TABLE 44
Example 11

| Sn | 1 | 2 | 3 |
|---|---|---|---|
| KA | 3.0254917E−01 | 5.1850683E+00 | −1.8105802E−01 |
| A3 | −9.5031709E−04 | 2.0105494E−03 | −4.9273974E−04 |
| A4 | 1.4950563E−04 | −1.7074575E−03 | 2.4339883E−04 |
| A5 | −1.8907199E−06 | 5.4263026E−04 | −5.5543976E−05 |
| A6 | −4.9759823E−07 | −7.9836465E−05 | 5.8496337E−06 |
| A7 | −1.0287458E−08 | −1.6804738E−06 | −7.9297237E−09 |
| A8 | 2.1940240E−09 | 1.9289363E−06 | −5.4324034E−08 |
| A9 | 6.7227745E−11 | −1.6244194E−07 | 3.5686820E−09 |
| A10 | −7.4972837E−12 | −1.1674184E−08 | 1.1525899E−10 |
| A11 | −8.9394184E−14 | 2.3030681E−09 | −1.8924245E−11 |
| A12 | 1.2624994E−14 | −2.7508297E−11 | 2.2396707E−13 |
| A13 | 2.4630130E−18 | −1.1822177E−11 | 3.6962211E−14 |
| A14 | −9.3301580E−18 | 4.8485752E−13 | −1.0545036E−15 |
| A15 | 3.9711889E−20 | 2.1098666E−14 | −2.3934104E−17 |
| A16 | 2.2377226E−21 | −1.2257663E−15 | 9.2618167E−19 |

| Sn | 4 | 5 |
|---|---|---|
| KA | 1.0000000E+00 | 1.0000000E+00 |
| A3 | 0.0000000E+00 | 1.1297561E−18 |
| A4 | 1.1400003E−04 | 6.4470365E−04 |
| A5 | 3.9438050E−04 | −2.4327474E−04 |
| A6 | −6.8380971E−05 | 2.8039901E−05 |
| A7 | −5.0676829E−05 | −1.8367005E−08 |
| A8 | 1.4369124E−05 | −1.5961557E−07 |
| A9 | 1.1109095E−06 | −4.2072390E−09 |
| A10 | −4.6856118E−07 | 1.3036972E−10 |

### Example 12

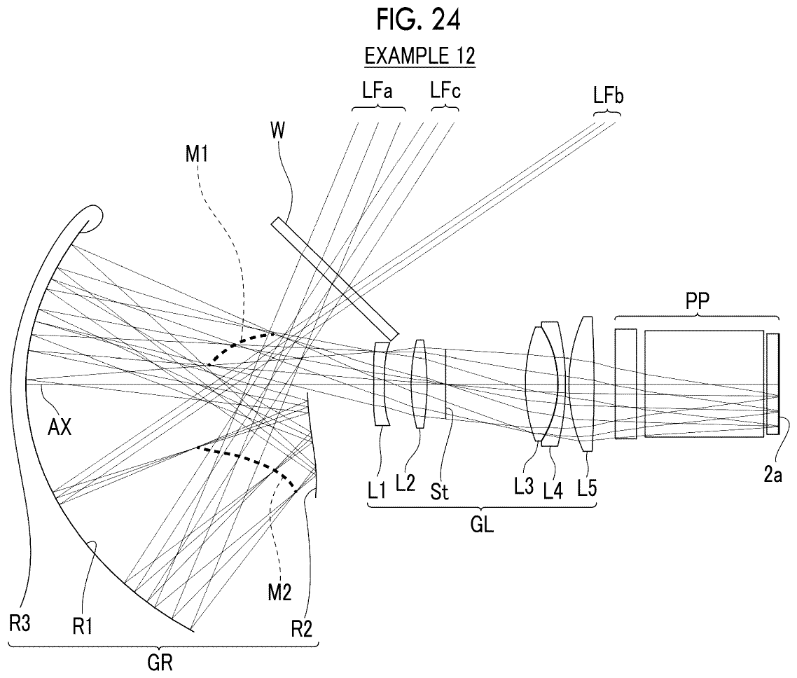

FIG. 24 is a cross-sectional view showing a configuration and luminous fluxes of an imaging optical system according to Example 12. The imaging optical system according to Example 12 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 and L2, an aperture stop St, and lenses L3 to L5 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 45 to 48 show data of the imaging optical system according to Example 12. Table 45 shows each of the configurations of the optical window W. Table 46 shows construction data of the reflective optical system GR, the refractive optical system GL, and the optical member PP. Table 47 shows specifications of a combined optical system where the reflective optical system GR and the refractive optical system GL are combined. Table 48 shows an aspherical coefficient of each of the aspherical surfaces.

TABLE 45
Example 12

| Center Position | 10.5 mm in Y-Axis Direction and 29.5 mm in Z-Axis |
|---|---|
| | Direction |
| Normal Direction | Direction in which Optical Axis AX is Rotated |
| | by 45° Around X-Axis as Rotation Axis |
| Shape | Flat Rectangle |
| Size | Long Side 38 mm, Short Side 16 mm |
| Center Thickness | 1 mm |
| Refractive Index | 1.51680 |
| Abbe Number | 64.20 |

TABLE 46
Example 12

| Sn | R | D | Nd | νd |
|---|---|---|---|---|
| *1 | 22.3197 | 26.5656 | Reflecting | |
| | | | Surface | |
| *2 | 29.7141 | −26.5656 | Reflecting | |
| | | | Surface | |
| *3 | 22.3197 | 32.8262 | Reflecting | |
| | | | Surface | |
| *4 | −57.5824 | 1.0000 | 1.50864 | 56.51 |
| *5 | 49.1968 | 2.4914 | | |
| 6 | 17.5672 | 1.4885 | 1.63854 | 55.38 |
| 7 | −27.8774 | 1.7795 | | |
| 8(St) | ∞ | 7.5041 | | |
| 9 | 16.3721 | 3.0901 | 1.49700 | 81.61 |
| 10 | −10.4746 | 0.7005 | 1.84666 | 23.78 |
| 11 | −24.7630 | 0.3239 | | |
| 12 | 16.2770 | 2.3784 | 1.69680 | 55.53 |
| 13 | −108.0215 | 2.0000 | | |
| 14 | ∞ | 2.0000 | 1.51680 | 64.20 |
| 15 | ∞ | 0.8000 | | |
| 16 | ∞ | 11.2000 | 1.72342 | 37.95 |
| 17 | ∞ | 0.3000 | | |
| 18 | ∞ | 1.1000 | 1.48749 | 70.44 |
| 19 | ∞ | 0.1044 | | |

TABLE 47
Example 12

| | |
|---|---|
| f | 1.69 |
| Bf | 11.75 |
| FNo. | 2.00 |
| 2ω[°] | 142.0 |

TABLE 48
Example 12

| Sn | 1 | 2 | 3 |
|---|---|---|---|
| KA | 3.3245959E−01 | 6.9916921E+00 | 3.3245959E−01 |
| A3 | −1.2869058E−04 | 3.1651003E−03 | −1.2869058E−04 |
| A4 | 4.7538657E−05 | −2.6861172E−03 | 4.7538657E−05 |
| A5 | −7.9560576E−06 | 9.7601981E−04 | −7.9560576E−06 |
| A6 | 6.6207097E−07 | −1.5493818E−04 | 6.6207097E−07 |
| A7 | −8.1793480E−09 | −4.2908113E−06 | −8.1793480E−09 |
| A8 | −2.7107505E−09 | 4.6387933E−06 | −2.7107505E−09 |
| A9 | 1.5652630E−10 | −4.0387463E−07 | 1.5652630E−10 |
| A10 | 2.0202953E−12 | −3.7238409E−08 | 2.0202953E−12 |
| A11 | −3.7657515E−13 | 7.0519472E−09 | −3.7657515E−13 |
| A12 | 4.6826058E−15 | −3.4995688E−11 | 4.6826058E−15 |
| A13 | 3.4876909E−16 | −4.4381837E−11 | 3.4876909E−16 |
| A14 | −8.1563597E−18 | 1.6271035E−12 | −8.1563597E−18 |
| A15 | −1.0846076E−19 | 9.7946851E−14 | −1.0846076E−19 |
| A16 | 3.3978515E−21 | −5.2184497E−15 | 3.3978515E−21 |

| Sn | 4 | 5 |
|---|---|---|
| KA | 1.0000000E+00 | 1.0000000E+00 |
| A3 | 0.0000000E+00 | 7.8797743E−19 |
| A4 | 1.9552233E−03 | 2.9311693E−03 |
| A5 | 1.0443443E−04 | −8.2239302E−04 |
| A6 | −1.2374104E−04 | 1.3796017E−04 |
| A7 | 7.6441311E−06 | 3.1728021E−05 |
| A8 | 4.5734892E−06 | −1.4431884E−05 |
| A9 | −5.2880164E−07 | 1.0867290E−07 |
| A10 | −6.0249175E−08 | 2.7636340E−07 |

### Example 13

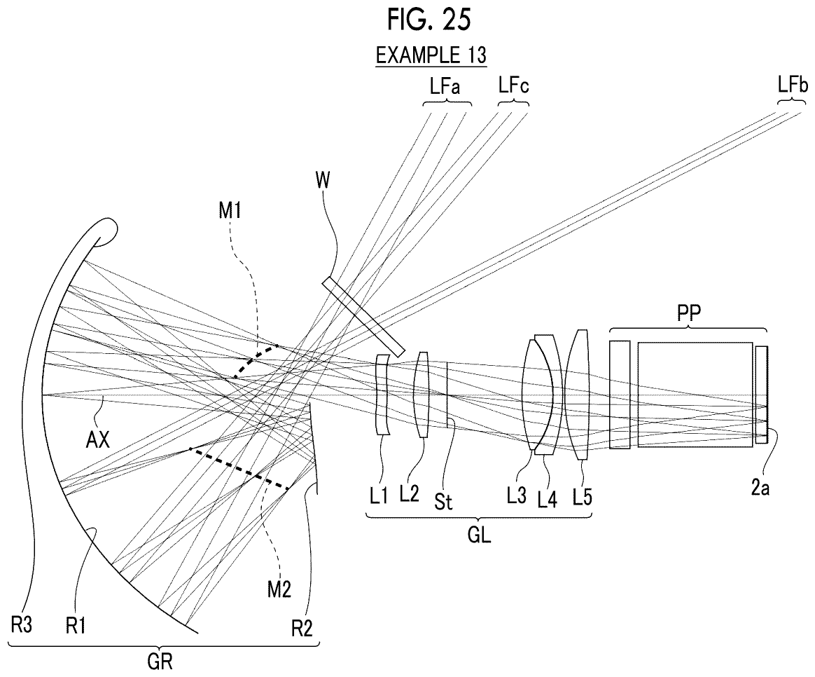

FIG. 25 is a cross-sectional view showing a configuration and luminous fluxes of an imaging optical system according to Example 13. The imaging optical system according to Example 13 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 and L2, an aperture stop St, and lenses L3 to L5 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 49 to 52 show data of the imaging optical system according to Example 13. Table 49 shows each of the configurations of the optical window W. Table 50 shows construction data of the reflective optical system GR, the refractive optical system GL, and the optical member PP. Table 51 shows specifications of a combined optical system where the reflective optical system GR and the refractive optical system GL are combined. Table 52 shows an aspherical coefficient of each of the aspherical surfaces.

TABLE 49
Example 13

| Center Position | 8.2 mm in Y-Axis Direction and 31.8 mm in Z-Axis |
|---|---|
| | Direction |
| Normal Direction | Direction in which Optical Axis AX is Rotated |
| | by 45° Around X-Axis as Rotation Axis |
| Shape | Flat Rectangle |
| Size | Long Side 34 mm, Short Side 10.5 mm |
| Center Thickness | 1 mm |
| Refractive Index | 1.51680 |
| Abbe Number | 64.20 |

TABLE 50
Example 13

| Sn | R | D | Nd | νd |
|---|---|---|---|---|
| *1 | 23.5859 | 26.2199 | Reflecting | |
| | | | Surface | |
| *2 | 28.6473 | −26.2199 | Reflecting | |
| | | | Surface | |
| *3 | 23.5859 | 32.7872 | Reflecting | |
| | | | Surface | |
| *4 | −15.2692 | 1.0001 | 1.50864 | 56.51 |
| *5 | −22.2217 | 2.5429 | | |
| 6 | 14.5278 | 1.5144 | 1.63854 | 55.38 |
| 7 | −55.2713 | 1.7800 | | |
| 8(St) | ∞ | 7.3297 | | |
| 9 | 18.9962 | 3.0504 | 1.49700 | 81.61 |
| 10 | −9.3189 | 0.9299 | 1.84666 | 23.78 |
| 11 | −19.3178 | 0.2005 | | |
| 12 | 16.7503 | 2.4094 | 1.69680 | 55.53 |
| 13 | −93.9504 | 2.0000 | | |
| 14 | ∞ | 2.0000 | 1.51680 | 64.20 |
| 15 | ∞ | 0.8000 | | |
| 16 | ∞ | 11.2000 | 1.72342 | 37.95 |
| 17 | ∞ | 0.3000 | | |
| 18 | ∞ | 1.1000 | 1.48749 | 70.44 |
| 19 | ∞ | 0.1015 | | |

TABLE 51
Example 13

| | |
|---|---|
| f | 2.22 |
| Bf | 11.74 |
| FNo. | 2.00 |
| 2ω[°] | 131.6 |

TABLE 52
Example 13

| Sn | 1 | 2 | 3 |
|---|---|---|---|
| KA | 3.3702552E−01 | 7.1687261E+00 | 3.3702552E−01 |
| A3 | −4.9037924E−05 | 1.7139537E−03 | −4.9037924E−05 |
| A4 | 2.4068093E−05 | −1.7091855E−03 | 2.4068093E−05 |
| A5 | −4.6785568E−06 | 6.5676892E−04 | −4.6785568E−06 |
| A6 | 4.7025303E−07 | −1.3226955E−04 | 4.7025303E−07 |
| A7 | −1.3072687E−08 | 4.0553947E−06 | −1.3072687E−08 |
| A8 | −1.3660298E−09 | 3.1213325E−06 | −1.3660298E−09 |
| A9 | 1.1123180E−10 | −4.3985151E−07 | 1.1123180E−10 |
| A10 | −2.7769370E−13 | −1.3376801E−08 | −2.7769370E−13 |
| A11 | −2.1809600E−13 | 6.2350192E−09 | −2.1809600E−13 |
| A12 | 4.8858587E−15 | −1.8346614E−10 | 4.8858587E−15 |
| A13 | 1.6908917E−16 | −3.5146085E−11 | 1.6908917E−16 |
| A14 | −5.8451536E−18 | 1.9054678E−12 | −5.8451536E−18 |
| A15 | −4.2505699E−20 | 7.1184732E−14 | −4.2505699E−20 |
| A16 | 2.1101974E−21 | −4.9230017E−15 | 2.1101974E−21 |

| Sn | 4 | 5 |
|---|---|---|
| KA | 1.0000000E+00 | 1.0000000E+00 |
| A3 | 3.3023407E−19 | −1.3680521E−18 |
| A4 | 2.9278577E−03 | 2.7458408E−03 |
| A5 | 5.8209807E−05 | −3.0278925E−05 |
| A6 | −9.9526469E−05 | −3.5868086E−05 |
| A7 | 9.9230568E−06 | 7.5897362E−06 |
| A8 | 2.8371012E−06 | −6.9618044E−07 |
| A9 | −3.4215183E−07 | 1.8525111E−08 |
| A10 | −4.2289918E−08 | 2.0606431E−08 |

### Example 14

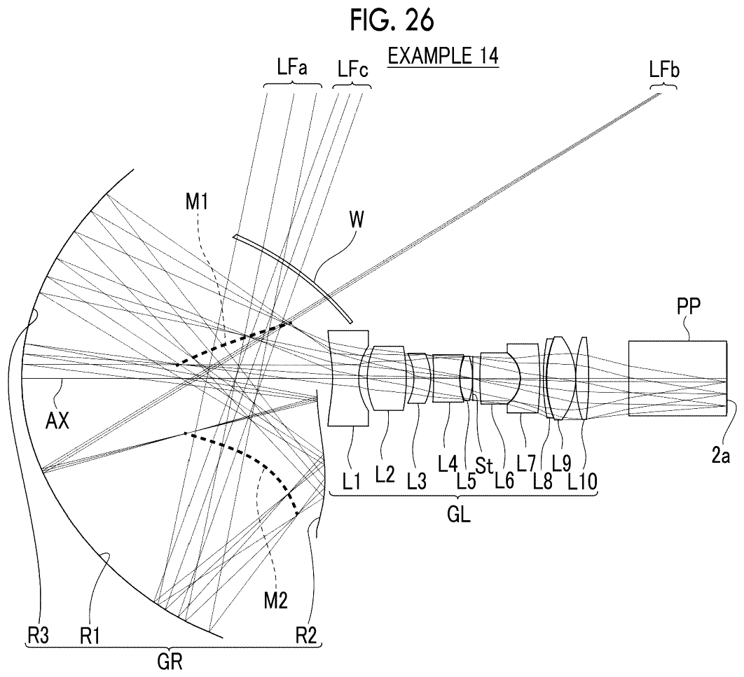

FIG. 26 is a cross-sectional view showing a configuration and luminous fluxes of an imaging optical system according to Example 14. The imaging optical system according to Example 14 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L5, an aperture stop St, and lenses L6 to L10 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 53 to 56 show data of the imaging optical system according to Example 14. Table 53 shows each of the configurations of the optical window W. In Table 53, “Origin of Equation of Curved Surface” shows the origin used in the equation defining the curved surface of the optical window W, and Table 53 shows the position of the origin with respect to the intersection between the first reflecting surface R1 and the optical axis AX. In Table 53, “Normal Direction” shows the normal direction of the center of curvature of the surface of the optical window W on the enlargement side. Table 54 shows construction data of the imaging optical system including the optical window W, and the optical member PP. Table 55 shows specifications of the imaging optical system including the optical window W. Table 56 shows an aspherical coefficient of each of the aspherical surfaces.

TABLE 53
Example 14

| Center Position | 35.3 mm in Y-Axis Direction and 87.1 mm in |
|---|---|
| | Z-Axis Direction |
| Origin of Equation | 20 mm in Y-Axis Direction and 100 mm in |
| of Curved Surface | Z-Axis Direction |
| Normal Direction | Direction in which Optical Axis AX is Rotated |
| | by 40° Around X-Axis as Rotation Axis |
| Shape | Surface on Enlargement Side and Surface on |
| | Reduction Side are Spherical |
| Size | Long Side 124 mm, Short Side 44 mm |
| Center Thickness | 1 mm |
| Refractive Index | 1.51680 |
| Abbe Number | 64.20 |

TABLE 54
Example 14

| Sn | R | D | Nd | νd |
|---|---|---|---|---|
| 1 | −95.3000 | −1.0000 | 1.51680 | 64.20 |
| 2 | −92.0000 | −99.0000 | | |
| *3 | 68.4344 | 90.4401 | Reflecting | |
| | | | Surface | |
| *4 | 124.9403 | −90.4401 | Reflecting | |
| | | | Surface | |
| *5 | 68.4344 | 95.3479 | Reflecting | |
| | | | Surface | |
| *6 | −41.4856 | 7.9989 | 1.69350 | 53.18 |
| 7 | 18.7543 | 2.6281 | | |
| 8 | 25.0592 | 12.0008 | 1.69895 | 30.13 |
| 9 | −54.8102 | 2.3371 | | |
| 10 | −16.6107 | 5.1325 | 1.48749 | 70.44 |
| 11 | −18.8938 | 0.9345 | | |
| 12 | −103.6085 | 8.0005 | 1.77250 | 49.62 |
| 13 | 21.4501 | 0.0511 | | |
| 14 | 17.3458 | 3.9095 | 1.48749 | 70.44 |
| 15(St) | −23.7551 | 2.2322 | | |
| 16 | 107.9483 | 12.4152 | 1.48749 | 70.44 |
| 17 | −10.0745 | 5.9999 | 1.83481 | 42.72 |
| 18 | −99.6193 | 1.0479 | | |
| 19 | 68.4501 | 0.8821 | 1.80420 | 46.50 |
| 20 | 35.1266 | 0.1960 | | |
| 21 | 37.2551 | 8.7072 | 1.59282 | 68.62 |
| 22 | −22.1688 | 0.0300 | | |
| 23 | 43.1546 | 3.9884 | 1.51633 | 64.06 |
| *24 | −108.3105 | 12.2900 | | |
| 25 | ∞ | 30.0900 | 1.51680 | 64.20 |
| 26 | ∞ | 0.0511 | | |

TABLE 55
Example 14

| | |
|---|---|
| f | 1.84 |
| Bf | 32.17 |
| FNo. | 2.00 |
| 2ω[°] | 162.2 |

TABLE 56
Example 14

| Sn | 3 | 4 | 5 |
|---|---|---|---|
| KA | 5.9549660E−01 | 7.0407163E+00 | 5.9549660E−01 |
| A3 | −2.8186123E−07 | −1.0526407E−04 | −2.8186123E−07 |
| A4 | 2.7050203E−07 | 1.5627378E−05 | 2.7050203E−07 |
| A5 | −1.7925325E−08 | 8.8542095E−08 | −1.7925325E−08 |
| A6 | −3.0297673E−11 | −6.9581033E−08 | −3.0297673E−11 |
| A7 | 9.7275184E−12 | 1.6760577E−09 | 9.7275184E−12 |
| A8 | −4.1700097E−14 | 5.4517477E−11 | −4.1700097E−14 |
| A9 | −3.1189692E−15 | −2.2682310E−12 | −3.1189692E−15 |
| A10 | 2.6112870E−17 | −9.2155994E−15 | 2.6112870E−17 |
| A11 | 4.8944073E−19 | 1.1742342E−15 | 4.8944073E−19 |
| A12 | −5.3587450E−21 | −5.5018990E−18 | −5.3587450E−21 |
| A13 | −3.5635322E−23 | −2.7383535E−19 | −3.5635322E−23 |
| A14 | 4.5777099E−25 | 2.4109042E−21 | 4.5777099E−25 |
| A15 | 9.7533588E−28 | 2.3994848E−23 | 9.7533588E−28 |
| A16 | −1.4012626E−29 | −2.6656661E−25 | −1.4012626E−29 |

| Sn | 6 | 24 |
|---|---|---|
| KA | 1.0000000E+00 | 1.0000000E+00 |
| A4 | 4.0854263E−05 | −1.9039244E−07 |
| A6 | −2.3694877E−07 | 8.7760069E−09 |
| A8 | 2.4416565E−09 | 2.6778716E−11 |
| A10 | −1.3697156E−11 | −1.0536610E−13 |
| A12 | 2.4437101E−14 | |
| A14 | 7.2336882E−17 | |
| A16 | −2.5077903E−19 | |

### Example 15

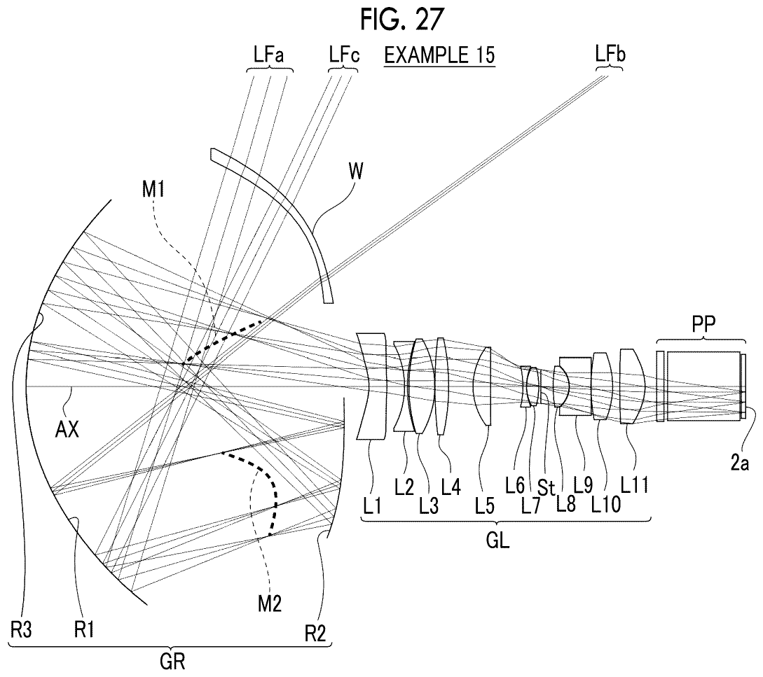

FIG. 27 is a cross-sectional view showing a configuration and luminous fluxes of an imaging optical system according to Example 15. The imaging optical system according to Example 15 consists of an optical window W, a reflective optical system GR, and a refractive optical system GL along the optical path in order from the enlargement side to the reduction side. The reflective optical system GR consists of a first reflecting surface R1 having a positive power, a second reflecting surface R2 having a power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L7, an aperture stop St, and lenses L8 to L11 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

Tables 57 to 60 show data of the imaging optical system according to Example 15. Table 57 shows each of the configurations of the optical window W. In Table 57, “Origin of Equation of Curved Surface” shows the origin used in the equation defining the curved surface of the optical window W, and Table 57 shows the position of the origin with respect to the intersection between the first reflecting surface R1 and the optical axis AX. In Table 57, “Normal Direction” shows the normal direction of the center of curvature of the surface of the optical window W on the enlargement side. Table 58 shows construction data of the imaging optical system including the optical window W, and the optical member PP. Table 59 shows specifications of the imaging optical system including the optical window W. Table 60 shows an aspherical coefficient of each of the aspherical surfaces.

TABLE 57
Example 15

| Center Position | 40 mm in Y-Axis Direction and 78.55 mm in |
|---|---|
| | Z-Axis Direction |
| Origin of Equation | 0 mm in Y-Axis Direction and 86.84 mm in |
| of Curved Surface | Z-Axis Direction |
| Normal Direction | Direction of Optical Axis AX |
| Shape | Surface on Enlargement Side and Surface on |
| | Reduction Side are Aspherical |
| Size | Long Side 120 mm, Short Side 52 mm |
| Center Thickness | 4 mm |
| Refractive Index | 1.53638 |
| Abbe Number | 56.09 |

TABLE 58
Example 15

| Sn | R | D | Nd | νd |
|---|---|---|---|---|
| *1 | −137.0303 | −4.0010 | 1.53638 | 56.09 |
| *2 | −9994.8919 | −82.8362 | | |
| *3 | 62.0058 | 87.8502 | Reflecting | |
| | | | Surface | |
| *4 | 569.2204 | −87.8502 | Reflecting | |
| | | | Surface | |
| *5 | 62.0058 | 94.7530 | Reflecting | |
| | | | Surface | |
| *6 | −15.6732 | 4.7847 | 1.53638 | 56.09 |
| *7 | −62.9889 | 4.9187 | | |
| 8 | −25.1224 | 0.8000 | 1.84666 | 23.78 |
| 9 | 41.7609 | 0.4087 | | |
| 10 | 46.1400 | 7.1405 | 1.59551 | 39.24 |
| 11 | −27.3716 | 0.0304 | | |
| 12 | 118.0968 | 3.8005 | 1.84666 | 23.78 |
| 13 | −64.6260 | 6.7326 | | |
| 14 | 18.7644 | 4.8346 | 1.59551 | 39.24 |
| 15 | 759.2139 | 8.9423 | | |
| 16 | −26.7791 | 0.9991 | 1.83481 | 42.72 |
| 17 | 14.1118 | 0.0308 | | |
| 18 | 11.5546 | 3.3679 | 1.48749 | 70.44 |
| 19 | −21.0959 | 0.5727 | | |
| 20(St) | ∞ | 3.3982 | | |
| 21 | 36.6114 | 4.4440 | 1.48749 | 70.44 |
| 22 | −7.6779 | 6.0008 | 1.83481 | 42.72 |
| 23 | 371.3311 | 0.0308 | | |
| 24 | 52.6456 | 5.9573 | 1.59282 | 68.62 |
| 25 | −24.9938 | 1.9590 | | |
| 26 | 210.3683 | 6.9994 | 1.58913 | 61.15 |
| *27 | −15.1885 | 3.2000 | | |
| 28 | ∞ | 2.0000 | 1.51680 | 64.20 |
| 29 | ∞ | 1.0000 | | |
| 30 | ∞ | 20.0000 | 1.72342 | 37.95 |
| 31 | ∞ | 0.4000 | | |
| 32 | ∞ | 1.2000 | 1.48749 | 70.44 |
| 33 | ∞ | 0.0520 | | |

TABLE 59
Example 15

| | |
|---|---|
| f | 2.08 |
| Bf | 18.37 |
| FNo. | 2.00 |
| 2ω[°] | 154.6 |

TABLE 60
Example 15

| Sn | 1 | 2 | 27 |
|---|---|---|---|
| KA | 1.0000000E+00 | 1.0000000E+00 | 1.0000000E+00 |
| A4 | 6.4125122E−07 | −1.6359149E−06 | 6.5017661E−05 |
| A6 | −5.9382937E−10 | 1.2851549E−10 | −1.0778638E−08 |
| A8 | 7.7963296E−14 | −9.9141959E−14 | 4.0140517E−10 |
| A10 | −3.9688769E−18 | 1.3392686E−17 | 1.6921998E−12 |

| Sn | 3 | 4 | 5 |
|---|---|---|---|
| KA | −3.0432803E−01 | 9.9999994E+00 | −3.0432803E−01 |
| A3 | 6.5716337E−06 | 2.6591735E−05 | 6.5716337E−06 |
| A4 | −1.6096295E−06 | −1.1026928E−05 | −1.6096295E−06 |
| A5 | 1.2155657E−07 | 4.5528822E−07 | 1.2155657E−07 |
| A6 | −2.0943836E−09 | −4.9394515E−09 | −2.0943836E−09 |
| A7 | −9.1130495E−11 | −2.4464201E−10 | −9.1130495E−11 |
| A8 | 4.4409331E−12 | 7.4763917E−12 | 4.4409331E−12 |
| A9 | −2.9796044E−14 | 2.6011524E−14 | −2.9796044E−14 |
| A10 | −1.7818583E−15 | −3.0279917E−15 | −1.7818583E−15 |
| A11 | 3.4737411E−17 | 1.0212139E−17 | 3.4737411E−17 |
| A12 | 1.4932812E−19 | 5.9534306E−19 | 1.4932812E−19 |
| A13 | −8.6689727E−21 | −2.7785886E−21 | −8.6689727E−21 |
| A14 | 3.6789973E−23 | −5.9788071E−23 | 3.6789973E−23 |
| A15 | 6.8947524E−25 | 1.9074439E−25 | 6.8947524E−25 |
| A16 | −5.3969606E−27 | 2.5254284E−27 | −5.3969606E−27 |

| Sn | 6 | 7 |
|---|---|---|
| KA | 1.0000000E+00 | 1.0000000E+00 |
| A4 | 2.4768996E−04 | 1.2733445E−04 |
| A6 | −1.5671169E−06 | −9.9484243E−07 |
| A8 | 1.1066272E−08 | 4.0558252E−09 |
| A10 | −5.9100749E−11 | −3.3511669E−12 |
| A12 | 2.4083898E−13 | −8.8053517E−14 |
| A14 | −6.3192178E−16 | 5.3022179E−16 |
| A16 | 8.9595305E−19 | −9.9536979E−19 |

### Modification Example

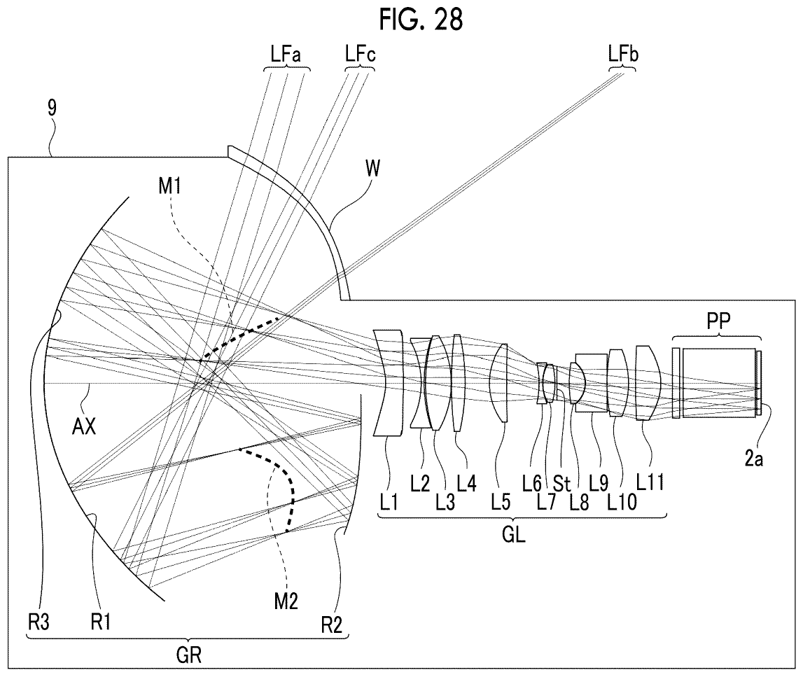

FIG. 28 is a cross-sectional view showing a configuration of a modification example where the imaging optical system according to Example 15 shown in FIG. 27 is accommodated in a housing 9.

Table 61 shows various data regarding the image displayed by the display surface 2a in Examples 1 to 15. In all of the examples, the long side direction is the X-axis direction, and the short side direction is the Y-axis direction. In Table 61, the “Inch Size” row shows the diagonal length of the image by inch. “ImL”, “ImS”, “Δs”, and “V” are the factors used in the conditional expressions. “[mm]” shows that the unit is millimeter. The “Projection Size” row shows the diagonal length of the projected enlarged image by inch. In Examples 1 to 4 and Examples 8 to 15, relative positions of the imaging optical system 1 and the display element 2 are fixed. In Examples 5 to 7, the imaging optical system 1 and the display element 2 are movable relative to each other in the direction perpendicular to the optical axis AX.

TABLE 61

| | Example 1 | Example 2 | Example 3 | Example 4 | Example 5 |
|---|---|---|---|---|---|
| Inch Size | 0.61″ | 0.61″ | 0.78″ | 0.78″ | 0.61″ |
| ImL [mm] | 13.44 | 13.44 | 17.28 | 17.28 | 13.44 |
| ImS [mm] | 7.56 | 7.56 | 9.72 | 9.72 | 7.56 |
| Aspect Ratio | 16:9 | 16:9 | 16:9 | 16:9 | 16:9 |
| Projection Size | 80″ | 80″ | 150″ | 150″ | 120″ |
| Δs [mm] | 5.065 | 5.065 | 5.832 | 5.832 | 4.778 to 6.161 |
| V | 0.67 | 0.67 | 0.60 | 0.60 | 0.632 to 0.815 |

| | Example 6 | Example 7 | Example 8 | Example 9 | Example 10 |
|---|---|---|---|---|---|
| Inch Size | 0.61″ | 0.61″ | 0.61″ | 0.61″ | 0.23″ |
| ImL [mm] | 13.44 | 13.44 | 13.44 | 13.44 | 5.184 |
| ImS [mm] | 7.56 | 7.56 | 7.56 | 7.56 | 2.916 |
| Aspect Ratio | 16:9 | 16:9 | 16:9 | 16:9 | 16:9 |
| Projection Size | 120″ | 120″ | 100″ | 100″ | 70″ |
| Δs [mm] | 4.778 to 6.161 | 4.778 to 6.161 | 5.292 | 5.292 | 2.624 |
| V | 0.632 to 0.815 | 0.632 to 0.815 | 0.70 | 0.70 | 0.90 |

| | Example 11 | Example 12 | Example 13 | Example 14 | Example 15 |
|---|---|---|---|---|---|
| Inch Size | 0.23″ | 0.23″ | 0.23″ | 0.61″ | 0.47″ |
| ImL [mm] | 5.184 | 5.184 | 5.184 | 13.44 | 10.368 |
| ImS [mm] | 2.916 | 2.916 | 2.916 | 7.56 | 5.832 |
| Aspect Ratio | 16:9 | 16:9 | 16:9 | 16:9 | 16:9 |
| Projection Size | 70″ | 35″ | 35″ | 100″ | 90″ |
| Δs [mm] | 2.624 | 2.624 | 2.624 | 4.914 | 4.43 |
| V | 0.90 | 0.90 | 0.90 | 0.65 | 0.76 |

Tables 62 to 66 show the corresponding values of Conditional Expressions (1) to (12) of the imaging optical systems according to Examples 1 to 15. Tables 62 to 66 show the values used for calculating the corresponding values below the corresponding values of Conditional Expressions (4), (5), (7), and (10). The units of the lengths shown in Tables 62 to 66 are all millimeters (mm). Preferable ranges of the conditional expressions may be set by using the corresponding values of the examples shown in Tables 62 to 66 as the upper or lower limits of the conditional expressions.

TABLE 62

| Expression | | | | |
|---|---|---|---|---|
| Number | | Example 1 | Example 2 | Example 3 |
| (1) | \|α\| | 68.3° | 68.3° | 71.8° |
| (2) | [θc] | 8.3° | 8.3° | 1.8° |
| (3) | ω | 79.0° | 79.0° | 81.9° |
| (4) | hWmin/ra | 1.10 | 1.53 | 1.13 |
| | | hWmin = 16.2 | hWmin = 22.6 | hWmin = 27.7 |
| | | ra = 14.75 | ra = 14.75 | ra = 24.25 |
| (5) | hWR/hM3 | 0.83 | — | 0.75 |
| | | (Effective Radius of | | hM3 = 73.0 |
| | | Third Reflecting | | hWR = 54.4 |
| | | Surface = 51.8) | | |
| | | hM3 = 53.0 | | |
| | | hWR = 44.1 | | |
| (6) | θwin | 60° | | 70° |
| (7) | (Vmin − 0.5) × WL × | 0.54 | — | 0.45 |
| | (Dsc/PrL)/ImL | | | |
| | | WL = 235 | | WL = 580 |
| | | ImL = 13.44 | | ImL = 17.28 |
| | | PrL = 1771 | | PrL = 3321 |
| | | Dsc = 324 | | Dsc = 450 |
| | | V = 0.67 | | V = 0.60 |
| (8) | WL/WS | 4.20 | — | 7.44 |
| (9) | (Vmin − 0.5) × | 0.71 | — | 0.74 |
| | WL/WS | | | |
| (10) | WpL/WpS | — | 1.96 | — |
| | | | WpL = 90 | |
| | | | WpS = 46 | |
| (11) | WpL/Rcy | — | 1.80 | — |
| (12) | fRL/Rcy | — | 0.042 | — |

TABLE 63

| Expression | | | | |
|---|---|---|---|---|
| Number | | Example 4 | Example 5 | Example 6 |
| (1) | \|α\| | 71.8° | 80.0° | 80.0° |
| (2) | \|θc\| | 1.8° | 24.0° | 10.0° |
| (3) | ω | 81.9° | 84.8° | 84.8° |
| (4) | hWmin/ra | 1.23 | 1.29 | 2.11 |
| | | hWmin = 29.8 | hWmin = 24.1 | hWmin = 39.6 |
| | | ra = 24.25 | ra = 18.75 | ra = 18.75 |
| (5) | hWR/hM3 | — | 0.88 | — |
| | | | hM3 = 62.0 | |
| | | | hWR = 54.3 | |
| (6) | θwin | | 56° | |
| (7) | (Vmin − 0.5) × WL × | — | 0.38 | — |
| | (Dsc/PrL)/ImL | | | |
| | | | WL = 404 | |
| | | | ImL = 13.44 | |
| | | | PrL = 2657 | |
| | | | Dsc = 255 | |
| | | | V = 0.632 | |
| (8) | WL/WS | — | 7.48 | — |
| (9) | (Vmin − 0.5) × | — | 0.99 | — |
| | WL/WS | | | |
| (10) | WpL/WpS | 1.79 | — | 2.16 |
| | | WpL = 122 | | WpL = 108 |
| | | WpS = 68 | | WpS = 50 |
| (11) | WpL/Rcy | 1.97 | — | 1.97 |
| (12) | fRL/Rcy | 0.032 | — | 0.021 |

TABLE 64

| Expression | | | | |
|---|---|---|---|---|
| Number | | Example 7 | Example 8 | Example 9 |
| (1) | \|α\| | 80.0° | 65.2° | 65.2° |
| (2) | \|θc\| | 5.34° | 4.8° | 0.2° |
| (3) | ω | 84.8° | 78.0° | 78.0° |
| (4) | hWmin/ra | 2.15 | 0.97 | 1.20 |
| | | hWmin = 40.3 | hWmin = 21.4 | hWmin = 26.5 |
| | | ra = 18.75 | ra = 22.0 | ra = 22.0 |
| (5) | hWR/hM3 | — | 0.74 | — |
| | | | hM3 = 50.0 | |
| | | | hWR = 37.2 | |
| (6) | θwin | | 70° | |
| (7) | (Vmim − 0.5) × WL × | — | 0.69 | — |
| | (Dsc/PrL)/ImL | | | |
| | | | WL = 240 | |
| | | | ImL = 13.44 | |
| | | | PrL = 2214 | |
| | | | Dsc = 430 | |
| | | | V = 0.70 | |
| (8) | WL/WS | — | 5.22 | — |
| (9) | (Vmin − 0.5) × WL/WS | — | 1.04 | — |
| (10) | WpL/WpS | 2.18 | — | 2.67 |
| | | WpL = 109 | | WpL = 95 |
| | | WpS = 50 | | WpS = 36 |
| (11) | WpL/Rcy | — | — | 1.90 |
| (12) | fRL/Rcy | — | — | 0.051 |

TABLE 65

| Expression | | | | |
|---|---|---|---|---|
| Number | | Example 10 | Example 11 | Example 12 |
| (1) | \|α\| | 72.6° | 72.6° | 57.9° |
| (2) | \|θc\| | 12.6° | 12.6° | 12.9° |
| (3) | ω | 80.3° | 80.3° | 71.0° |
| (4) | hWmin/ra | 1.66 | 1.78 | 1.21 |
| | | hWmin = 6.63 | hWmin = 7.13 | hWmin = 4.83 |
| | | ra = 4.0 | ra = 4.0 | ra = 4.00 |
| (5) | hWR/hM3 | 0.76 | — | 2.7 |
| | | hM3 = 18.0 | | hM3 = 6.00 |
| | | hWR = 13.6 | | hWR = 16.2 |
| (6) | θwin | 60° | | 45° |
| (7) | (Vmin − 0.5) × WL × | 0.69 | — | 1.02 |
| | (Dsc/PrL)/ImL | | | |
| | | WL = 48 | | WL = 38 |
| | | ImL = 5.184 | | ImL = 5.184 |
| | | PrL = 388.8 | | PrL = 777.6 |
| | | Dsc = 270 | | Dsc = 270 |
| | | V = 0.70 | | V = 0.9 |
| (8) | WL/WS | 3.43 | — | 2.38 |
| (9) | (Vmin − 0.5) × WL/WS | 0.69 | — | 0.95 |
| (10) | WpL/WpS | — | 2.07 | — |
| | | | WpL = 31 | |
| | | | WpS = 15 | |
| (11) | WpL/Rcy | — | 1.55 | — |
| (12) | fRL/Rcy | — | 0.042 | — |

TABLE 66

| Expression | | | | |
|---|---|---|---|---|
| Number | | Example 13 | Example 14 | Example 15 |
| (1) | \|α\| | 50.4° | 70.9° | 65.7° |
| (2) | \|θc\| | 5.4° | 10.8° | 21.9° |
| (3) | ω | 65.8° | 81.1° | 77.3° |
| (4) | hWmin/ra | 1.08 | 1.15 | 1.57 |
| | | hWmin = 4.31 | hWmin = 17.2 | hWmin = 23.5 |
| | | ra = 4.00 | ra = 15.00 | ra = 15.00 |
| (5) | hWR/hM3 | 2.4 | — | — |
| | | hM3 = 5.5 | | |
| | | hWR = 12.9 | | |
| (6) | θwin | 45° | | |
| (7) | (Vmin − 0.5) × WL × | 1.18 | — | — |
| | (Dsc/PrL)/ImL | | | |
| | | WL = 34 | | |
| | | ImL = 5.184 | | |
| | | PrL = 777.6 | | |
| | | Dsc = 350 | | |
| | | V = 0.9 | | |
| (8) | WL/WS | 3.09 | — | — |
| (9) | (Vmin − 0.5) × WL/WS | 1.24 | — | — |
| (10) | WpL/WpS | — | 2.81 | 2.18 |
| | | | WpL = 124 | WpL = 120 |
| | | | WpS = 44 | WpS = 55 |
| (11) | WpL/Rcy | — | — | — |
| (12) | fRL/Rcy | — | — | — |

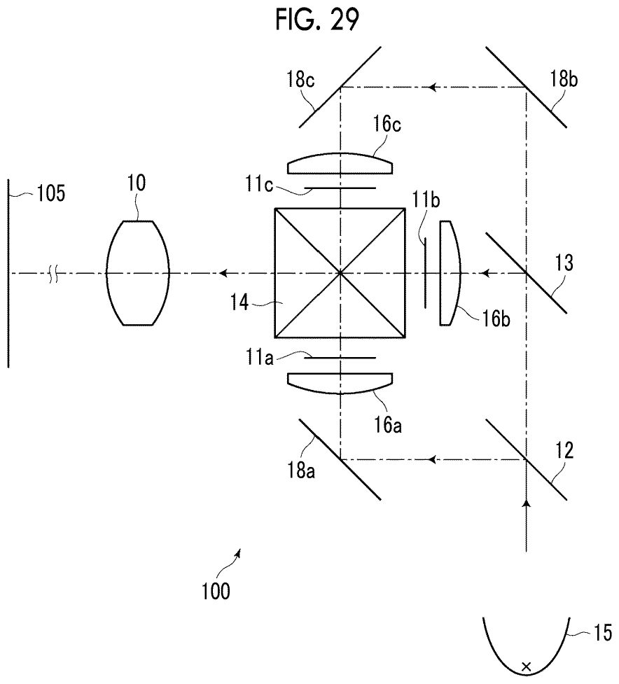

Next, a projection type display device according to an embodiment of the present disclosure will be described. FIG. 29 is a schematic configuration diagram showing the projection type display device according to an embodiment of the present disclosure. A projection type display device 100 shown in FIG. 29 includes an imaging optical system 10 according to the embodiment of the present disclosure, a light source 15, and transmissive display elements 11a to 11c as light valves corresponding to each color light and outputting an optical image. Further, the projection type display device 100 includes dichroic mirrors 12 and 13 for color separation, a cross dichroic prism 14 for color synthesis, condenser lenses 16a to 16c, and total reflection mirrors 18a to 18c for deflecting the optical path. In addition, FIG. 29 schematically shows the imaging optical system 10. Further, an integrator is disposed between the light source 15 and the dichroic mirror 12, but is not shown in FIG. 29.

White light emitted from the light source 15 is separated into three colored luminous fluxes (green light, blue light, and red light) through the dichroic mirrors 12 and 13. Next, the three colored luminous fluxes pass through the condenser lenses 16a to 16c, are incident into and modulated by the transmissive display elements 11a to 11c respectively corresponding to the respective colored luminous fluxes, are subjected to color synthesis by the cross dichroic prism 14, and are subsequently incident into the imaging optical system 10. The imaging optical system 10 projects an optical image, which is based on the modulated light modulated through the transmissive display elements 11a to 11c, onto a screen 105.

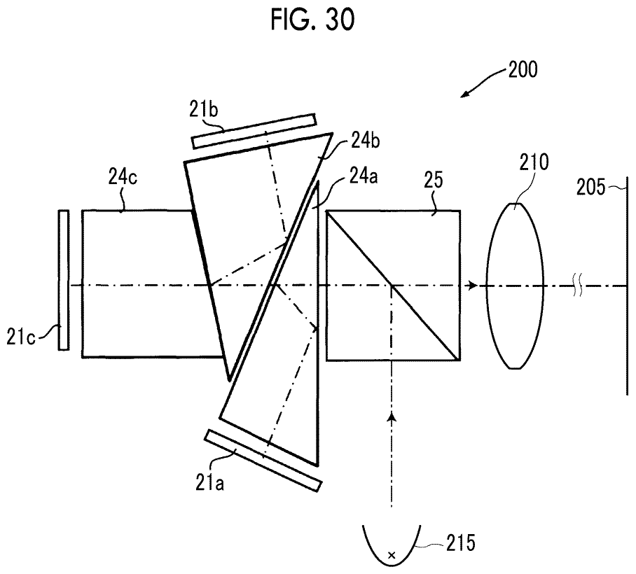

FIG. 30 is a schematic configuration diagram showing a projection type display device according to another embodiment of the present disclosure. A projection type display device 200 shown in FIG. 30 includes an imaging optical system 210 according to the embodiment of the present disclosure, a light source 215, and digital micromirror device (DMD: registered trademark) elements 21a to 21c as light valves corresponding to each color light and outputting an optical image. Further, the projection type display device 200 includes total internal reflection (TIR) prisms 24a to 24c for color separation and color synthesis, and a polarization separating prism 25 that separates illumination light and projection light. In addition, FIG. 30 schematically shows the imaging optical system 210. Further, an integrator is disposed between the light source 215 and the polarization separating prism 25, but is not shown in FIG. 30.

White light emitted from the light source 215 is reflected from a reflecting surface inside the polarization separating prism 25, and is separated into three colored luminous fluxes (green light, blue light, and red light) by the TIR prisms 24a to 24c. The separated colored luminous fluxes with the respective colors are respectively incident into and modulated through the corresponding DMD elements 21a to 21c, travel through the TIR prisms 24a to 24c again in a reverse direction, are subjected to color synthesis, are subsequently transmitted through the polarization separating prism 25, and are incident into the imaging optical system 210. The imaging optical system 210 projects an optical image, which is based on the modulated light modulated through the DMD elements 21a to 21c, onto a screen 205.

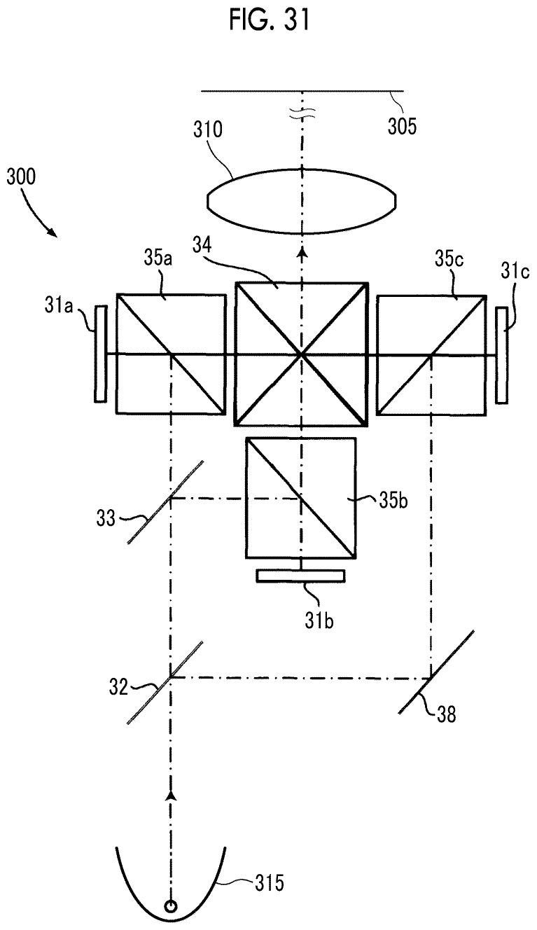

FIG. 31 is a schematic configuration diagram showing a projection type display device according to still another embodiment of the present disclosure. A projection type display device 300 shown in FIG. 31 includes an imaging optical system 310 according to the embodiment of the present disclosure, a light source 315, reflective display elements 31a to 31c as light valves each corresponding to each color light, dichroic mirrors 32 and 33 for color separation, a cross dichroic prism 34 for color synthesis, a total reflection mirror 38 for deflecting the optical path, and polarization separating prisms 35a to 35c. In addition, FIG. 31 schematically shows the imaging optical system 310. Further, an integrator is disposed between the light source 315 and the dichroic mirror 32, but is not shown in FIG. 31.

White light emitted from the light source 315 is separated into three colored luminous fluxes (green light, blue light, and red light) through the dichroic mirrors 32 and 33. The separated colored luminous fluxes with the respective colors respectively pass through the polarization separating prisms 35a to 35c, are incident into and modulated through the reflective display elements 31a to 31c respectively corresponding to the ray with the respective colors, are subjected to color synthesis through the cross dichroic prism 34, and are subsequently incident into the imaging optical system 310. The imaging optical system 310 projects an optical image, which is based on the modulated light modulated through the reflective display elements 31a to 31c, onto a screen 305.

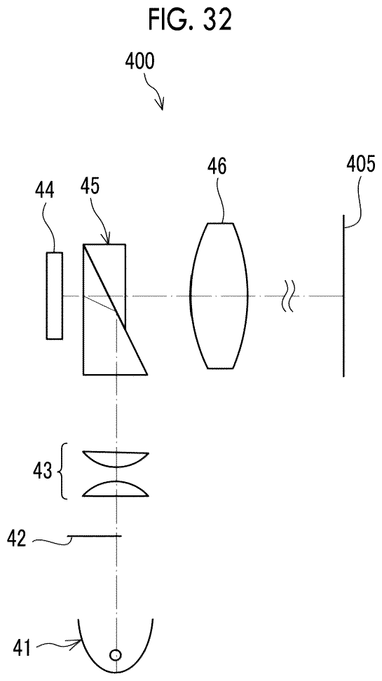

FIG. 32 is a schematic configuration diagram showing a projection type display device according to still another embodiment of the present disclosure. A projection type display device 400 shown in FIG. 32 includes an imaging optical system 46 according to the embodiment of the present disclosure, a light source 41, and a DMD element 44 as a light valve corresponding to each color light and outputting an optical image. Further, the projection type display device 400 includes a color wheel 42, a light guide optical system 43, and a TIR prism 45. In addition, FIG. 32 schematically shows the imaging optical system 46.

Filters having three colors of green, blue, and red are provided on a circumference of the color wheel 42. In a case where the color wheel 42 is rotated, the filters having the respective colors are sequentially inserted on the optical path. White light from the light source 41 is incident into the rotating color wheel 42 and is time-divided into colored luminous fluxes having three colors (green light, blue light, and red light). The colored luminous fluxes having the respective colors after the time-division pass through the light guide optical system 43 and the TIR prism 45, are incident into the DMD elements 44 to be modulated, and are incident into the imaging optical system 46 through the TIR prism 45 again. The imaging optical system 46 projects an optical image based on the modulated light modulated by the DMD element 44 onto a screen 405.

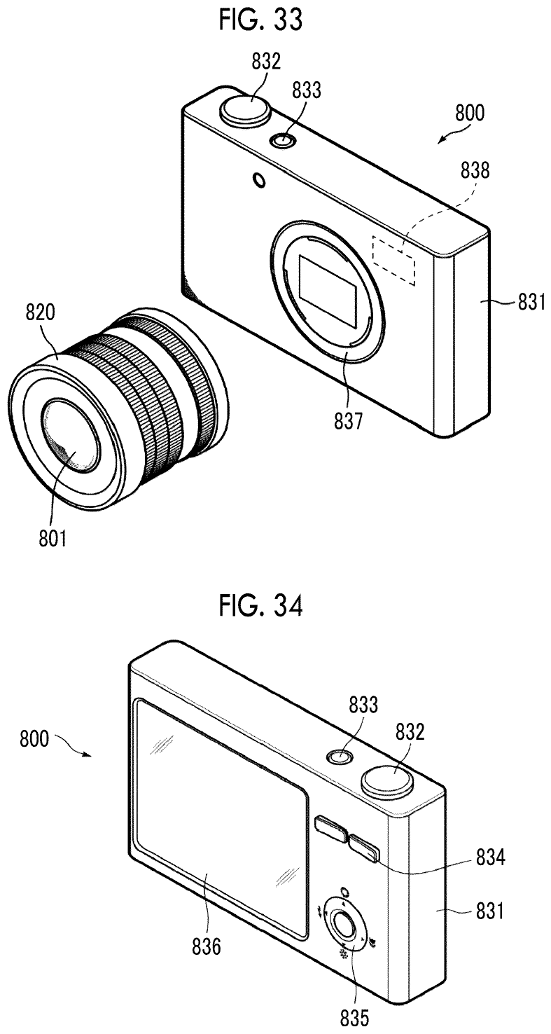

FIGS. 33 and 34 are external views showing a camera 800 that is an imaging apparatus according to an embodiment of the present disclosure. FIG. 33 is a perspective view showing the camera 800 in a view from the front side, and FIG. 34 is a perspective view showing the camera 800 in a view from the rear side. The camera 800 is a so-called mirrorless type digital camera, and an interchangeable lens 820 can be removably attached thereto. The interchangeable lens 820 is composed of an imaging optical system 801 according to an embodiment of the present disclosure accommodated in a lens barrel.

The camera 800 includes a camera body 831. A shutter button 832 and a power button 833 are provided on an upper surface of the camera body 831. Further, an operator 834, an operator 835 and a display unit 836 are provided on the rear surface of the camera body 831. The display unit 836 displays a captured image and an image within an angle of view before imaging.

An imaging aperture through which light from an imaging target is incident is provided at the center on the front surface of the camera body 831. A mount 837 is provided at a position corresponding to the imaging aperture. The interchangeable lens 820 is mounted on the camera body 831 with the mount 837 interposed therebetween.

An imaging element 838 is provided in the camera body 831. The imaging element 838 outputs an imaging signal corresponding to the subject image formed by the interchangeable lens 820. For example, a charge coupled device (CCD) or a complementary metal oxide semiconductor (CMOS) is used as the imaging element 838. A signal processing circuit (not shown), a recording medium (not shown), and the like are provided in the camera body 831. The signal processing circuit processes the imaging signal output from the imaging element 838 to generate an image. The recording medium is used to record the generated image. The camera 800 can capture a still image or a motion picture by pressing the shutter button 832, and records image data obtained through imaging in the recording medium.

The present disclosed technology has been hitherto described through embodiments and examples, but the technique of the present disclosure is not limited to the above-mentioned embodiments and examples, and may be modified into various forms. The curvature radius of each of the reflecting surfaces and the curvature radius, the surface spacing, the refractive index, the Abbe number, the aspherical coefficient of each of the lenses are not limited to the values shown in each of the examples, and may be other values.

In addition, the projection type display device according to the present disclosed technology is not limited to the above-described configuration. For example, various changes of aspects can be made for the optical members and the light valves used for the luminous flux separation or the luminous flux synthesis. The light valve is not limited to an aspect in which light emitted from the light source is spatially modulated by an image display element and is output as an optical image based on image data, but may be an aspect in which light itself output from a light emitting image display element is output as an optical image based on the image data. Examples of the light emitting image display element include an image display element where light emitting elements such as light emitting diodes (LED) or organic light emitting diodes (OLED) are two-dimensionally arranged.

Further, an imaging apparatus according to the present disclosed technology is not limited to the above-described configuration, and can be modified into various aspects such as a non-mirrorless type camera, a film camera, a video camera, a security camera, and a camera for movie imaging.

Regarding the above-described embodiments and examples, the following supplementary notes will be further disclosed.

### Supplementary Note 1

An imaging optical system that is capable of forming an enlarged image on an enlargement-side imaging plane by enlarging an image on a reduction-side imaging plane,
the imaging optical system consisting of an optical window, a reflective optical system, and a refractive optical system including a plurality of lenses along an optical path in order from an enlargement side to a reduction side,
in which the reflective optical system includes a first reflecting surface having a positive power, a second reflecting surface having a power, and a third reflecting surface having a positive power along the optical path in order from the enlargement side to the reduction side,
a first intermediate image is formed at a position conjugate to the image on the optical path closer to the reduction side than the third reflecting surface,
a second intermediate image is formed at a position conjugate to the first intermediate image in the reflective optical system,
the enlarged image is formed at a position conjugate to the second intermediate image on the optical path closer to the enlargement side than the optical window,
a center of the enlarged image is at a position shifted from an optical axis of the refractive optical system in a direction perpendicular to the optical axis, and
in a case where a principal ray that is incident into the center of the enlarged image in a state where an amount of the shift is maximum is a center principal ray,
an incidence angle of the center principal ray into the enlargement-side imaging plane is represented by α, and
an incidence angle of the center principal ray into the optical window is represented by θc, Conditional Expressions (1) and (2) represented by

$$40 ° < \vert α \vert < 85 ° \qquad ( 1 )$$

$$0 ° < \vert θ c \vert < 35 ° \qquad ( 2 )$$

are satisfied.

### Supplementary Note 2

The imaging optical system according to Supplementary Note 1, in which in a case where a maximum half angle of view of the enlargement side is represented by ω, Conditional Expression (3) represented by

$$65 ° < ω < 90 ° \qquad ( 3 )$$

is satisfied.

### Supplementary Note 3

The imaging optical system according to Supplementary Note 1 or 2,
in which an intersection between the center principal ray and a surface of the optical window on the enlargement side is positioned closer to the third reflecting surface side than the entire second reflecting surface in a direction of the optical axis.

### Supplementary Note 4

The imaging optical system according to any one of Supplementary Notes 1 to 3,
in which the entire optical window is positioned closer to the third reflecting surface side than a point positioned closest to the enlargement side in the refractive optical system in a direction of the optical axis.

### Supplementary Note 5

The imaging optical system according to any one of Supplementary Notes 1 to 4,
in which in a case where a distance between a point closest to the optical axis in the optical window and the optical axis is represented by hWmin, and
a radius of a lens closest to the enlargement side in the refractive optical system is represented by ra, Conditional Expression (4) represented by

$$0.9 < hW min / ra < 3 \qquad ( 4 )$$

is satisfied.

### Supplementary Note 6

The imaging optical system according to any one of Supplementary Notes 1 to 5,
in which the optical window is flat, and
in a case where a distance between the optical axis and a point positioned closest to the optical axis among points positioned closest to the reflective optical system side in the optical window in a direction of the optical axis is represented by hWR, and
a distance between the optical axis and a point farthest from the optical axis among points in an effective region of the third reflecting surface is represented by hM3, Conditional Expression (5) represented by

$$0.5 < hWR / hM 3 < 3 \qquad ( 5 )$$

is satisfied.

### Supplementary Note 7

The imaging optical system according to any one of Supplementary Notes 1 to 6,
in which the optical window is flat, and
in a case where a tilt angle of the optical window with respect to a surface perpendicular to the optical axis is represented by θwin, Conditional Expression (6) represented by

$$30 ° < θ win < 85 ° \qquad ( 6 )$$

is satisfied.

### Supplementary Note 8

The imaging optical system according to any one of Supplementary Notes 1 to 7,
in which the optical window is flat, and
in a case where a distance between a center of the image and the optical axis is represented by Δs,
a length of a short side of the image is represented by ImS,
a minimum value of V defined by V=Δs/ImS is represented by Vmin,
a length of a long side of a rectangle circumscribing the optical window is represented by WL,
a distance in a direction of the optical axis from the first reflecting surface to the enlarged image is represented by Dsc,
a length of a long side of the enlarged image is represented by PrL, and
a length of a long side of the image is represented by ImL, Conditional Expression (7) represented by

$$0 < ( V min - 0.5 ) \times W L \times ( Dsc / PrL ) / ImL < 1.2 , \qquad ( 7 )$$

is satisfied.

### Supplementary Note 9

The imaging optical system according to any one of Supplementary Notes 1 to 8,
in which the optical window is flat, and
in a case where a length of a long side of a rectangle circumscribing the optical window is represented by WL, and
a length of a short side of the rectangle is represented by WS, Conditional Expression (8) represented by

$$2 < WL / WS < 10 \qquad ( 8 )$$

is satisfied.

### Supplementary Note 10

The imaging optical system according to any one of Supplementary Notes 1 to 9,
in which the optical window is flat, and
in a case where a distance between a center of the image and the optical axis is represented by Δs,
a length of a short side of the image is represented by ImS,
a minimum value of V defined by V=Δs/ImS is represented by Vmin,
a length of a long side of a rectangle circumscribing the optical window is represented by WL, and
a length of a short side of the rectangle is represented by WS, Conditional Expression (9) represented by

$$0.5 < ( Vmin - 0.5 ) \times WL / WS < 1.5 \qquad ( 9 )$$

is satisfied.

### Supplementary Note 11

The imaging optical system according to any one of Supplementary Notes 1 to 5,
in which the optical window has a curvature in a long side direction of the image.

### Supplementary Note 12

The imaging optical system according to Supplementary Note 11,
in which in a case where a length of a long side of a projection of a rectangle circumscribing the optical window onto a surface perpendicular to a direction from a center of the curvature toward an origin used in an equation defining a curved surface of the optical window is represented by WpL, and
a length of a short side of the projection is represented by WpS, Conditional Expression (10) represented by

$$1 < WpL / WpS < 3 \qquad ( 10 )$$

is satisfied.

### Supplementary Note 13

The imaging optical system according to Supplementary Note 11 or 12,
in which the optical window is a cylindrical lens.

### Supplementary Note 14

The imaging optical system according to Supplementary Note 13,
in which a surface of the optical window on the reduction side is a cylindrical surface, and
in a case where a length of a long side of a projection of a rectangle circumscribing the optical window onto a surface perpendicular to a direction from a center of the curvature toward an origin used in an equation defining a curved surface of the optical window is represented by WpL, and
a curvature radius of the cylindrical surface in a direction perpendicular to a generatrix of the cylindrical surface is represented by Rcy, Conditional Expression (11) represented by

$$1 < WpL / Rcy < 2 \qquad ( 11 )$$

is satisfied.

### Supplementary Note 15

The imaging optical system according to Supplementary Note 13 or 14,
in which a surface of the optical window on the reduction side is a cylindrical surface, and
in a case where a combined focal length of the reflective optical system and the refractive optical system is fRL, and
a curvature radius of the cylindrical surface in a direction perpendicular to a generatrix of the cylindrical surface is represented by Rcy, Conditional Expression (12) represented by

$$0 < fRL / Rcy < 0.1 \qquad ( 12 )$$

is satisfied.

### Supplementary Note 16

The imaging optical system according to Supplementary Note 11 or 12,
in which the optical window has a toric shape.

### Supplementary Note 17

The imaging optical system according to Supplementary Note 11 or 12,
in which a surface of the optical window on the enlargement side and a surface of the optical window on the reduction side have a spherical shape.

### Supplementary Note 18

The imaging optical system according to Supplementary Note 11 or 12,
in which the optical window has an aspherical shape.

### Supplementary Note 19

A projection type display device comprising:
the imaging optical system according to any one of Supplementary Notes 1 to 18.

### Supplementary Note 20

An imaging apparatus comprising:
the imaging optical system according to any one of Supplementary Notes 1 to 18.

What is claimed is:

1. An imaging optical system that is capable of forming an enlarged image on an enlargement-side imaging plane by enlarging an image on a reduction-side imaging plane,
the imaging optical system consisting of an optical window, a reflective optical system, and a refractive optical system including a plurality of lenses along an optical path in order from an enlargement side to a reduction side,
wherein the reflective optical system includes a first reflecting surface having a positive power, a second reflecting surface having a power, and a third reflecting surface having a positive power along the optical path in order from the enlargement side to the reduction side,
a first intermediate image is formed at a position conjugate to the image on the optical path closer to the reduction side than the third reflecting surface,
a second intermediate image is formed at a position conjugate to the first intermediate image in the reflective optical system,
the enlarged image is formed at a position conjugate to the second intermediate image on the optical path closer to the enlargement side than the optical window,
a center of the enlarged image is at a position shifted from an optical axis of the refractive optical system in a direction perpendicular to the optical axis, and
in a case where a principal ray that is incident into the center of the enlarged image in a state where an amount of the shift is maximum is a center principal ray,
an incidence angle of the center principal ray into the enlargement-side imaging plane is represented by α, and
an incidence angle of the center principal ray into the optical window is represented by θc, Conditional Expressions (1) and (2) represented by
$$40 ° < \vert α \vert < 85 ° \\ and \qquad ( 1 )$$
$$0 ° < \vert θ c \vert < 35 ° \qquad ( 2 )$$
are satisfied.

2. The imaging optical system according to claim 1,
wherein in a case where a maximum half angle of view of the enlargement side is represented by ω, Conditional Expression (3) represented by
65°<ω<90° (3)
is satisfied.

3. The imaging optical system according to claim 1,
wherein an intersection between the center principal ray and a surface of the optical window on the enlargement side is positioned closer to the third reflecting surface side than the entire second reflecting surface in a direction of the optical axis.

4. The imaging optical system according to claim 1,
wherein the entire optical window is positioned closer to the third reflecting surface side than a point positioned closest to the enlargement side in the refractive optical system in a direction of the optical axis.

5. The imaging optical system according to claim 1,
wherein in a case where a distance between a point closest to the optical axis in the optical window and the optical axis is represented by hWmin, and
a radius of a lens closest to the enlargement side in the refractive optical system is represented by ra, Conditional Expression (4) represented by
$$0.9 < hWmin / ra < 3 \qquad ( 4 )$$
is satisfied.

6. The imaging optical system according to claim 1,
wherein the optical window is flat, and
in a case where a distance between the optical axis and a point positioned closest to the optical axis among points positioned closest to the reflective optical system side in the optical window in a direction of the optical axis is represented by hWR, and
a distance between the optical axis and a point farthest from the optical axis among points in an effective region of the third reflecting surface is represented by hM3, Conditional Expression (5) represented by
$$0.5 < hWR / hM 3 < 3 \qquad ( 5 )$$
is satisfied.

7. The imaging optical system according to claim 1,
wherein the optical window is flat, and
in a case where a tilt angle of the optical window with respect to a surface perpendicular to the optical axis is represented by θwin, Conditional Expression (6) represented by
$$30 ° < θ win < 85 ° \qquad ( 6 )$$
is satisfied.

8. The imaging optical system according to claim 1,
wherein the optical window is flat, and
in a case where a distance between a center of the image and the optical axis is represented by Δs,
a length of a short side of the image is represented by ImS,
a minimum value of V defined by V=Δs/ImS is represented by Vmin,
a length of a long side of a rectangle circumscribing the optical window is represented by WL,
a distance in a direction of the optical axis from the first reflecting surface to the enlarged image is represented by Dsc,
a length of a long side of the enlarged image is represented by PrL, and
a length of a long side of the image is represented by ImL, Conditional Expression (7) represented by
$$0 < ( Vmin - 0.5 ) \times WL \times ( Dsc / PrL ) / ImL < 1.2 , \qquad ( 7 )$$
is satisfied.

9. The imaging optical system according to claim 1,
wherein the optical window is flat, and
in a case where a length of a long side of a rectangle circumscribing the optical window is represented by WL, and
a length of a short side of the rectangle is represented by WS, Conditional Expression (8) represented by
$$2 < WL / WS < 10 \qquad ( 8 )$$
is satisfied.

10. The imaging optical system according to claim 1,
wherein the optical window is flat, and
in a case where a distance between a center of the image and the optical axis is represented by Δs,
a length of a short side of the image is represented by ImS,
a minimum value of V defined by V=Δs/ImS is represented by Vmin,
a length of a long side of a rectangle circumscribing the optical window is represented by WL, and
a length of a short side of the rectangle is represented by WS, Conditional Expression (9) represented by
$$0.5 < ( Vmin - 0.5 ) \times WL / WS < 1.5 \qquad ( 9 )$$
is satisfied.

11. The imaging optical system according to claim 1,
wherein the optical window has a curvature in a long side direction of the image.

12. The imaging optical system according to claim 11,
wherein in a case where a length of a long side of a projection of a rectangle circumscribing the optical window onto a surface perpendicular to a direction from a center of the curvature toward an origin used in an equation defining a curved surface of the optical window is represented by WpL, and
a length of a short side of the projection is represented by WpS, Conditional Expression (10) represented by
$$1 < WpL / WpS < 3 \qquad ( 10 )$$
is satisfied.

13. The imaging optical system according to claim 11,
wherein the optical window is a cylindrical lens.

14. The imaging optical system according to claim 13,
wherein a surface of the optical window on the reduction side is a cylindrical surface, and
in a case where a length of a long side of a projection of a rectangle circumscribing the optical window onto a surface perpendicular to a direction from a center of the curvature toward an origin used in an equation defining a curved surface of the optical window is represented by WpL, and
a curvature radius of the cylindrical surface in a direction perpendicular to a generatrix of the cylindrical surface is represented by Rcy, Conditional Expression (11) represented by
$$1 < WpL / Rcy < 2 \qquad ( 11 )$$
is satisfied.

15. The imaging optical system according to claim 13,
wherein a surface of the optical window on the reduction side is a cylindrical surface, and
in a case where a combined focal length of the reflective optical system and the refractive optical system is fRL, and
a curvature radius of the cylindrical surface in a direction perpendicular to a generatrix of the cylindrical surface is represented by Rcy, Conditional Expression (12) represented by
$$0 < fRL / Rcy < 0.1 \qquad ( 12 )$$
is satisfied.

16. The imaging optical system according to claim 11,
wherein the optical window has a toric shape.

17. The imaging optical system according to claim 11,
wherein a surface of the optical window on the enlargement side and a surface of the optical window on the reduction side have a spherical shape.

18. The imaging optical system according to claim 11,
wherein the optical window has an aspherical shape.

19. A projection type display device comprising:
the imaging optical system according to claim 1.

20. An imaging apparatus comprising:
the imaging optical system according to claim 1.
